(19) United States
(12) Patent Application Publication
(10) Pub. No.: US 2026/0215468 A1
(43) Pub. Date: Jul. 30, 2026

(54) METHODS AND SYSTEMS FOR INDUCING COALESCENCE OF FUNGAL PROTEINS, AND FUNGAL FOOD PRODUCTS MADE THEREBY

(71) Applicant: THE FYNDER GROUP, INC., Chicago, IL (US)

(72) Inventors: Mohammad ANVARI, Chicago, IL (US); Jacob CHEGENI, Chicago, IL (US); Sarah MCCARTHY, Chicago, IL (US)

(21) Appl. No.: 19/143,587

(22) PCT Filed: Dec. 29, 2023
(86) PCT No.: PCT/US23/86486

§ 371 Date: Jun. 26, 2025

Related U.S. Application Data
(60) Provisional application No. 63/436,413, filed on Dec. 30, 2022.

(51) Int. Cl. A23L 31/00; A23C 20/02; A23J 3/20; A23J 3/22

(52) U.S. Cl. CPC A23L 31/00; A23C 20/02; A23J 3/20; A23J 3/225

(57) ABSTRACT

Methods of inducing coalescence of fungal proteins in liquid dispersion of filamentous fungal particles, particularly via pH adjustment, addition of functional ingredients, and/or addition of salts, are disclosed. Also disclosed are fungal food products, such as cheese and cheese curd analog food products and tofu analog food products, that may be produced by such methods.

### CROSS-REFERENCE TO RELATED APPLICATION

This application claims the benefit of priority of U.S. Provisional Patent Application 63/436,413, filed 30 Dec. 2022, the entirety of which is incorporated herein by reference.

### FIELD

This disclosure relates generally to food products made from edible filamentous fungi and methods of manufacture thereof, and particularly to solid and/or colloidal fungal food products (e.g., cheese and cheese curd analog food products, tofu analog food products, edible gels, etc.) made by coalescence of filamentous fungal proteins in liquid dispersions thereof.

### BACKGROUND

Many conventional food products, such as cheese, cheese curds, and tofu, are formed by processes in which proteins (e.g., dairy proteins in the case of cheese and cheese curds, soy proteins in the case of tofu) are coagulated from liquid dispersions of the proteins (e.g., dairy milk, soy milk); these coagulated proteins can then be further processed and transformed into the food product. As vegan and/or hypoallergenic alternatives to such food products have gained increasing commercial interest, many attempts have been made to make analogs of these conventional food products by coagulating other types of proteins, e.g., fungal proteins, from liquid dispersions thereof. However, for reasons that are not always well understood, it can be more difficult to induce coagulation of fungal proteins from liquid dispersions than it is to induce coagulation of dairy or plant proteins. Moreover, even when fungal proteins can be coagulated from liquid dispersions, the resulting coagulated proteins may be more difficult or expensive to process into a suitable food product; by way of non-limiting example, fungal protein coagulates may be smaller and/or more fragile than dairy and/or soy protein coagulates and thus more difficult to process into food products having significant structural integrity and texture (e.g., tofu analogs).

Many previous efforts to process coagulated fungal proteins into food products have attempted to overcome these drawbacks by combining the coagulated fungal proteins with binders or gelling agents, such as alginates, carrageenans, and/or egg albumin. However, these ingredients may be expensive, allergenic, and/or non-vegan, and/or may negatively affect desired sensory characteristics (e.g., color, taste, etc.) of the resulting food product.

There is thus a need in the art for methods and systems for providing solid and/or colloidal fungal protein compositions with limited or no addition of conventional non-fungal binders and gelling agents. It is further advantageous for such methods and systems to utilize, and thus for the resulting fungal protein compositions to include, relatively small quantities of readily available and inexpensive components, such as common food-safe acids and/or bases, non-fungal proteins and/or oligo- and/or polysaccharides, and/or salts.

### SUMMARY

In an aspect of the present disclosure, a method for making a solid and/or colloidal fungal food material comprises inducing coalescence of fungal proteins in a liquid dispersion of filamentous fungal particles.

In embodiments, the inducing step may comprise at least one of (i) adjusting a pH of the liquid dispersion; (ii) adding one or more functional ingredients to the liquid dispersion; and (iii) adding one or more salts to the liquid dispersion. The inducing step may, but need not, comprise (i). The inducing step may, but need not, comprise (ii). The inducing step may, but need not, comprise (iii). The inducing step may, but need not, comprise (i) and (ii). The inducing step may, but need not, comprise (i) and (iii). The inducing step may, but need not, comprise (ii) and (iii). The inducing step may, but need not, comprise (i), (ii), and (iii).

In embodiments, the liquid dispersion of filamentous fungal particles may comprise an oil and/or a solid fat. The method may, but need not, comprise prior to the inducing step, combining a liquid phase, the filamentous fungal particles, and the oil and/or solid fat to form the liquid dispersion. The combining step may, but need not, comprise blending the liquid phase and the filamentous fungal particles with the oil and/or solid fat. The blending may, but need not, comprise high-speed shearing. The high-speed shearing may, but need not, comprise shearing the liquid phase, the filamentous fungal particles, and the oil and/or solid fat for at least about two minutes at a rotational speed of at least about 10,000 rpm. The combining step may, but need not, comprise adding an emulsifier. The emulsifier may, but need not, be selected from the group consisting of carboxymethylcellulose, carrageenan, cellulose, guar gum, lecithin, mono- and diglycerides of fatty acids, polyglycerol esters of fatty acids, polyglycerol polyricinoleate, polysorbates, stearoyl lactylates, sorbitan esters, sucrose esters, sucroglycerides, xanthan gum, and combinations thereof. The oil and/or solid fat may, but need not, comprise an oil selected from the group consisting of acai oil, almond oil, avocado oil, blackcurrant seed oil, borage seed oil, canola oil, cashew oil, coconut oil, corn oil, cottonseed oil, evening primrose oil, grapeseed oil, hazelnut oil, hemp oil, macadamia oil, olive oil, palm oil, peanut oil, pecan oil, pine seed oil, pistachio oil, pumpkin seed oil, safflower oil, sesame oil, soybean oil, sunflower oil, tea oil, walnut oil, and combinations thereof. The oil and/or solid fat may, but need not, comprise a solid fat selected from the group consisting of blubber, butter, chicken fat, clarified butter, cocoa butter, dripping, duck fat, fatback, lard, mango butter, margarine, schmaltz, shea butter, speck, suet, tail fat, tallow, vegetable shortening, and combinations thereof. An oil content of the liquid dispersion may, but need not, be about 1 wt. % to about 5 wt. %.

In embodiments, the inducing step may comprise (ii) and the one or more functional ingredients may comprise a non-fungal protein. The non-fungal protein may, but need not, be selected from the group consisting of bean protein, broccoli protein, chickpea protein, hemp protein, lentil protein, nut protein, pea protein, potato protein, quinoa protein, rice protein, seaweed protein, seed protein, soy protein, spinach protein, and combinations thereof.

In embodiments, the inducing step may comprise (ii) and the one or more functional ingredients may comprise one or more enzymes. The one or more enzymes may, but need not, be selected from the group consisting of catalases, chymosin, lactases, lipases, transglutaminases, and combinations thereof.

In embodiments, the inducing step may comprise (i) and, in the inducing step, the pH of the liquid dispersion may be reduced. The pH of the liquid dispersion may, but need not, be reduced by adding an acid to the liquid dispersion. The acid may, but need not, be selected from the group consisting of sorbic acid, benzoic acid, formic acid, acetic acid, dehydroacetic acid, lactic acid, propionic acid, boric acid, malic acid, fumaric acid, ascorbic acid, erythorbic acid, citric acid, tartaric acid, phosphoric acid, metatartaric acid, adipic acid, succinic acid, thiodipropionic acid, phytic acid, alginic acid, hydrochloric acid, sulfuric acid, gluconic acid, glutamic acid, guanylic acid, inosinic acid, cyclamic acid, cholic acid, and combinations thereof. The pH of the liquid dispersion may, but need not, be reduced by adding an acidifying microbial culture to the liquid dispersion. The inducing step may, but need not, further comprise heating the liquid dispersion. The liquid dispersion may, but need not, be heated to a temperature of about 150° F. to about 180° F. (about 65.5° C. to about 83° C.). The method may, but need not, further comprise further heating the liquid dispersion to a temperature of about 180° F. to about 200° F. (about 83° C. to about 94° C.) after the inducing step.

In embodiments, the liquid dispersion may comprise at least one salt of calcium or magnesium, and/or the method may comprise (iii) and the one or more salts may comprise at least one salt of calcium or magnesium. The at least one salt of calcium or magnesium may, but need not, be selected from the group consisting of calcium carbonate, calcium sorbate, calcium benzoate, calcium sulfite, calcium hydrogen sulfite, calcium formate, calcium acetate, calcium propionate, calcium ascorbate, calcium lactate, monocalcium citrate, dicalcium citrate, tricalcium citrate, monocalcium phosphate, dicalcium phosphate, tricalcium phosphate, calcium malate, calcium hydrogen malate, calcium tartrate, calcium fumarate, calcium glycerylphosphate, calcium disodium ethylene diamine tetraacetate, calcium lactobionate, calcium alginate, dicalcium diphosphate, calcium dihydrogen diphosphate, sodium calcium polyphosphate, calcium polyphosphate, calcium salts of fatty acids, calcium stearoyl-2-lactylate, calcium stearoyl fumarate, calcium chloride, calcium sulfate, calcium oxide, calcium ferrocyanide, dicalcium diphosphate, calcium sodium polyphosphate, calcium polyphosphate, calcium silicate, calcium aluminosilicate, calcium stearate, calcium gluconate, synthetic calcium aluminates, calcium diglutamate, calcium guanylate, calcium inosinate, calcium 5′-ribonucleotides, calcium iodate, calcium bromate, calcium peroxide, calcium cyclamate, calcium saccharate, magnesium lactate, monomagnesium phosphate, dimagnesium phosphate, magnesium citrate, magnesium salts of fatty acids, magnesium carbonate, magnesium bicarbonate, magnesium chloride, magnesium sulfate, magnesium oxide, magnesium silicate, magnesium trisilicate, magnesium stearate, magnesium gluconate, magnesium diglutamate, and combinations thereof.

In embodiments, the liquid dispersion may further comprise at least one of a flavoring agent, a taste modulator, and a plantmasker.

In embodiments, at least a portion of the filamentous fungal particles may be produced by size-reducing a cohesive filamentous fungal mycelial biomass. The cohesive filamentous fungal mycelial biomass may, but need not, be produced by liquid surface fermentation or solid-state fermentation.

In embodiments, at least a portion of the filamentous fungal particles may be produced by submerged fermentation.

In embodiments, the filamentous fungal particles may be in the form of a flour having a particle size of about 30 μm to about 400 μm.

In embodiments, the filamentous fungal particles may consist essentially of fungal mycelia.

In embodiments, the filamentous fungal particles may comprise at least about 50 wt. % fungal mycelia. The filamentous fungal particles may, but need not, comprise at least about 75 wt. % fungal mycelia. The filamentous fungal particles may, but need not, comprise at least about 95 wt. % fungal mycelia.

In embodiments, a solids content of the liquid dispersion may be about 4 wt. % to about 7 wt. %.

In embodiments, a mass ratio of filamentous fungal particles to liquid in the liquid dispersion may be about 1:10 to about 10:1.

In embodiments, the liquid dispersion may be stable at room temperature for at least about 1 day, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 15 days, at least about 16 days, at least about 17 days, at least about 18 days, at least about 19 days, at least about 20 days, at least about 21 days, at least about 22 days, at least about 23 days, at least about 24 days, at least about 25 days, at least about 26 days, at least about 27 days, at least about 28 days, at least about 29 days, at least about 30 days, at least about 1 month, at least about 2 months, or at least about 3 months.

In embodiments, the liquid dispersion may be stable at a refrigerated temperature for at least about 1 day, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 15 days, at least about 16 days, at least about 17 days, at least about 18 days, at least about 19 days, at least about 20 days, at least about 21 days, at least about 22 days, at least about 23 days, at least about 24 days, at least about 25 days, at least about 26 days, at least about 27 days, at least about 28 days, at least about 29 days, at least about 30 days, at least about 1 month, at least about 2 months, or at least about 3 months.

In embodiments, the liquid dispersion may be a mixed-format mycelial biomass composition comprising a first mycelial biomass format and a second mycelial biomass format, wherein the first and second mycelial biomass formats are different from each other. The first mycelial biomass format may, but need not, be a cohesive mycelial biomass format and the second mycelial biomass format may, but need not, be a submerged mycelial biomass format. The first mycelial biomass format may, but need not, be selected from the group consisting of biomat pieces, a biomat flour, a biomat dispersion, and a spray dried biomat flour. The second mycelial biomass format may, but need not, be selected from the group consisting of a submerged slurry, a submerged dough, a submerged flour, a submerged dispersion, and a submerged spray dried flour. Each of the first and second mycelial biomass formats may, but need not, be a submerged mycelial biomass format. Each of the first and second mycelial biomass formats may, but need not, be selected from the group consisting of a submerged liquid biomass, a submerged dough, a submerged flour, a submerged dispersion, and a submerged spray dried flour. The liquid dispersion may, but need not, be a combined liquid dispersion, and the method may, but need not, comprise, before the inducing step, blending a mixture of the first mycelial biomass format and a first liquid to form a first liquid dispersion; blending a mixture of the second mycelial biomass format and a second liquid to form a second liquid dispersion; and combining the first and second liquid dispersions to form the combined liquid dispersion.

In embodiments, a gel may be formed in the inducing step. The inducing step may, but need not, comprise adjusting a pH of the liquid dispersion to a gelation pH of no more than about 4. The gelation pH may, but need not, be about 3.5.

In embodiments, a fungal curd may be formed in the inducing step, and the method may further comprise separating at least a portion of a liquid phase of the liquid dispersion from the fungal curd. In the separating step, the at least a portion of the liquid phase may, but need not, be at least about 90 wt. % of the liquid phase. The inducing step may, but need not, comprise adjusting a pH of the liquid dispersion to a pH of about 2 to about 4. In the inducing step, the pH may, but need not, be adjusted to a pH of about 3.5. The separating step may, but need not, comprise pressing the fungal curd through a mesh filter. The mesh filter may, but need not, comprise a cloth. The cloth may, but need not, be cheesecloth. The mesh filter may, but need not, comprise a fine wire sieve. The method may, but need not, comprise forming the fungal curd into a block.

In another aspect of the present disclosure, a food material comprises coalesced filamentous fungal mycelial biomass.

In embodiments, the food material may further comprise an oil and/or a solid fat. The oil and/or solid fat may, but need not, comprise an oil selected from the group consisting of acai oil, almond oil, avocado oil, blackcurrant seed oil, borage seed oil, canola oil, cashew oil, coconut oil, corn oil, cottonseed oil, evening primrose oil, grapeseed oil, hazelnut oil, hemp oil, macadamia oil, olive oil, palm oil, peanut oil, pecan oil, pine seed oil, pistachio oil, pumpkin seed oil, safflower oil, sesame oil, soybean oil, sunflower oil, tea oil, walnut oil, and combinations thereof. The oil and/or solid fat may, but need not, comprise a solid fat selected from the group consisting of blubber, butter, chicken fat, clarified butter, cocoa butter, dripping, duck fat, fatback, lard, mango butter, margarine, schmaltz, shea butter, speck, suet, tail fat, tallow, vegetable shortening, and combinations thereof.

In embodiments, the food material may further comprise a non-fungal protein. The non-fungal protein may, but need not, be selected from the group consisting of bean protein, broccoli protein, chickpea protein, hemp protein, lentil protein, nut protein, pea protein, potato protein, quinoa protein, rice protein, seaweed protein, seed protein, soy protein, spinach protein, and combinations thereof.

In embodiments, at least a portion of the filamentous fungal particles may be produced by size-reducing a cohesive filamentous fungal mycelial biomass. The cohesive filamentous fungal mycelial biomass may, but need not, be produced by liquid surface fermentation or solid-state fermentation.

In embodiments, at least a portion of the filamentous fungal particles may be produced by submerged fermentation.

In embodiments, the filamentous fungal particles may consist essentially of fungal mycelia.

In embodiments, the filamentous fungal particles may comprise at least about 50 wt. % fungal mycelia. The filamentous fungal particles may, but need not, comprise at least about 75 wt. % fungal mycelia. The filamentous fungal particles may, but need not, comprise at least about 95 wt. % fungal mycelia.

In embodiments, the fungal curd may be in the form of a block.

In embodiments, the food material may be free of any non-fungal gelling agent.

In embodiments, the food material may consist essentially of the coalesced filamentous fungal mycelial biomass.

In embodiments, the food material may consist of the filamentous fungal mycelial biomass and at least one acid or base.

In embodiments, the food material may consist of the filamentous fungal mycelial biomass and at least one functional ingredient.

In embodiments, the food material may consist of the filamentous fungal mycelial biomass and at least one salt.

In embodiments, the food material may further comprise a microbial food culture.

In embodiments, the food material may have a hardness of about 1 N to about 50 N.

In embodiments, the food material may have an adhesiveness of about 0.001 N·mm to about 60 N·mm.

In embodiments, the food material may have a cohesiveness of about 0.001 to about 4.

In embodiments, the food material may be a fungal curd made by a method of making a fungal curd as disclosed herein.

In another aspect of the present disclosure, a mixed-format mycelial biomass composition comprises a first mycelial biomass format; and a second mycelial biomass format, wherein the first and second mycelial biomass formats are different mycelial biomass formats.

In embodiments, the composition may be a food material. The food material may, but need not, be selected from the group consisting of a flour, a plurality of solid particles other than a flour, a liquid dispersion, an emulsion, a foam, a gel, a sol, and a solid foam. The food material may, but need not, be a flour, and the flour may, but need not, comprise filamentous fungal particles having a particle size of about 30 μm to about 400 μm. The food material may, but need not, be a plurality of solid particles other than a flour, and the plurality of solid particles may, but need not, comprise filamentous fungal particles having a particle length of about 0.05 mm to about 500 mm, a particle width of about 0.03 mm to about 7 mm, and a particle height of about 0.03 mm to about 1.0 mm. The food material may, but need not, be a liquid dispersion or a sol, and a mass ratio of filamentous fungal particles to liquid in the liquid dispersion or sol may, but need not, be about 1:10 to about 10:1. The food material may, but need not, be a liquid dispersion or sol, and the liquid dispersion or sol may, but need not, be stable for at least about 1 day, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 15 days, at least about 16 days, at least about 17 days, at least about 18 days, at least about 19 days, at least about 20 days, at least about 21 days, at least about 22 days, at least about 23 days, at least about 24 days, at least about 25 days, at least about 26 days, at least about 27 days, at least about 28 days, at least about 29 days, at least about 30 days, at least about 1 month, at least about 2 months, or at least about 3 months. The food material may, but need not, be a foam having a foam stability of at least about 50%, at least about 55%, at least about 60%, at least about 65%, at least about 70%, at least about 75%, at least about 80%, at least about 85%, at least about 90%, or at least about 95% over a period of at least about 1 day, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 15 days, at least about 16 days, at least about 17 days, at least about 18 days, at least about 19 days, at least about 20 days, at least about 21 days, at least about 22 days, at least about 23 days, at least about 24 days, at least about 25 days, at least about 26 days, at least about 27 days, at least about 28 days, at least about 29 days, at least about 30 days, at least about 1 month, at least about 2 months, or at least about 3 months.

In embodiments, a food product may comprise the food material.

In embodiments, the first mycelial biomass format may be a cohesive mycelial biomass format and the second mycelial biomass format is a submerged mycelial biomass format. The first mycelial biomass format may, but need not, be selected from the group consisting of biomat pieces, a biomat flour, a biomat dispersion, and a spray dried biomat flour. The second mycelial biomass format may, but need not, be selected from the group consisting of a submerged slurry, a submerged dough, a submerged flour, a submerged dispersion, and a submerged spray dried flour. The composition may, but need not, be a food material. The composition may, but need not, be a gel. The composition may, but need not, be a food product selected from the group consisting of a blancmange analog food product, a butter analog food product, a custard analog food product, a jam analog food product, a jelly analog food product, a margarine analog food product, and a yogurt analog food product. A mass ratio of the first mycelial biomass format to the second mycelial biomass format may, but need not, be about 1:10 to about 10:1.

In embodiments, each of the first and second mycelial biomass formats may be a submerged mycelial biomass format. Each of the first and second mycelial biomass formats may, but need not, be selected from the group consisting of a submerged slurry, a submerged dough, a submerged flour, a submerged dispersion, and a submerged spray dried flour. The composition may, but need not, be a food material. The composition may, but need not, be a gel. The composition may, but need not, be a food product selected from the group consisting of a blancmange analog food product, a butter analog food product, a custard analog food product, a jam analog food product, a jelly analog food product, a margarine analog food product, and a yogurt analog food product. A mass ratio of the first mycelial biomass format to the second mycelial biomass format may, but need not, be about 1:10 to about 10:1.

In another aspect of the present disclosure, a method for producing a fungal gel comprises at least one of (i) adjusting a pH of a liquid dispersion; (ii) adding one or more functional ingredients to a liquid dispersion; and (iii) adding one or more salts to a liquid dispersion, wherein the liquid dispersion is a mixed-format mycelial biomass composition comprising a first mycelial biomass format and a second mycelial biomass format, wherein the first and second mycelial biomass formats are different mycelial biomass formats.

In embodiments, the fungal gel may be a food product. The food product may, but need not, be selected from the group consisting of a blancmange analog food product, a butter analog food product, a custard analog food product, a jam analog food product, a jelly analog food product, a margarine analog food product, and a yogurt analog food product.

In embodiments, a mass ratio of the first mycelial biomass format to the second mycelial biomass format may be about 1:10 to about 10:1.

In embodiments, the first mycelial biomass format may be a cohesive mycelial biomass format selected from the group consisting of biomat pieces, a biomat flour, a biomat dispersion, and a spray dried biomat flour and the second mycelial biomass format may be a submerged mycelial biomass format selected from the group consisting of a submerged slurry, a submerged dough, a submerged flour, a submerged dispersion, and a submerged spray dried flour. The first mycelial biomass format may, but need not, be selected from the group consisting of biomat pieces, a biomat flour, and a spray dried biomat flour and the second mycelial biomass format may, but need not, be selected from the group consisting of a submerged dough, and a submerged flour.

In embodiments, each of the first and second mycelial biomass formats may be a submerged mycelial biomass format selected from the group consisting of a submerged paste, a submerged flour, a submerged liquid dispersion, and a submerged spray dried flour. Each of the first and second mycelial biomass formats may, but need not, be selected from the group consisting of a submerged dough, a submerged flour, and a submerged spray dried flour.

In embodiments, the mixed-format mycelial biomass composition may be produced by a method comprising blending a mixture of the first mycelial biomass format and a first liquid to form a first liquid dispersion; blending a mixture of the second mycelial biomass format and a second liquid to form a second liquid dispersion; and combining the first and second liquid dispersions to form the mixed-format mycelial biomass composition.

In embodiments, the inducing step may comprise (i) and, in the inducing step, the pH of the liquid dispersion may be adjusted to a gelation pH of no more than about 4. The gelation pH may, but need not, be about 3.5.

In another aspect of the present disclosure, a method for making a fungal tofu analog food product comprises inducing coalescence of fungal proteins in a liquid dispersion of filamentous fungal particles to form a fungal curd, wherein the inducing step comprises at least one of (i) adjusting a pH of the liquid dispersion; (ii) adding one or more functional ingredients to the liquid dispersion; and (iii) adding one or more salts to the liquid dispersion; and compressing the fungal curd to form the fungal tofu analog food product.

In embodiments, the method may further comprise, after the inducing step, separating the fungal curd from a liquid phase of the liquid dispersion.

In embodiments, the liquid dispersion may comprise an oil and/or a solid fat. The method may, but need not, further comprise, prior to the inducing step, combining a liquid phase, the filamentous fungal particles, and the oil and/or solid fat to form the liquid dispersion. The combining step may, but need not, comprise blending the liquid phase and the filamentous fungal particles with the oil and/or solid fat. The blending may, but need not, comprise high-speed shearing. The high-speed shearing may, but need not, comprise shearing the liquid phase, the filamentous fungal particles, and the oil and/or solid fat for at least about two minutes at a rotational speed of at least about 10,000 rpm. The combining step may, but need not, comprise adding an emulsifier. The emulsifier may, but need not, be selected from the group consisting of carboxymethylcellulose, carrageenan, cellulose, guar gum, lecithin, mono- and diglycerides of fatty acids, polyglycerol esters of fatty acids, polyglycerol polyricinoleate, polysorbates, stearoyl lactylates, sorbitan esters, sucrose esters, sucroglycerides, xanthan gum, and combinations thereof. The oil and/or solid fat may, but need not, comprise an oil selected from the group consisting of acai oil, almond oil, avocado oil, blackcurrant seed oil, borage seed oil, canola oil, cashew oil, coconut oil, corn oil, cottonseed oil, evening primrose oil, grapeseed oil, hazelnut oil, hemp oil, macadamia oil, olive oil, palm oil, peanut oil, pecan oil, pine seed oil, pistachio oil, pumpkin seed oil, safflower oil, sesame oil, soybean oil, sunflower oil, tea oil, walnut oil, and combinations thereof. The oil and/or solid fat may, but need not, comprise a solid fat selected from the group consisting of blubber, butter, chicken fat, clarified butter, cocoa butter, dripping, duck fat, fatback, lard, mango butter, margarine, schmaltz, shea butter, speck, suet, tail fat, tallow, vegetable shortening, and combinations thereof. An oil content of the liquid dispersion may, but need not, be about 1 wt. % to about 5 wt. %.

In embodiments, the inducing step may comprise (ii) and the one or more functional ingredients may comprise a non-fungal protein. The non-fungal protein may, but need not, be selected from the group consisting of bean protein, broccoli protein, chickpea protein, hemp protein, lentil protein, nut protein, pea protein, potato protein, quinoa protein, rice protein, seaweed protein, seed protein, soy protein, spinach protein, and combinations thereof.

In embodiments, the inducing step may comprise (ii) and the one or more functional ingredients may comprise one or more enzymes. The one or more enzymes may, but need not, be selected from the group consisting of catalases, chymosin, lactases, lipases, transglutaminases, and combinations thereof.

In embodiments, the inducing step may comprise (i) and, in the inducing step, the pH of the liquid dispersion may be reduced. The pH of the liquid dispersion may, but need not, be reduced by adding an acid to the liquid dispersion. The acid may, but need not, be selected from the group consisting of sorbic acid, benzoic acid, formic acid, acetic acid, dehydroacetic acid, lactic acid, propionic acid, boric acid, malic acid, fumaric acid, ascorbic acid, erythorbic acid, citric acid, tartaric acid, phosphoric acid, metatartaric acid, adipic acid, succinic acid, thiodipropionic acid, phytic acid, alginic acid, hydrochloric acid, sulfuric acid, gluconic acid, glutamic acid, guanylic acid, inosinic acid, cyclamic acid, cholic acid, and combinations thereof. The pH of the liquid dispersion may, but need not, be reduced by adding an acidifying microbial culture to the liquid dispersion. The inducing step may, but need not, further comprise heating the liquid dispersion. The liquid dispersion may, but need not, be heated to a temperature of about 150° F. to about 180° F. (about 65.5° C. to about 83° C.). The method may, but need not, further comprise further heating the liquid dispersion to a temperature of about 180° F. to about 200° F. (about 83° C. to about 94° C.) after the inducing step. In the inducing step, the pH may, but need not, be adjusted to a pH of about 2 to about 4. In the inducing step, the pH may, but need not, be adjusted to a pH of about 3.5.

In embodiments, the liquid dispersion may comprise at least one salt of calcium or magnesium, and/or the inducing step may comprise (iii) and the one or more salts may comprise at least one salt of calcium or magnesium. The at least one salt of calcium or magnesium may, but need not, be selected from the group consisting of calcium carbonate, calcium sorbate, calcium benzoate, calcium sulfite, calcium hydrogen sulfite, calcium formate, calcium acetate, calcium propionate, calcium ascorbate, calcium lactate, monocalcium citrate, dicalcium citrate, tricalcium citrate, monocalcium phosphate, dicalcium phosphate, tricalcium phosphate, calcium malate, calcium hydrogen malate, calcium tartrate, calcium fumarate, calcium glycerylphosphate, calcium disodium ethylene diamine tetraacetate, calcium lactobionate, calcium alginate, dicalcium diphosphate, calcium dihydrogen diphosphate, sodium calcium polyphosphate, calcium polyphosphate, calcium salts of fatty acids, calcium stearoyl-2-lactylate, calcium stearoyl fumarate, calcium chloride, calcium sulfate, calcium oxide, calcium ferrocyanide, dicalcium diphosphate, calcium sodium polyphosphate, calcium polyphosphate, calcium silicate, calcium aluminosilicate, calcium stearate, calcium gluconate, synthetic calcium aluminates, calcium diglutamate, calcium guanylate, calcium inosinate, calcium 5′-ribonucleotides, calcium iodate, calcium bromate, calcium peroxide, calcium cyclamate, calcium saccharate, magnesium lactate, monomagnesium phosphate, dimagnesium phosphate, magnesium citrate, magnesium salts of fatty acids, magnesium carbonate, magnesium bicarbonate, magnesium chloride, magnesium sulfate, magnesium oxide, magnesium silicate, magnesium trisilicate, magnesium stearate, magnesium gluconate, magnesium diglutamate, and combinations thereof.

In embodiments, the separating step may comprise pressing the fungal curd through a mesh filter. The mesh filter may, but need not, comprise a cloth. The cloth may, but need not, be cheesecloth. The mesh filter may, but need not, comprise a fine wire sieve. The method may, but need not, further comprise forming the fungal curd into a block.

In embodiments, the liquid dispersion may further comprise at least one of a flavoring agent, a taste modulator, and a plantmasker.

In embodiments, at least a portion of the filamentous fungal particles may be produced by size-reducing a cohesive filamentous fungal mycelial biomass. The cohesive filamentous fungal mycelial biomass may, but need not, be produced by liquid surface fermentation or solid-state fermentation.

In embodiments, at least a portion of the filamentous fungal particles may be produced by submerged fermentation.

In embodiments, the filamentous fungal particles may be in the form of a flour having a particle size of about 30 μm to about 400 μm.

In embodiments, the filamentous fungal particles may consist essentially of fungal mycelia.

In embodiments, the filamentous fungal particles may comprise at least about 50 wt. % fungal mycelia. The filamentous fungal particles may, but need not, comprise at least about 75 wt. % fungal mycelia. The filamentous fungal particles may, but need not, comprise at least about 95 wt. % fungal mycelia.

In embodiments, a solids content of the liquid dispersion may be about 4 wt. % to about 7 wt. %.

In another aspect of the present disclosure, a fungal tofu analog food product is made by a method of making a fungal tofu analog food product as disclosed herein.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%;

by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The embodiments and configurations described herein are neither complete nor exhaustive. As will be appreciated, other embodiments are possible utilizing, alone or in combination, one or more of the features set forth above or described in detail below.

### BRIEF DESCRIPTION OF THE DRAWINGS

FIG. 1 is a flowchart illustrating a method for inducing coalescence of fungal proteins via acid addition, according to embodiments of the present disclosure.

FIG. 2 is a flowchart illustrating a method for inducing coalescence of fungal proteins via addition of an acid-producing microbial culture, according to embodiments of the present disclosure.

FIG. 3 is a flowchart illustrating a method for inducing coalescence of fungal proteins via addition of one or more functional ingredients, according to embodiments of the present disclosure.

FIG. 4 is a flowchart illustrating a method for inducing coalescence of fungal proteins via addition of one or more salts, according to embodiments of the present disclosure.

FIG. 5 is a flowchart illustrating a method for inducing coalescence of fungal proteins via a combination of addition of one or more functional ingredients and addition of one or more acids, acid-producing microbial cultures, and/or salts, according to embodiments of the present disclosure.

FIG. 6 is a flowchart illustrating a method for inducing coalescence of fungal proteins via acidification and/or addition of one or more salts, according to embodiments of the present disclosure.

FIG. 7 is a flowchart illustrating a method for making a fungal tofu analog food product from fungal curds, according to embodiments of the present disclosure.

FIG. 8 is an image of an aqueous dispersion of Fusarium strain flavolapis, according to embodiments of the present disclosure.

FIGS. 9 and 10 are images of the aqueous dispersion illustrated in FIG. 8 shortly after initiation of fungal curd formation, according to embodiments of the present disclosure.

FIGS. 11 and 12 are images of the aqueous dispersion illustrated in FIGS. 8-10 after further heating and fungal curd formation, according to embodiments of the present disclosure.

FIG. 13 is an image illustrating separation of fungal curds from the liquid phase of the aqueous dispersion illustrated in FIGS. 8-12, according to embodiments of the present disclosure.

FIG. 14 is an image of a fungal curd composition resembling a soft spreadable or ricotta-like cheese, according to embodiments of the present disclosure.

FIG. 15 is a graph of the oil-in-water emulsion stability of liquid dispersions of various mycelial biomass formats, according to embodiments of the present disclosure.

FIG. 16 is a graph of the viscosity of liquid dispersions of various mycelial biomass formats as a function of shear rate, according to embodiments of the present disclosure.

FIG. 17 is a graph of the viscosity of a liquid dispersion of biomat pieces at varying pH values as a function of shear rate, according to embodiments of the present disclosure.

FIG. 18 is a graph of the storage and loss moduli of a liquid dispersion of biomat pieces at varying pH values as functions of shear frequency, according to embodiments of the present disclosure.

FIG. 19 is a graph of the storage and loss moduli of a fungal gel formed from a liquid dispersion of biomat pieces as a function of time after coalescence of fungal proteins, according to embodiments of the present disclosure.

FIG. 20A is a graph of the moisture content of fungal tofu analog food products produced using liquid dispersions of submerged dough, according to embodiments of the present disclosure.

FIG. 20B is a graph of the moisture content of fungal tofu analog food products produced using liquid dispersions of biomat pieces, according to embodiments of the present disclosure.

FIG. 21A is a graph of the protein content of fungal tofu analog food products produced using liquid dispersions of submerged dough, according to embodiments of the present disclosure.

FIG. 21B is a graph of the protein content of fungal tofu analog food products produced using liquid dispersions of biomat pieces, according to embodiments of the present disclosure.

FIG. 22A is a graph of the hardness of fungal tofu analog food products produced using liquid dispersions of submerged dough, according to embodiments of the present disclosure.

FIG. 22B is a graph of the hardness of fungal tofu analog food products produced using liquid dispersions of biomat pieces, according to embodiments of the present disclosure.

FIG. 23A is a graph of the cohesiveness of fungal tofu analog food products produced using liquid dispersions of submerged dough, according to embodiments of the present disclosure.

FIG. 23B is a graph of the cohesiveness of fungal tofu analog food products produced using liquid dispersions of biomat pieces, according to embodiments of the present disclosure.

FIG. 24A is a graph of the adhesiveness of fungal tofu analog food products produced using liquid dispersions of submerged dough, according to embodiments of the present disclosure.

FIG. 24B is a graph of the adhesiveness of fungal tofu analog food products produced using liquid dispersions of biomat pieces, according to embodiments of the present disclosure.

FIGS. 25A, 25B, 26A, 26B, 27A, 27B, 28A, 28B, 29A, 29B, 30A, 30B, 31A, 31B, 32A, 32B, 33A, 33B, 34A, 34B, 35A, 35B, 36A, 36B, 37A, 37B, 38A, 38B, 39A, 39B, 40A, 40B, 41A, 41B, 42A, and 42B are scanning electron microscopy (SEM) images of fungal tofu analog food products produced using liquid dispersions of submerged dough, according to embodiments of the present disclosure. Figures labeled “A” are images of the surfaces of the tofu analog food products and figures labeled “B” are images of the cross-sections of the tofu analog food products.

FIGS. 43A, 43B, 44A, 44B, 45A, 45B, 46A, 46B, 47A, 47B, 48A, 48B, 49A, 49B, 50A, 50B, 51A, 51B, 52A, 52B, 53A, 53B, 54A, 54B, 55A, 55B, 56A, 56B, 57A, 57B, 58A, 58B, 59A, 59B, 60A, and 60B are SEM images of fungal tofu analog food products produced using liquid dispersions of biomat pieces, according to embodiments of the present disclosure. Figures labeled “A” are images of the surfaces of the tofu analog food products and figures labeled “B” are images of the cross-sections of the tofu analog food products.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

As used herein, unless otherwise specified, the term “analog” or “analog food product” refers to a food product comprising edible fungi that bears an aesthetic, culinary, nutritional, and/or sensory equivalence or resemblance to an identified non-fungal food product. By way of non-limiting example, an “ice cream analog food product,” as that term is used herein, refers to a food product comprising edible fungi that bears an aesthetic, culinary, nutritional, and/or sensory equivalence or resemblance to conventional ice cream made from animal milk, and a “mayonnaise analog food product,” as that term is used herein, refers to a food product comprising edible fungi that bears an aesthetic, culinary, nutritional, and/or sensory equivalence or resemblance to conventional mayonnaise made using animal products.

As used herein, unless otherwise specified, the term “coalesce” and its derived terms (e.g., “coalescing,” “coalescence,” etc.) refer to a phenomenon in which fungal proteins in a liquid dispersion of particles of filamentous fungal mycelial biomass are attracted to each other to form a fungal curd (i.e., a solid mass of aggregated filamentous fungal mycelial biomass proteins (and, in some cases, along with other components) that can be separated from the remaining liquid phase, similar to the manner in which proteins are coagulated from animal milks (to form curd) or soy milk (to form tofu)) or a gel material (i.e., a phase that holds its shape and is resistant to flow, in which the liquid phase is dispersed throughout a network formed by the filamentous fungal proteins (and, in some cases, other compounds)). “Coalescence” of fungal proteins, as that term is used herein, can be induced, by way of non-limiting example, by adjusting the pH of the liquid dispersion, adding one or more functional ingredients to the liquid dispersion, and/or adding one or more salts to the liquid dispersion.

As used herein, unless otherwise specified, the terms “cohesive mycelial biomass,” “biomat,” and “cohesive biomat” are interchangeable and each refer to a mycelial biomass that is produced by a non-submerged fermentation process, such as liquid surface fermentation, membrane or mesh fermentation, or solid substrate fermentation. Non-limiting examples of cohesive mycelial biomasses as that term is used herein include biomats that are composed substantially entirely of mycelium and composite mycelium/feedstock biomats.

As used herein, unless otherwise specified, the term “cohesive mycelial biomass format” refers to a mycelial biomass format in which the mycelial biomass is produced by a non-submerged fermentation process.

As used herein, unless otherwise specified, the term “colloid” refers to a mixture in which particles of one substance (the “dispersed phase”) are dispersed throughout a volume of a different substance (the “dispersion medium”); for example, the dispersed phase can comprise or consist of microscopic bubbles, particles, etc. Where the dispersed phase and the dispersion medium of a colloid are specifically identified herein, they are separated by a hyphen, with the dispersed phase identified first, e.g., a reference herein to an “oil-water colloid” refers to a colloid in which an oil is the dispersed phase and water is the dispersion medium.

As used herein, unless otherwise specified, the term “emulsion” refers to a colloid in which both the dispersed phase and the dispersion medium are liquids. Examples of emulsions as that term is used herein include but are not limited to butter (when melted), margarine (when melted), mayonnaise, and milk.

As used herein, unless otherwise specified, the term “foam” refers to a colloid in which the dispersed phase is a gas, and the dispersion medium is a liquid. Examples of foams as that term is used herein include but are not limited to egg white foam (i.e., the product of whisking, or otherwise incorporating, air into egg white) and whipped cream.

As used herein, unless otherwise specified, the term “foam stability” refers to the proportion of an initial volume of a foam that is retained by the foam after a specified interval. By way of non-limiting example, a foam that has an initial volume of five liters and a volume of four liters 14 days later thus has 80% stability over 14 days. Unless otherwise specified, a “stable” foam, as that term is used herein, is a foam that has at least 50% stability after a specified interval.

As used herein, unless otherwise specified, the term “fungal curd” refers to any mass of filamentous fungal particles, and optionally other components, that (1) is formed by coalescence of fungal proteins in a liquid dispersion of the filamentous fungal particles, and (2) behaves substantially as a solid material such that it can be separated from a remaining liquid phase of the liquid dispersion by conventional means of liquid-solid separation (e.g., decanting, pressing, filtration, gravity separation, screw separation, centrifugation, etc.).

As used herein, unless otherwise specified, the term “gel” refers to a colloid in which the dispersed phase is a liquid, and the dispersion medium is a solid. Examples of gels as that term is used herein include but are not limited to blancmange, butter (when cold), custard (after it is cooked), jam, jelly (after it is set), margarine (when cold), and yogurt. Gels, as that term is used herein, may behave as solids or semi-solids and typically have an elastic modulus greater than their dynamic (or loss) modulus, and thus do not readily flow.

As used herein, unless otherwise specified, the term “functional ingredient” refers to any edible carbohydrate or protein.

As used herein, unless otherwise specified, the term “liquid aerosol” refers to a colloid in which the dispersed phase is a liquid, and the dispersion medium is a gas.

As used herein, unless otherwise specified, the term “mycelial biomass” refers to a filamentous fungal biomass that (i) comprises at least 50% mycelium on a dry weight basis, and may in some cases comprise at least 55%, at least 60%, at least 65%, at least 70%, at least 75%, at least 80%, at least 85%, at least 90%, or at least 95% mycelium on a dry weight basis, and (ii) is produced by a submerged fermentation process or a non-submerged fermentation process. Any portion of the dry weight of a mycelial biomass that is not mycelium may consist of impurities and/or other filamentous fungal tissues (e.g., conidia, fruiting bodies or portions thereof, etc.).

As used herein, unless otherwise specified, the term “mycelial biomass format” refers to a mycelial biomass produced by a specific type of fermentation process and subsequently subjected to one or more specific post-production processing steps, e.g., dewatering, blending with a liquid, drying and grinding/milling, size reducing, spray drying, etc. Non-limiting examples of mycelial biomass formats as that term is used herein include (1) a biomass-containing fermentation broth or a washed biomass resuspended in a liquid (referred to herein as a “submerged slurry”); (2) a mycelial biomass in the form of a dough produced by dewatering a submerged slurry (referred to herein as a “submerged dough”); (3) a mycelial biomass in the form of a flour produced by drying and grinding or milling a submerged slurry, or a submerged dough (referred to herein as a “submerged flour”); (4) a liquid dispersion of mycelial biomass produced by (i) blending a submerged slurry and/or (ii) mixing a submerged dough with a liquid and blending the mixture (referred to herein as a “submerged dispersion”); (5) a biomass in the form of a flour produced by spray drying a submerged dispersion (referred to herein as a “submerged spray dried flour”); (6) cut pieces of biomat (referred to herein as “biomat pieces”); (7) a mycelial biomass in the form of a flour produced by drying and grinding or milling a biomat or biomat pieces (referred to herein as a “biomat flour”); (8) a liquid dispersion of mycelial biomass produced by mixing a biomat, biomat pieces, or a biomat flour with a liquid (referred to herein as a “biomat dispersion”); and (9) a mycelial biomass in the form of a flour produced by spray drying a biomat dispersion or other fluid that contains a biomat, biomat pieces, or a biomat flour (referred to herein as a “spray dried biomat flour”).

As used herein, unless otherwise specified, the term “mycelium” refers to the vegetative part of a filamentous fungus, consisting of a mass of hyphae.

As used herein, unless otherwise specified, the term “non-submerged fermentation process” refers to any fungal fermentation process in which at least a portion of the mycelium formed by the process is not submerged in a liquid fermentation medium. Non-limiting examples of non-submerged fermentation processes as that term is used herein include liquid surface fermentation processes, solid-surface (or solid-substrate) fermentation processes, membrane surface fermentation processes, and mesh surface fermentation processes. Non-limiting examples of liquid surface fermentation processes include those described in PCT Application Publications 2017/151684, 2019/099474, 2020/176758, and 2023/021264.

As used herein, unless otherwise specified, the term “sol” refers to a colloid in which the dispersed phase is a solid and the dispersion medium is a liquid. Examples of sols as that term is used herein include but are not limited to custard (before it is cooked) and jelly (before it is set).

As used herein, unless otherwise specified, the term “solid aerosol” refers to a colloid in which the dispersed phase is a solid and the dispersion medium is a gas.

As used herein, unless otherwise specified, the term “solid foam” refers to a colloid in which the dispersed phase is a gas, and the dispersion medium is a solid. Examples of solid foams as that term is used herein include but are not limited to bread, cake, ice cream, and meringue.

As used herein, unless otherwise specified, the term “solid sol” refers to a colloid in which both the dispersed phase and the dispersion medium are solids.

As used herein, unless otherwise specified, the term “submerged fermentation process” refers to any fungal fermentation process in which substantially all of the mycelium formed by the process is submerged in a liquid fermentation medium. Non-limiting examples of submerged fermentation processes include those described in British Patent 1,346,062, U.S. Pat. No. 4,555,485, and PCT Publications 2022/157326 and 2022/236165.

As used herein, unless otherwise specified, the term “submerged mycelial biomass” refers to a mycelial biomass produced by a submerged fermentation process.

As used herein, unless otherwise specified, the term “submerged mycelial biomass format” refers to a mycelial biomass format in which the mycelial biomass is produced by a submerged fermentation process.

As used herein, unless otherwise specified, the term “vegan” refers to a food product that is substantially free of food components or ingredients, such as protein, derived from animals. Specific examples of non-vegan food ingredients or products include blood, eggs, isinglass, meat (and components thereof, e.g., animal fats), milk, rennet, and foods made using any one or more of these ingredients (e.g., ice cream, mayonnaise, etc.). As disclosed herein, some vegan food products may be analogs of non-vegan food products.

The present disclosure provides methods for inducing coalescence of filamentous fungal proteins in liquid dispersions thereof, as well as solid and/or colloidal fungal food products (e.g., cheese and cheese curd analog food products, tofu analog food products, edible gels, etc.) made by such methods. According to various embodiments of the present disclosure, coalescence of filamentous fungal proteins is induced by one or more of (1) adjusting the pH (e.g., by adding one or more acids or bases) of a liquid dispersion of filamentous fungal particles; (2) adding one or more functional ingredients (i.e., proteins and/or carbohydrates) to a liquid dispersion of filamentous fungal particles; and/or (3) adding one or more salts to a liquid dispersion of filamentous fungal particles. In some embodiments, this coalescence results in the formation of a fungal curd, i.e., a solid mass of filamentous fungal proteins (and, in some cases, other components) that can be separated from the remaining liquid phase, similar to the manner in which proteins are coagulated from animal milks (to form curd) or soy milk (to form tofu), while in other embodiments the coalescence results in the formation of a gel material, i.e., a phase that holds its shape and is resistant to flow, in which the liquid phase is dispersed throughout a network formed by the filamentous fungal proteins (and, in some cases, other compounds). The fungal curd or gel material can then be processed into any of a wide array of fungal food products, such as, by way of non-limiting example, cheese and cheese curd analog food products, tofu analog food products, edible gels, and the like.

### Edible Filamentous Fungi

Edible filamentous fungi, and particularly, filamentous fungal mycelial biomass, can be used as a nutrition source, such as for protein, either alone or incorporated into foodstuffs, such as the disclosed solid and/or colloidal fungal food products. Described herein are solid and/or colloidal fungal food products comprising coalesced proteins of edible filamentous fungi.

Filamentous fungi suitable for use in the disclosed methods are selected from the phyla or divisions Zygomycota, Glomermycota, Chytridiomycota, Basidiomycota or Ascomycota. The phylum (or division) Basidiomycota comprises, inter alia, the orders Agaricales, Russulales, Polyporales and Ustilaginales; the phylum Ascomycota comprises, inter alia, the orders Pezizales and Hypocreales; and the phylum Zygomycota comprises, inter alia, the order Mucorales. In some embodiments, the particles of edible filamentous fungi of the present invention belong to an order selected from Ustilaginales, Russulales, Polyporales, Agaricales, Pezizales, Hypocreales, and Mucorales. In some embodiments, the filamentous fungi of the order Ustilaginales are selected from the family Ustilaginaceae. In some embodiments, the filamentous fungi of the order Russulales are selected from the family Hericiaceae. In some embodiments, the filamentous fungi of the order Polyporales are selected from the families Polyporaceae or Grifolaceae. In some embodiments, the filamentous fungi of the order Agaricales are selected from the families Lyophyllaceae, Strophariaceae, Lycoperdaceae, Agaricaceae, Pleurotaceae, Physalacriaceae, or Omphalotaceae. In some embodiments, the filamentous fungi of the order Pezizales are selected from the families Tuberaceae or Morchellaceae. In some embodiments, the filamentous fungi of the order Mucorales are selected from the family Mucoraceae. In some embodiments, the filamentous fungi are from the genera Fusarium, Aspergillus, Trichoderma, and/or Rhizopus.

Examples of the species of filamentous fungi suitable for use in the methods provided by the present disclosure include, without limitation, Ustilago esculenta, Hericululm erinaceus, Polyporous squamosus, Grifola fondrosa, Hypsizygus marmoreus, Hypsizygus ulmariuos (elm oyster), Calocybe gambosa, Pholiota nameko, Calvatia gigantea, Agaricus bisporus, Stropharia rugosoannulata, Hypholoma lateritium, Pleurotus eryngii, Pleurotus ostreatus (pearl), Pleurotus ostreatus var. columbinus (blue oyster), Tuber borchii, Morchella esculenta, Morchella conica, Morchella importuna, Sparassis crispa (cauliflower), Fusarium venenatum, Fusarium strain flavolapis (ATCC Accession Deposit No. PTA-10698), Disciotis venosa, Cordyceps militaris, Ganoderma lucidum (reishi), Flammulina velutipes, Lentinula edodes, and Ophiocordyceps sinensis. Additional examples include, without limitation, Trametes versicolor, Ceriporia lacerate, Pholiota gigantea, Leucoagaricus holosericeus, Pleurotus djamor, Calvatia fragilis, Handkea utriformis, and Rhizopus oligosporus.

In some embodiments, the filamentous fungus is a Fusarium species. In some embodiments, the filamentous fungus is Fusarium strain flavolapis (ATCC Accession Deposit No. PTA-10698), which may also be referred to herein as “F. flavolapis” or “F.f.” In some embodiments, the filamentous fungus is Fusarium venenatum.

Because they are edible, the filamentous fungi suitable for use in methods and compositions provided by the present disclosure typically have a low mycotoxin content. In some embodiments, the total amount of mycotoxins in a filamentous fungus utilized in the disclosed methods and compositions is less than about 10 ppm.

The amount of edible filamentous fungal biomass used in the disclosed methods can vary based on the desired protein content, texture, and/or flavor of the final solid and/or colloidal product. In various embodiments, amounts of about 0.25 wt. % to about 10 wt. % of fungal biomass, or any subrange included therein, can be used to prepare the disclosed liquid dispersions. As used herein, wt. % is expressed as the weight of a component divided by the total weight of the composition; for example, if 1 g of filamentous fungal biomass is dispersed in 100 mL (i.e., 100 g) of water, the resulting dispersion would be represented as a 1 wt. % fungal dispersion. In some embodiments, the amount of edible filamentous fungal biomass used in the disclosed liquid dispersions is about 1.0 wt. % to about 10.0 wt. %, or any value in any subrange thereof. In some embodiments, the amount of edible filamentous fungal biomass used in the disclosed liquid dispersions is about 2.5 wt. % to about 4.0 wt. %. In some embodiments, the amount of edible filamentous fungal biomass used in the disclosed liquid dispersions is about 2.7 wt. % to about 4.0 wt. %. In some embodiments, the amount of edible filamentous fungi used in the disclosed liquid dispersions is selected from 2.0 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, 3.0 wt. %, 3.1 wt. %, 3.2 wt. %, 3.3 wt. %, 3.4 wt. %, 3.5 wt. %, 3.6 wt. %, 3.7 wt. %, 3.8 wt. %, 3.9 wt. %, 4.0 wt. %, 4.1 wt. %, 4.2 wt. %, 4.3 wt. %, 4.4 wt. %, 4.5 wt. %, 4.6 wt. %, 4.7 wt. %, 4.8 wt. %, 4.9 wt. %, and 5.0 wt. %, and any subrange from about 1.0 wt. % to about 10.0 wt. %.

### Liquid Dispersions of Filamentous Fungal Particles

Methods provided by the present disclosure utilize a liquid dispersion made from one or more filamentous fungi. The liquid dispersion comprises particles of filamentous fungi dispersed in a liquid medium, most typically an aqueous medium (i.e., a medium that is or includes water). In the case of a cohesive fungal biomass, the fungal biomass is typically size-reduced for use in the disclosed dispersions, which can occur by such means as cutting, chopping, dicing, mincing, grinding, blending, sonication, etc. Typically, some form of size reduction is conducted prior to mixing with the liquid medium.

In various embodiments, the liquid dispersion is prepared by combining and blending one or more mycelial biomass formats with a liquid phase, most commonly an aqueous (i.e., water or water-containing) phase. The liquid dispersion utilized in the disclosed methods is preferably stable such that particles of filamentous fungus do not readily separate from the liquid medium in which they are dispersed. For example, in various embodiments, upon forming the dispersion, the resulting fluid composition may appear to be homogeneous in appearance and/or may not visibly separate into distinct phases, such that no visibly discernible or significant fungal sediment forms on the bottom of any container holding the dispersion.

The blending can occur at varying speeds and times. As can be appreciated, a typical blending apparatus is one that combines two or more components together via the use of moving or rotating blades. As such, longer blending times and/or higher blending speeds will often result in smaller fungal particles in the dispersion. In some embodiments, the fungal material is blended in a liquid medium until it is reduced to fine particles. In some embodiments, the particle size of the fungal material is the same as or similar to those of conventional flours, such as wheat flours, wherein the particle size is typically about 30 μm to about 400 μm, most typically about 75 μm to about 120 μm. In some other embodiments, finer particles may be used; an average particle size of the fungal material may be no more than about 10 μm, and/or at least 50%, or at least 60%, or at least 70%, or at least 80%, or at least 90% of the particles may have a particle size of about 1 μm to about 10 μm, or alternatively in any subrange within this range. In some embodiments, at least 50%, or at least 60%, or at least 70%, or at least 80%, or at least 90% of the particles are less than 10 μm, less than 9 μm, less than 8 μm, less than 7 μm, less than 6 μm, less than 5 μm, less than 4 μm, less than 3 μm, less than 2 μm, or less than 1 μm. In some embodiments, at least about 50%, or at least about 60%, or at least about 70%, or at least about 80%, or at least about 90% of the particles may have a particle size of less than about 1 μm.

Typically, the blending occurs at sufficient speed and for a sufficient period to produce filamentous fungal particles in the liquid having a particle size of no more than about 500 μm. In some embodiments, the blending is or includes high shear blending, where the fungi and water are blended for at least two minutes at a speed of at least about 10,000 rpm. Additionally or alternatively, in some embodiments, the blending is or includes high-pressure homogenization, where the fungi and water are blended at a very high pressure (e.g., about 20,000 psi) to cause lysis of the fungal cells. In some embodiments, the blended mixture is heated gradually during blending, in some embodiments to the boiling point of water, to facilitate production of the dispersion. Once blending is complete, the heated mixture may in some embodiments be allowed to cool prior to further utilization in the disclosed methods.

The mass ratio of filamentous fungal biomass to the liquid phase (e.g., water) can be adjusted to produce a liquid dispersion with a desired consistency and density. The ratio of the biomass to water is generally from about 1:50 to about 50:1, or in any range of ratios therebetween. In some embodiments, the mass ratio of the fungal biomass to water is about 1:30, about 1:20, about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, or about 10:1.

In some embodiments, the filamentous fungal particles in the dispersion consist essentially of fungal mycelia. In some embodiments, the filamentous fungal particles in the dispersion comprise about 50 wt. % to about 95 wt. % fungal mycelia. In some embodiments, the filamentous fungal particles in the dispersion comprise at least about 50 wt. % fungal mycelia, in some embodiments at least about 75 wt. % fungal mycelia, and in some embodiments at least about 95 wt. % fungal mycelia. In some embodiments, the dispersion comprises at least about 4% fungal solids. In other embodiments, the dispersion has a solids content of about 4% to about 30%, typically about 5% to about 15%, and most typically about 6.25% to about 10%.

In some embodiments, the filamentous fungal particles comprise both fungal mycelia and one or more fruiting bodies (or portions thereof). Some species of fungi produce multicellular fruiting bodies for sexual reproduction and spore development. A fruiting body is the part of a fungus that is typically thought of when considering the term “mushroom.” Fruiting bodies include mushroom caps, stems, gills, skirts, scales, volva, and the like. While a fruiting body grows above a growth substrate, mycelium typically grows within or beneath a substrate (e.g., soil, dead wood, etc.) from which it derives resources. Because the fungal filaments that form mycelia, known as hyphae, are the vegetative structures of a filamentous fungus through which the fungus absorbs air and/or nutrients from its environment, the fungus must typically produce a certain mass of mycelium before it can produce fruiting bodies, i.e., the mycelium is necessary to collect the resources the fungus requires for fruiting body production. When filamentous fungi that form fruiting bodies are used in liquid dispersions according to the present disclosure, the filamentous fungal particles of the liquid dispersion can, in some embodiments, be completely or mostly formed of fruiting bodies. Additionally or alternatively, filamentous fungal particles in liquid dispersions according to the present disclosure can be derived from a fungal biomass that comprises conidia. In some embodiments, the filamentous fungal particles of the liquid dispersion can comprise a mixture of mycelium, conidia, and fruiting body material in any proportions.

In some embodiments, the liquid dispersion is produced under nitrogen, which results in a creamier consistency of liquid dispersion with less fungal scent. Production under nitrogen can be accomplished by bubbling nitrogen gas into a closed vessel such that nitrogen replaces the available oxygen (and other non-nitrogen gases) in the vessel. This can occur during blending, while the nascent dispersion is created.

The amount of liquid dispersion—that is, the combined amount of edible filamentous fungal biomass and liquid dispersion medium—used in the methods disclosed herein can vary based on the desired protein content, texture, and/or flavor of the final solid and/or colloidal food product. In various embodiments, an amount of about 80 wt. % to about 95 wt. % of dispersion can be used in the disclosed methods. In some embodiments, the amount of liquid dispersion used in the disclosed methods is about 83 wt. % to about 91 wt. %.

### Mixed-Format Mycelial Biomass Compositions

Some embodiments of the present disclosure include mycelial biomass compositions that include two or more different mycelial biomass formats. In some embodiments, particularly liquid dispersions of filamentous fungal biomass, the compositions can include two or more different mycelial biomass formats whose proteins can coalesce to form a fungal curd or a gel or other stable colloid under a desired set of conditions (e.g., within a selected pH range). These compositions can include (i) at least one cohesive mycelial biomass format and at least one submerged mycelial biomass format, (ii) at least two different submerged mycelial biomass formats, and/or (iii) at least two different cohesive mycelial biomass formats; compositions characterized by one or more of these conditions (i) through (iii) are referred to herein as “mixed-format mycelial biomat compositions.” A first non-limiting example of a mixed-format mycelial biomass composition according to these embodiments is a mycelial biomass composition comprising a submerged dough as a first mycelial biomass format and biomat pieces (or a liquid dispersion thereof) as a second mycelial biomass format. A second non-limiting example of a mixed-format mycelial biomass composition according to these embodiments is a mycelial biomass composition comprising a submerged dough as a first mycelial biomass format and a submerged flour as a second mycelial biomass format. A third non-limiting example of a mixed-format mycelial biomass composition according to these embodiments is a mycelial biomass composition comprising biomat pieces (or a liquid dispersion thereof) as a first mycelial biomass format and a submerged flour as a second mycelial biomass format.

Mixed-format mycelial biomass compositions according to the present disclosure can possess marked and important advantages and/or benefits relative to many previous conventional mycelial biomass compositions. Particularly, the present inventors have found, surprisingly and unexpectedly, that by combining at least one cohesive mycelial biomass format and at least one submerged mycelial biomass format, and/or at least two different submerged mycelial biomass formats, and/or at least two different cohesive mycelial biomass formats, in a single mycelial biomass composition in the form of a liquid dispersion, the liquid dispersion can form a fungal curd or stable gel by methods of coalescing fungal proteins disclosed herein and/or under conditions that can be controlled, optimized, selected, and/or tuned for a desired application (for example, in a particular pH regime, e.g., particularly at pH values of no more than about 4 and even more particularly at pH values of about 3.5), where previous and/or conventional mycelial biomass compositions cannot be made to form a fungal curd or a gel or other stable colloid by the same methods or under the same conditions. This is an important or necessary feature for making many fungal food products (e.g., mayonnaise analog food products, colloidal sauces, salad dressings, etc.). In particular embodiments of the present disclosure, mycelial biomass compositions of the present disclosure may be formed that behave in a more fluid-like manner at a pH above about 4, and that begin to gel as the pH is reduced below about 4 and form a thick gel as the pH is further reduced to about 3.5; the change in rheology under each of these conditions can be determined by a rheometer. Without wishing to be bound by any particular theory, the present inventors hypothesize that this advantageous and beneficial feature of the mycelial biomass compositions of the present disclosure is the result of intermolecular interactions between proteins of one mycelial biomass format and proteins of another mycelial biomass format, and/or proteins of one mycelial biomass format and oligo- and/or polysaccharides of another mycelial biomass format.

A further advantage and/or benefit of the mixed-format mycelial biomass compositions of the present disclosure relative to many previous conventional mycelial biomass compositions is that the formation of a fungal curd or stable colloid may be reversible, and/or the stable colloid may be configured to transition from one type of colloid to another type of colloid, by reversing the process step that caused coalescence of the fungal proteins in the mixed-format mycelial biomass composition (e.g., by altering the pH to a pH outside the range within which the proteins of the composition coalesce). By way of non-limiting example, mixed-format mycelial biomass compositions according to the present disclosure may form a stable gel (i.e., a stable colloid in which the dispersed phase is a liquid and the dispersion medium is a solid) at a pH of no more than about 4 (and in some embodiments, at a pH of about 3.5 specifically) due to coalescence of the fungal proteins, but the coalescence may be reversed to cause the gel to collapse (i.e., the gel may separate into distinct phases), and/or the gel may transition to a different type of colloid (e.g., an emulsion, a sol, etc.), upon raising the pH to at least about 5.

Most typically, the mixed-format mycelial biomass compositions of the present disclosure include (i) at least one cohesive mycelial biomass format and at least one submerged mycelial biomass format, and/or (ii) at least two different submerged mycelial biomass formats. Without wishing to be bound by any particular theory, the present inventors hypothesize that these combinations of multiple mycelial biomass formats allow for the production of mycelial biomass compositions with combinations of advantageous or beneficial features of each of the two (or more) mycelial biomass formats, or even, in some embodiments, synergistic advantages or benefits (i.e., advantages or benefits that cannot be achieved by any single mycelial biomass format alone), due to intermolecular interactions between the two or more mycelial biomass formats in the mycelial biomass composition.

A first non-limiting example of a submerged mycelial biomass format suitable for use in mixed-format mycelial biomass compositions according to the present disclosure is a submerged slurry. A submerged slurry generally consists of a biomass-containing fluid (e.g., fermentation broth or water) and is produced by growing filamentous fungal biomass in fermentation medium using a submerged fermentation process. In embodiments, the fermentation broth, itself, with the accumulated biomass, constitutes a submerged slurry. In embodiments, a submerged slurry is produced by separating fungal biomass from a liquid fermentation broth, such as by filtration or decanting, washing the separated biomass, such as with water, to remove the fermentation medium, and resuspending the washed biomass in water to provide a submerged slurry. In embodiments, a submerged slurry has a water content level of approximately 85% to 99%.

A second non-limiting example of a submerged mycelial biomass format suitable for use in mixed-format mycelial biomass compositions according to the present disclosure is a submerged dough. Submerged doughs are biomasses with a generally dough-like consistency (i.e., they behave like a wet, solid mass) and are produced by dewatering submerged mycelial biomasses such as a submerged slurry. Submerged dough has a water content of approximately 60-85%.

A third non-limiting example of a submerged mycelial biomass format suitable for use in mixed-format mycelial biomass compositions according to the present disclosure is a submerged flour. Submerged flours are pluralities of relatively fine, low-moisture fungal particles and are produced by drying and grinding or milling a submerged slurry or a submerged dough. In embodiments, submerged flour has a water content of approximately 1-15%. In embodiments, submerged flour has a water content of 5-10%. Most typically, production of a submerged flour requires removal of a greater fraction of water from the output of a submerged fermentation process than production of a submerged dough (i.e., a submerged dough has a higher water content than a submerged flour).

A fourth non-limiting example of a submerged mycelial biomass format suitable for use in mixed-format mycelial biomass compositions according to the present disclosure is a submerged dispersion. Submerged dispersions are flowable compositions (and, in some embodiments, sols, i.e., colloids in which the mycelial biomass is in particulate form and is dispersed throughout a liquid dispersion medium) and are produced by (i) blending a submerged slurry and/or (ii) mixing a submerged dough with a liquid and blending the mixture. In embodiments, a submerged dispersion has a water content of 80-99%. In embodiments, a submerged dispersion has a water content of 85-95%.

A fifth non-limiting example of a submerged mycelial biomass format suitable for use in mixed-format mycelial biomass compositions according to the present disclosure is a submerged spray dried flour. Submerged spray dried flours are pluralities of relatively fine fungal particles and are produced by spray drying a submerged dispersion. In embodiments, a submerged spray dried flour has a water content of less than 1-10%. In embodiments, a submerged spray dried flour has a water content of less than 6%.

A first non-limiting example of a cohesive mycelial biomass format suitable for use in mixed-format mycelial biomass compositions according to the present disclosure is biomat pieces. Biomat pieces are pieces of a biomat (i.e., a mycelial biomass formed by a suitable non-submerged fermentation process, such as a liquid surface fermentation process, a solid-surface (or solid-substrate) fermentation process, a membrane surface fermentation process, and a mesh surface fermentation process) that has been size-reduced or otherwise segmented into a plurality of pieces by cutting or another size reduction technique. In embodiments, biomat pieces have 60-85% water. In embodiments, biomat pieces have 70-80% water. In embodiments, the cohesive mycelial biomass and biomat pieces derived therefrom are free of feedstock on which the filamentous fungal biomass was grown.

A second non-limiting example of a cohesive mycelial biomass format suitable for use in mixed-format mycelial biomass compositions according to the present disclosure is a biomat flour. Biomat flours are pluralities of relatively fine, low-moisture particles in the form of a flour produced by drying and grinding a biomat. In embodiments, biomat flour has a moisture content of 4-14%. In embodiments, biomat flour has a moisture content of 5-10%. In embodiments, biomat flour has a moisture content of less than 6%.

A third non-limiting example of a cohesive mycelial biomass format suitable for use in mixed-format mycelial biomass compositions according to the present disclosure is a biomat dispersion. Biomat dispersions are flowable compositions (and, in some embodiments, sols, i.e. colloids in which the mycelial biomass is in particulate form and is dispersed throughout a liquid dispersion medium) and are produced by mixing a biomat, biomat pieces, or a biomat flour with a liquid. In embodiments, a biomat dispersion has a water content of 80-99.9%. In embodiments, a biomat dispersion has a water content of 85-95%.

A fourth non-limiting example of a cohesive mycelial biomass format suitable for use in mixed-format mycelial biomass compositions suitable for use in the present disclosure is a spray dried biomat flour. Spray dried biomat flours are pluralities of relatively fine fungal particles and are produced by spray drying a biomat dispersion or other fluid that contains a biomat, biomat pieces, or a biomat flour. In embodiments, a spray dried biomat flour has a water content of less than 1-10%. In embodiments, a spray dried biomat flour has a water content of less than 6%, less than 5%, less than 4%, less than 3%, or less than 2%.

In the mixed-format mycelial biomass compositions of the present disclosure, which include at least a first mycelial biomass format and a second mycelial biomass format, a weight ratio between the first and second mycelial biomass formats may take any value in any range that enables the mycelial biomass composition to possess any one or more of the advantageous and beneficial chemical and/or material properties described herein, e.g., the ability to form a stable gel or other stable colloid under acidic conditions. More generally, the weight ratio of the first mycelial biomass format to the second mycelial biomass format may be in any range having a lower bound of A:B and an upper bound of C:D, where A and B are whole numbers whose sum is 100, C and D are whole numbers whose sum is 100, and A is less than C, and/or, in particular embodiments, the weight ratio of the first mycelial biomass format to the second mycelial biomass format may be from about 1:10 to about 10:1 (or any value in any subrange thereof, e.g., about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, or about 9:1). By way of first non-limiting example, where the first mycelial biomass format is a submerged dough and the second mycelial biomass format is biomat pieces (or a liquid dispersion thereof), a weight ratio of the submerged dough to the biomat pieces may be about 75:25. By way of second non-limiting example, where the first mycelial biomass format is a submerged dough and the second mycelial biomass is a submerged flour, a weight ratio of the submerged dough to the submerged flour may be about 40:60.

A first non-limiting example of a type of food material that may be made from a mixed-format mycelial biomass composition according to the present disclosure is a flour. The flour may, but need not, have a particle size of from 30-400 μm. The flour may, but need not, have a particle size of no more than about 400 μm, no more than about 390 μm, no more than about 380 μm, no more than about 370 μm, no more than about 360 μm, no more than about 350 μm, no more than about 340 μm, no more than about 330 μm, no more than about 320 μm, no more than about 310 μm, no more than about 300 μm, no more than about 290 μm, no more than about 280 μm, no more than about 270 μm, no more than about 260 μm, no more than about 250 μm, no more than about 240 μm, no more than about 230 μm, no more than about 220 μm, no more than about 210 μm, no more than about 200 μm, no more than about 190 μm, no more than about 180 μm, no more than about 170 μm, no more than about 160 μm, no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, or no more than about 1 micron, or alternatively no more than about any whole number of μm between about 1 micron and about 400 μm. The particle size may be any one or more of a D₁₀ particle size, a D₂₅ particle size, a D₅₀ particle size, a D₇₅ particle size, a D₉₀ particle size, or a weight-average particle size. In some embodiments, substantially all particles may have a particle size of at least about 30 μm and no more than about 400 μm.

In embodiments in which the food material made from the mixed-format mycelial biomass composition of the present disclosure is a flour, the particle size and particle size distributions may be the same or similar to those conventional for flour-like materials, such as wheat or other flours. In some embodiments, at least 50%, or at least 60%, or at least 70%, or at least 80%, or at least 90% of the particles fall within the range of 0.03 mm to about 0.4 mm, or alternatively in any subrange within this range, such as about 0.03 mm to 0.07 mm, about 0.07 mm to about 0.12 mm, about 0.12 mm to about 0.15 mm, about 0.15 mm to about 2.0, about 0.04 mm to about 0.2 mm, or 0.06 mm to about 0.120 mm or 0.2 mm to about 0.4 mm. In some embodiments, at least 50%, or at least 60%, or at least 70%, or at least 80%, or at least 90% of the particles fall within the range of 0.075 mm to about 0.12 mm.

In some embodiments, at least 50%, or at least 60%, or at least 70%, or at least 80%, or at least 90% of the mass of the particles fall within the range of 0.03 mm to about 0.4 mm, or alternatively in any subrange within this range, such as about 0.03 mm to 0.07 mm, about 0.07 mm to about 0.12 mm, about 0.12 mm to about 0.15 mm, about 0.15 mm to about 2.0, about 0.04 mm to about 0.2 mm, or 0.06 mm to about 0.120 mm or 0.2 mm to about 0.4 mm. In some embodiments, at least 50%, or at least 60%, or at least 70%, or at least 80%, or at least 90% of the mass of the particles fall within the range of 0.075 mm to about 0.12 mm.

In some embodiments, particles of one or more of the mycelial biomass formats present in a flour may be size-reduced. The size reduction may be done using a flour mill, grinder or other conventional equipment for size reduction.

In some embodiments, the moisture content of particles of one or more of the mycelial biomass formats is less than about 15%, about 14%, about 13%, about 12%, about 11%, about 10%, about 9%, about 8%, about 7%, about 6%, about 5%, about 4%, about 3%, about 2% or about 1%. The low moisture levels aid to prevent clumping of the particles.

Flours made from mixed-format mycelial biomass compositions according to the present disclosure are useful in the preparation of food materials such as baked goods, including but not limited to bread, rolls, muffins, cakes, cookies, pies, etc. or can be sprinkled on other food products.

A second non-limiting example of a type of food material that may be made from a mixed-format mycelial biomass composition according to the present disclosure is a plurality of solid particles other than a flour. In embodiments of such pluralities of solid particles other than a flour, at least 50%, or at least 60%, or at least 70%, or at least 80%, or at least 90% of the particles may have a particle length of about 0.05 mm to about 500 mm, a particle width of about 0.03 mm to about 7 mm, and a particle height of about 0.03 mm to about 1.0 mm, or alternatively in any subranges within these ranges. For example, at least 50%, or at least 60%, or at least 70%, or at least 80%, or at least 90% of the particles may have a particle length of about 0.08 mm to about 100 mm, or 10 mm to about 70 mm, or 130 mm to about 200 mm; a particle width of about 0.05 mm to about 2 mm, or about 1 mm to about 3 mm, or about 4 mm to about 6 mm; and a particle height of about 0.03 mm to about 0.06 mm, or about 0.04 mm to about 0.07 mm, or about 0.08 mm to about 1.0 mm.

In some embodiments, at least one mycelial biomass format in mixed-format mycelial biomass compositions according to the present disclosure is in the form of particles wherein at least 50%, or at least 60%, or at least 70%, or at least 80%, or at least 90% of the mass of the particles have a particle length of about 0.05 mm to about 500 mm, a particle width of about 0.03 mm to about 7 mm, and a particle height of about 0.03 mm to about 1.0 mm, or alternatively in any subranges within these ranges. For example, at least 50%, or at least 60%, or at least 70%, or at least 80%, or at least 90% of the mass of the particles may have a particle length of about 0.08 mm to about 100 mm, or 10 mm to about 70 mm, or 130 mm to about 200 mm; a particle width of about 0.05 mm to about 2 mm, or about 1 mm to about 3 mm, or about 4 mm to about 6 mm; and a particle height of about 0.03 mm to about 0.06 mm, or about 0.04 mm to about 0.07 mm, or about 0.08 mm to about 1.0 mm. For example, at least 50%, or at least 60%, or at least 70%, or at least 80%, or at least 90% of the particles may have a particle length of about 0.08 mm to about 100 mm, or 10 mm to about 70 mm, or 130 mm to about 200 mm; a particle width of about 0.05 mm to about 2 mm, or about 1 mm to about 3 mm, or about 4 mm to about 6 mm; and a particle height of about 0.03 mm to about 0.06 mm, or about 0.04 mm to about 0.07 mm, or about 0.08 mm to about 1.0 mm.

In some embodiments of food materials made from mixed-format mycelial biomass compositions according to the present disclosure in the form of a plurality of solid particles other than a flour, at least one mycelial biomass format may mimic the texture and chewiness of meat products such as chicken nuggets or hamburgers, and the food materials may thus be useful in the preparation of meat analogs and/or meat fillers and/or extenders. In use, meat product fillers or extenders according to the present disclosure may be adapted to be mixed with animal meat in a ratio of from 10:90 to 90:10, or any subrange therebetween.

In some embodiments of food materials made from mixed-format mycelial biomass compositions according to the present disclosure in the form of a plurality of solid particles other than a flour, at least one mycelial biomass format may comprise particles in which at least 90% of the particles with lengths less than about 1.5 mm and the majority of lengths being 1 mm or less, widths of less than about 1 mm, and heights of less than about 0.75 mm. Mycelial biomass formats comprising such particles may be characterized as having a higher perceived density in the mouth, may be easier to chew, may offer a creamy mouth feel and a more refined food experience, and/or may be used to prepare a food material that resembles a hamburger found in fine dining establishments.

In some embodiments of food materials made from mixed-format mycelial biomass compositions according to the present disclosure in the form of a plurality of solid particles other than a flour, at least one mycelial biomass format may comprise particles in which at least about 90% of the particles with lengths between about 4 mm and about 10 mm, widths of about 1.0 mm to about 3 mm, and heights of less than 0.75 mm. Mycelial biomass formats comprising such particles may be found to lend a heartier food experience, similar to the type of burger commonly found in specialty burger restaurants or barbecues.

A third non-limiting example of a type of food material that may be made from a mixed-format mycelial biomass composition according to the present disclosure is a liquid dispersion, and especially a dispersion of particles of two or more mycelial biomass formats in an aqueous liquid. In some embodiments, the liquid dispersion may be a replacement ingredient for milk or a milk analog.

In some embodiments of food materials made from mixed-format mycelial biomass compositions according to the present disclosure in the form of a liquid dispersion, at least one mycelial biomass format may comprise particles smaller than about 10 μm. In some embodiments, at least 50%, or at least 60%, or at least 70%, or at least 80%, or at least 90% of the particles of at least one mycelial biomass format may fall within a particle size range of about 1 μm to about 10 μm, or alternatively in any subrange within this range. In some embodiments, at least 50%, or at least 60%, or at least 70%, or at least 80%, or at least 90% of the particles of at least one mycelial biomass format may have a particle size of less than 10 μm, less than 9 μm, less than 8 μm, less than 7 μm, less than 6 μm, less than 5 μm, less than 4 μm, less than 3 μm, less than 2 μm, or less than 1 micron. In some embodiments, at least about 50%, or at least about 60%, or at least about 70%, or at least about 80%, or at least about 90% of the particles of at least one mycelial biomass format may have a particle size of less than about 1 micron.

In some embodiments of food materials made from mixed-format mycelial biomass compositions according to the present disclosure in the form of a liquid dispersion, a weight ratio of one or more mycelial biomass formats to water can be adjusted to produce a liquid dispersion of the appropriate consistency and density. The ratio of the one or more mycelial biomass formats to water can range from about 1:10 to about 10:1 or any range of ratios in between. In some embodiments, the ratio of the one or more mycelial biomass formats to water can be about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, or about 10:1.

In some embodiments, liquid dispersion food materials according to the present disclosure are stable such that at least one mycelial biomass format does not, and preferably none of the mycelial biomass formats, readily separate from the liquid medium. For example, upon forming the dispersion, the dispersion may appear to be homogeneous in appearance and may not visibly separate into distinct phases, and/or no visibly discernable or significant sediment may form on the bottom of the container holding the dispersion. In some embodiments, the liquid dispersion may remain stable for at least about one hour, at least about two hours, at least about three hours, at least about four hours, at least about five hours, at least about six hours, at least about seven hours, at least about eight hours, at least about nine hours, at least about ten hours, at least about eleven hours, at least about twelve hours, at least about thirteen hours, at least about fourteen hours, at least about fifteen hours, at least about sixteen hours, at least about seventeen hours, at least about eighteen hours, at least about nineteen hours, at least about twenty hours, at least about 21 hours, at least about 22 hours, at least about 23 hours, at least about one day, at least about two days, at least about three days, at least about four days, at least about five days, at least about six days, at least about one week, at least about two weeks, at least about three weeks, at least about four weeks, at least about one month, at least about two months, at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months, at room temperature and/or at a refrigerated temperatures, e.g., about 35° F. (1.6° C.).

In some embodiments, liquid dispersion food materials according to the present disclosure may comprises at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, or at least about 20% solids. In other embodiments, a liquid dispersion food material according to the present disclosure may have a solids content of about 4% to about 30%, or in any sub-range between 4% and 30%; particularly, the solids content may in some embodiments be about 5% to about 15%, or about 6.25% to about 10%.

Liquid dispersion food materials according to the present disclosure can be used as a drink or beverage, including as a substitute for any milk product such as dairy milk, almond milk, rice milk, soy milk, etc. These food materials can also be used in a number of recipes, including recipes for soups, ice cream, yogurt, smoothies, fudge, and candies such as caramel and truffles.

A fourth non-limiting example of a type of food material that may be made from a mixed-format mycelial biomass composition according to the present disclosure is an emulsion. In emulsion food materials according to the present disclosure, either or both of the dispersed liquid phase and the liquid dispersion medium may be part of one or more of the mycelial biomass formats or may be a component separate from the mycelial biomass formats.

In some embodiments, the food material may be a particle-stabilized emulsion, otherwise known as a Pickering emulsion. In these embodiments, one or more of the mycelial biomass formats may stabilize the colloid by adsorbing onto the interface between the dispersed phase and the dispersion medium, e.g., the interface between air bubbles and the solid phase in an ice cream analog food product or the interface between oil droplets and water in a mayonnaise analog food product.

One or more of the mycelial biomass formats in emulsion food materials according to the present disclosure may have a desired hydrophilic-lipophilic balance (HLB) of between about 3 and about 16, in some embodiments between about 3 and about 6 (e.g., to stabilize a water-in-oil emulsion) or between about 8 and about 16 (e.g., to stabilize an oil-in-water emulsion, such as a mayonnaise analog food product).

Another important parameter related to the stability of emulsion food materials according to the present disclosure is contact angle, i.e., the angle formed by two phase interfaces (generally between a liquid-gas interface, e.g., at the surface of a liquid droplet, and a liquid-solid interface, e.g., where a liquid droplet rests on a solid substrate). A low contact angle (e.g., close to) 0° demonstrates high surface energy, as the liquid droplet tends to spread across and adhere to the solid surface, whereas a high contact angle (e.g., close to) 90° demonstrates the solid surface's tendency to repel the liquid droplet. In emulsion food materials according to the present disclosure, the contact angle of the colloidal food composition on a solid surface such as a silicon wafer, at ambient conditions (e.g. about 25° C. and about 1 atm of pressure) may generally be between about 45° and about 75°; the surface energy, and thus the contact angle, of the emulsion food material may, in some embodiments, be controlled, selected, and/or tuned by selection of one or more especially suitable mycelial biomass formats. Without wishing to be bound by any particular theory, it is believed that selecting one or more especially suitable mycelial biomass formats may allow for the formulation of emulsion food materials having excellent stability, e.g., including filamentous fungal particles having high water wettability (for highly stable oil-in-water emulsions), high oil wettability (for highly stable water-in-oil emulsions), and/or a balance between these two characteristics.

A fifth non-limiting example of a type of food material that may be made from a mixed-format mycelial biomass composition according to the present disclosure is a foam, and in particular a foam that is stable insofar as it does not spontaneously collapse immediately upon cessation of the foaming process; such foaming processes can include whipping with a whipping appliance, incorporation of compressed gases or other conventional foaming processes. In some embodiments, foam food materials according to the present disclosure may be made by subjecting a liquid dispersion food material, an emulsion food material, and/or a sol food material according to the present disclosure to such a foaming process.

Foam food materials according to the present disclosure may be smooth and creamy in appearance and show the presence of bubbles in a distribution of sizes, wherein larger bubbles tend to pop after sitting or being poured but smaller bubbles remain for a longer time to form a stable foam product. Foam food materials according to the present disclosure may have compositional characteristics similar to those of a liquid dispersion food material according to the present disclosure, with the addition of air or other gas incorporated into the food material in a stable manner. For example, a foam food material according to the present disclosure can have an increased volume (i.e., overrun) by incorporation of air of at least about 10%, at least about 20%, at least about 30%, at least about 40%, at least about 50%, at least about 75%, at least about 100%, at least about 200%, at least about 300%, at least about 400%, or at least about 500%, as compared to the starting volume of the liquid material prior to foaming. In various embodiments, a foam food material according to the present disclosure may have a foam stability of at least about 50%, at least about 60%, at least about 70%, at least about 80%, at least about 90%, or at least about 95% for at least about one day, at least about two days, at least about three days, at least about four days, at least about five days, at least about six days, at least about seven days, at least about eight days, at least about nine days, at least about ten days, at least about eleven days, at least about twelve days, at least about thirteen days, at least about fourteen days, at least about fifteen days, at least about sixteen days, at least about seventeen days, at least about eighteen days, at least about nineteen days, at least about twenty days, at least about 21 days, at least about 22 days, at least about 23 days, at least about 24 days, at least about 25 days, at least about 26 days, at least about 27 days, at least about 28 days, at least about 29 days, at least about 30 days, at least about one month, at least about two months, or at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months.

In foam food materials according to the present disclosure, an average overrun of about 12% may be suitable for preparing ice cream (with more fat and emulsifiers), frozen yogurt, cheesecake batters, whipped toppings, etc. In some embodiments, the foam food material may incorporate nitrogen to provide different overrun characteristics.

A sixth non-limiting example of a type of food material that may be made from a mixed-format mycelial biomass composition according to the present disclosure is a gel. Particularly, as disclosed more fully elsewhere throughout this disclosure, food materials according to the present disclosure may be gels under a certain pH regime (e.g., at a pH of no more than about 4 and/or at a pH of about 3.5) but take a different physical form (e.g., a liquid dispersion, an emulsion, a foam, a sol, etc.) under a different pH regime (e.g., at a pH of at least about 5).

A seventh non-limiting example of a type of food material that may be made from a mixed-format mycelial biomass composition according to the present disclosure is a solid foam. In solid foam food materials according to the present disclosure, one stability parameter of interest is foam stability, i.e., the proportion of an initial volume of the solid foam that is retained by the solid foam after a specified interval, to allow for the creation of a solid foam that does not rapidly spontaneously collapse. The foaming process can include whipping with a whipping appliance, incorporation of compressed gases, or other conventional foaming processes, and will generally result in the formation of gas bubbles in a variety of sizes. The larger bubbles tend to pop after sitting or being poured, but smaller bubbles may remain in suspension for a long time to form a stable solid foam. A solid foam food material according to the present disclosure can have an increased volume (i.e., overrun) by incorporation of air of at least about 10%, at least about 20%, at least about 30%, at least about 40%, at least about 50%, at least about 75%, at least about 100%, at least about 200%, at least about 300%, at least about 400%, or at least about 500%, as compared to the starting volume of the solid dispersion medium prior to foaming. In various embodiments, a solid foam food material according to the present disclosure may have a foam stability of at least about 50%, at least about 60%, at least about 70%, at least about 80%, at least about 90%, or at least about 95% for at least about one day, at least about two days, at least about three days, at least about four days, at least about five days, at least about six days, at least about seven days, at least about eight days, at least about nine days, at least about ten days, at least about eleven days, at least about twelve days, at least about thirteen days, at least about fourteen days, at least about fifteen days, at least about sixteen days, at least about seventeen days, at least about eighteen days, at least about nineteen days, at least about twenty days, at least about 21 days, at least about 22 days, at least about 23 days, at least about 24 days, at least about 25 days, at least about 26 days, at least about 27 days, at least about 28 days, at least about 29 days, at least about 30 days, at least about one month, at least about two months, or at least about three months, at least about four months, at least about five months, at least about six months, at least about seven months, at least about eight months, at least about nine months, at least about ten months, at least about eleven months, at least about twelve months, at least about thirteen months, at least about fourteen months, at least about fifteen months, at least about sixteen months, at least about seventeen months, or at least about eighteen months.

### Additional Ingredients

Before, during, or after pH adjustment, addition of functional ingredient(s), and/or addition of salt(s) as described in the following sections of this disclosure, other components that impart beneficial qualities to the coalesced protein composition can be added to the liquid dispersion. For example, flavoring agents can be added to help the coalesced protein composition more closely resemble a selected non-fungal food product (e.g., cheese, tofu, etc.) in taste, dairy enhancers may be added to impart a creamier texture, and/or taste modulators can be added to impart a desired mouthfeel, mask undesirable flavor notes, and/or improve the overall taste of the disclosed food products.

Suitable flavoring agents can include, for example, half and half flavoring, cottage cheese flavoring, milk flavoring, cheese culture flavoring, cream flavoring, butter flavoring, and the like. Such flavoring agents, in a vegan food context, are commercially available preparations that contain flavoring agents that mimic half and half, cottage cheese, milk, butter, and the like. Most commercially available products are water-soluble flavoring agents, suitable for addition to the aqueous dispersion before, during, or after pH adjustment, addition of functional ingredient(s), and/or addition of salt(s). Flavoring agents can be mixed and matched in a variety of ways, to achieve a desired flavor profile in a final coalesced protein-containing food product. The amount of any one flavoring agent used in the disclosed methods can vary based on the desired flavor of the final coalesced protein product. In various embodiments, an amount of 0.05 wt. %-3.0 wt. % of a single flavoring agent can be used. In some embodiments, the amount of a single flavoring agent used in the disclosed methods is selected from 0.05 wt. %, 0.1 wt. %, 0.15 wt. %, 0.2 wt. %, 0.25 wt. %, and 0.3 wt. %.

Dairy enhancers can also be added to the disclosed liquid dispersions before, during, or after pH adjustment, addition of functional ingredient(s), and/or addition of salt(s). Dairy enhancers are typically made from natural or artificial flavoring agents and are used to add a dairy-like flavor to non-dairy products, to mask off flavors, reduce or augment fat contents, reduce sodium contents, and/or reduce sugar contents. Dairy enhancers are commercially available preparations that are water-soluble, suitable for addition to the aqueous dispersion before, during, or after pH adjustment, addition of functional ingredient(s), and/or addition of salts. Dairy enhancers can be mixed and matched in a variety of ways, to achieve a desired flavor profile in a final coalesced protein-containing food product, but in some particular embodiments, only a single dairy enhancer may be used.

The amount of any one dairy enhancer used in the disclosed methods can vary based on the desired flavor of the final coalesced protein-containing food product. In various embodiments, an amount of 0.05 wt. %-3.0 wt. % of a single dairy enhancer can be used. In some embodiments, the amount of a single dairy enhancer used in the disclosed methods is selected from 0.05 wt. %, 0.1 wt. %, 0.15 wt. %, 0.2 wt. %, 0.25 wt. %, and 0.3 wt. %.

Taste modulators can also be added to the disclosed dispersions before, during, or after pH adjustment, addition of functional ingredient(s), and/or addition of salt(s). Taste modulators, for example Modumax® (Royal DSM, NL), are natural compositions that help create improved taste profiles in food products that may contain high intensity sweeteners, are low in fat, or that contain higher protein content resulting in undesirable flavor notes. These modulators mask certain undesirable flavors and enhance other, desirable, flavors. For example, a plantmasker is a preparation that will mask the green and/or beany flavors of certain plant ingredients. They are commercially available preparations that are typically water-soluble, suitable for addition to the liquid dispersion before, during, or after pH adjustment, addition of functional ingredient(s), and/or addition of salt(s). Taste modulators are typically used one at a time in a single formulation, but they can also be mixed and matched in a variety of ways to achieve a desired flavor profile in a final coalesced protein-containing food product.

The amount of any one taste modulator used in the disclosed methods can vary based on the desired flavor of the final coalesced protein-containing food product. In various embodiments, an amount of 0.01 wt. %-1.0 wt. % of a single taste modulator can be used. In some embodiments, the amount of a single taste modulator used in the disclosed methods is selected from 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, and 0.1 wt. %.

Sugars and salts (other than the saccharides and/or salts used to induce coalescence of fungal proteins, as further described below) can also be added to the disclosed liquid dispersions to taste, to enhance the flavor of the final coalesced protein-containing food product. Any suitable form of food grade sugar can be used (e.g., dextrose, sucrose, and the like). In some embodiments, the amount of sugar used in the disclosed methods is 1.0 wt. %-3.0 wt. %. Any suitable form of food grade salt, typically sodium and/or chloride salts and most typically sodium chloride, can also be used (e.g., sea salt, Kosher salt, and the like). In some embodiments, the amount of salt used in the disclosed methods is 0.5 wt. %-0.8 wt. %.

In some embodiments of the methods disclosed herein, an oil and/or solid fat is, or one or more oils and/or solid fats are, incorporated into the liquid dispersion of filamentous fungal particles. In a typical embodiment, oils and/or solid fats may be included in the disclosed liquid dispersion to impart a cheese-like texture to the fungal curd and/or gel formed upon coalescence of the fungal proteins. Any suitable food grade oil and/or solid fat, or blends of food grade oils and/or solid fats, may be used in the disclosed methods. Oils and/or solid fats may be selected for their taste, texture, melting temperature, perceived moisture content, or any combination thereof. For example, some oils, such as olive oils, have a distinctive taste that can be imparted to the coalesced protein composition. Alternatively, a neutral-flavored oil, such as coconut or soybean oil, may be desired, to avoid imparting any strong flavor to the coalesced protein composition.

Oils suitable for use in the disclosed methods, either alone or in combination with one or more other oils and/or solid fats, include acai oil, almond oil, amaranth oil, apricot oil, argan oil, artichoke oil, avocado oil, ben oil (extracted from the seeds of Moringa oleifera), blackcurrant seed oil, borage seed oil, Borneo tallow nut oil, buffalo gourd oil, canola oil, carob pod oil, cashew oil, coconut oil, coriander seed oil, corn oil, cottonseed oil, evening primrose oil, false flax oil, grapeseed oil, hazelnut oil, hemp oil, kapok seed oil, macadamia oil, meadowfoam seed oil, mustard oil, okra seed oil, olive oil, palm oil, peanut oil, pecan oil, perilla seed oil, pequi oil, pine nut oil, pine seed oil, pistachio oil, poppyseed oil, prune kernel oil, pumpkin seed oil, quinoa oil, ramtil oil, rice bran oil, safflower oil, sesame oil, soybean oil, sunflower oil, tea oil, thistle oil, walnut oil, and wheat germ oil.

Solid fats suitable for use in the disclosed methods, either alone or in combination with one or more other oils and/or solid fats, include blubber, butter, chicken fat, clarified butter, cocoa butter, dripping, duck fat, fatback, lard, mango butter, margarine, schmaltz, shea butter, speck, suet, tail fat, tallow, and vegetable shortening.

The amount of oil and/or solid fat, or combinations of oils and/or solid fat, used in the disclosed methods can vary based on the desired texture and/or flavor of the final coalesced protein composition. In various embodiments, an amount of 4 wt. %-10 wt. % of oil and/or solid fat can be used in the disclosed methods. In some embodiments, the amount of oil and/or solid fat used in the disclosed methods is selected from 4.0 wt. %, 4.5 wt. %, 5.0 wt. %, 5.5 wt. %, 6.0 wt. %, 6.5 wt. %, 7.0 wt. %, 7.5 wt. %, 8.0 wt. %, 8.5 wt. %, 9.0 wt. %, 9.5 wt. %, and 10 wt. %.

Incorporating the oil and/or solid fat into the liquid dispersion of filamentous fungal particles can be difficult, because oils and/or solid fats are typically immiscible with water, which in most embodiments makes up all or the majority of the liquid phase of the liquid dispersion. In various embodiments, it is therefore useful to include an emulsifying agent to facilitate the stability of the dispersion. Emulsifiers suitable for use in the disclosed methods are typically FDA-approved food additives. Suitable emulsifiers can be man-made or naturally occurring. For example, numerous hydrocolloids serve as thickening agents and support the structure, texture, flavor, and shelf life of various food products. They are often referred to simply as gums because of the food texture and consistency they create. Hydrocolloids include emulsifiers made from plants, animals, and aquatic sources. Plant-based hydrocolloids include locust bean gum, carrageenan, pectin, and starch, while animal-sourced varieties including chitosan made from crustacean shells. Hydrocolloids, like xanthan gum, can also come from microbial sources.

In some embodiments, emulsifiers suitable for use in the disclosed methods include carboxymethylcellulose, carrageenan, cellulose, guar gum, lecithin, mono- and di-glycerides of fatty acids, polyglycerol esters of fatty acids, polyglycerol polyricinoleate, polysorbates, stearoyl lactylates, sorbitan esters, sucrose esters, sucroglycerides, xanthan gum, and combinations thereof.

The amount of emulsifier used in the disclosed methods can vary. In various embodiments, an amount of 0.1 wt. %-1.0 wt. % of emulsifier is used. In some embodiments, the amount of emulsifier used in the disclosed methods is 0.2 wt. %-0.5 wt. %. In some embodiments, the amount of emulsifier used in the disclosed methods is selected from 0.1 wt. %, 0.2 wt. %, 0.3 wt. %, 0.4 wt. %, 0.5 wt. %, 0.6 wt. %, 0.7 wt. %, 0.8 wt. %, 0.9 wt. %, and 1.0 wt. %.

### Coalescence of Fungal Proteins Via pH Adjustment

In some embodiments of the present disclosure, coalescence of filamentous fungal proteins is induced by adjusting the pH (e.g., by adding one or more acids or bases) of the liquid dispersion of filamentous fungal particles. In some embodiments, this coalescence results in the formation of a fungal curd, i.e., a solid mass of filamentous fungal proteins (and, in some cases, other components) that can be separated from the remaining liquid phase, similar to the manner in which proteins are coagulated from animal milks (to form curd) or soy milk (to form tofu), while in other embodiments the coalescence results in the formation of a gel material, i.e., a phase that holds its shape and is resistant to flow, in which the liquid phase is dispersed throughout a network formed by the filamentous fungal proteins (and, in some cases, other compounds).

Filamentous fungal particles in liquid dispersions according to the present disclosure are characterized by an isoelectric point (pI), i.e., a specific pH at which the surfaces of the particles have no net electrical charge or are electrically neutral; thus, the relationship between the pH of the liquid dispersion and the pI of the filamentous fungal particles strongly affects the relative affinity of the filamentous fungal particles to electrostatically interact with themselves, the molecules of the liquid phase (e.g., water molecules), and/or molecules of other compounds within the liquid dispersion (e.g., functional ingredients, salts, etc.). The present inventors therefore hypothesize, without wishing to be bound by any particular theory, that adjustment of the pH of the liquid dispersion of filamentous fungal particles may cause coalescence of the filamentous fungal particles by any one or more of several mechanisms.

By way of first non-limiting example, where the liquid dispersion is a mixed-format mycelial biomass composition comprising at least two mycelial biomass formats with different isoelectric points, there may be a pH range within which particles of the two mycelial biomass formats are electrostatically attracted to each other and form networks of fungal proteins. Particularly, as further described elsewhere throughout this disclosure, the present inventors have found that mixed-format mycelial biomass compositions comprising, e.g., biomat pieces and submerged dough or submerged flour and submerged dough in varying ratios, may form non-flowable gels by coalescence of fungal proteins within a particular pH range (e.g., around about pH 3.5), but adjusting the pH outside of this range (e.g., to less than about 3 or more than about 4) results in a reversing of the coalescence such that the gel “collapses” and returns to a flowable, liquid state.

By way of second non-limiting example, where the liquid phase of the liquid dispersion comprises a significant quantity of a polar liquid (e.g., water), there may be a pH range within which filamentous fungal particles in the liquid dispersion are repulsed by, or at least have little or no electrostatic attraction to, the molecules of the polar liquid and thus have a greater tendency to aggregate with themselves or other solid components within the liquid dispersion, while outside this pH range the filamentous fungal particles are attracted to the polar molecules and thus have a greater tendency to remain stably dispersed in the liquid dispersion. Particularly, as further described elsewhere throughout this disclosure, the present inventors have found that liquid dispersions of biomat pieces can be prepared that form non-flowable gels by coalescence of fungal proteins within a particular pH range (e.g., around about pH 3.5), but adjusting the pH outside of this range (e.g., to less than about 3 or more than about 4) results in a reversing of the coalescence such that the gel collapses and returns to a flowable, liquid state.

By way of third non-limiting example, where the liquid dispersion comprises non-fungal proteins and/or oligo- and/or polysaccharides, the fungal proteins within the liquid dispersion may be subjected to differing electrostatic interactions with the non-fungal proteins and/or oligo- and/or polysaccharides in different pH regimes, depending on the pI of the non-fungal proteins and/or oligo- and/or polysaccharides. Particularly, as further described elsewhere throughout this disclosure, the present inventors have found that in certain liquid dispersions of filamentous fungal particles that include non-fungal proteins (e.g., potato protein, chickpea protein, etc.) and/or oligo- and/or polysaccharides (e.g., maltodextrin), where the pH at which biopolymer complexes form (hereinafter denoted pH_{Φ}) differs from the pI of the fungal particles, the fungal proteins and the non-fungal components may begin to form soluble complexes as the pH is adjusted toward pH_{Φ} (“Stage I” coalescence), then form larger interpolymeric complexes as the pH is further adjusted into a range between pH_{Φ} and the pI of the fungal particles (“Stage II” coalescence), and finally form a highly networked gel as the pH is still further adjusted beyond the pI of the fungal particles (“Stage III” coalescence).

By way of fourth non-limiting example, where the liquid dispersion comprises salts, there may be a pH range within which ionic salt “bridges” between fungal protein molecules form. Particularly, as further described elsewhere throughout this disclosure, the present inventors have found that in certain liquid dispersions of filamentous fungal particles, the fungal proteins may coalesce into “fine” networks (i.e., networks having relatively low concentrations of ionic salt “bridges”) when the pH is relatively far from the pI of the fungal material and salts are present at a relatively low ionic strength, and/or may coalesce into “particulate” or “coarse” networks (i.e., networks having relatively high concentrations of ionic salt “bridges”) when the pH is relatively close to the pI of the fungal material and salts are present at a relatively high ionic strength.

Coalescence of fungal proteins via pH adjustment occurs when one or more food-safe acids or bases are introduced into the liquid dispersion to cause coalescence. These acids or bases can be added directly, and/or they can be produced by live microbial cultures. In embodiments in which the acids or bases are added directly, suitable acids for decreasing the pH of the liquid dispersion of filamentous fungal particles include sorbic acid, benzoic acid, formic acid, acetic acid, dehydroacetic acid, lactic acid, propionic acid, boric acid, malic acid, fumaric acid, ascorbic acid, erythorbic acid, citric acid, tartaric acid, phosphoric acid, metatartaric acid, adipic acid, succinic acid, thiodipropionic acid, phytic acid, alginic acid, hydrochloric acid, sulfuric acid, gluconic acid, glutamic acid, guanylic acid, inosinic acid, cyclamic acid, cholic acid, and combinations thereof, and suitable bases for increasing the pH of the liquid dispersion of filamentous fungal particles include iron hydroxides, sodium hydroxide, potassium hydroxide, calcium hydroxide, ammonium hydroxide, magnesium hydroxide, and combinations thereof. In embodiments in which the acids or bases are produced by live microbial cultures, the microbial culture may include any one or more bacteria, molds, or yeasts suitable for fermentation of food products; fermentation by these microorganisms typically results in conversion of a sugar (e.g., lactose) to an acid (e.g., lactic acid), thus acidifying the liquid dispersion, and non-limiting examples of microorganisms suitable for use in these embodiments include starter lactic acid bacteria (e.g., Lactococcus lactis ssp. lactis, Lactococcus lactis ssp. cremoris, Streptococcus salivarius ssp. thermophilus, Lactobacillus helveticus, etc.) and non-starter lactic acid bacteria (e.g., Lactobacillus casei ssp. casei, Lactobacillus plantarum, etc.). In some embodiments, the pH adjustment-induced coalescence of fungal proteins may be aided by heating and/or cooling the liquid dispersion before, during, and/or after addition of the acid(s) or base(s).

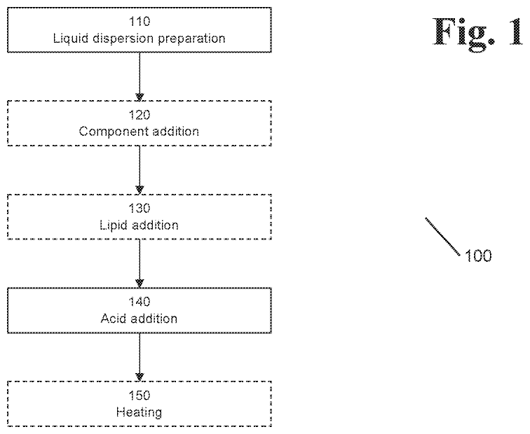

Referring now to FIG. 1, one non-limiting embodiment of a method 100 for making a composition comprising coalesced fungal proteins (e.g., a fungal curd, a fungal gel, etc.) via pH adjustment is illustrated. The embodiment of the method 100 illustrated in FIG. 1 includes a liquid dispersion preparation step 110, an optional component addition step 120, an optional lipid addition step 130, an acid addition step 140, and an optional heating step 150.

In the liquid dispersion preparation step 110, a liquid dispersion of edible filamentous fungi is prepared by combining water and one or more mycelial biomass formats in ratios as described herein, such as about 30:1, 27:1, or 20:1, or alternatively in any ratio that results in a dispersion having a solids content of about 0.1 wt. % to about 15 wt. % (e.g., in some embodiments in which the liquid phase is water, having a water content of about 85 wt. % to about 99.9 wt. %). The water and mycelial biomass formats are placed into an apparatus containing rotating blades, for example a blender or an impeller, and sheared until smooth. In this embodiment, shearing occurs by high speed blending or mixing (e.g., at about 10,000+ rpm), non-stop, for a period of at least 2-10 minutes, or until a stable, homogeneous dispersion is achieved; shear mixing is desirable to achieve a satisfactory homogeneity of the fungal material in the water, and to fully disintegrate any possible agglomerates. This step can occur without the addition of any heat, though if desired heat (e.g., 90° F.-120° F., 32.2° C.-48.9° C.) can be applied to facilitate generation of a homogeneous mixture.

In the optional component addition step 120, such components as additional (e.g., non-fungal) proteins, flavoring agents, salts, sugars, etc., may be added to the liquid dispersion. In some embodiments, a mixture of non-fungal proteins is added to the dispersion in a combined amount of about 0.25-10 wt. %, in some embodiments in a combined amount of about 3.0-4.0 wt. %, and in some embodiments about 3.5 wt. %. For example, a soy protein powder (e.g., a soy flour) and an 80% strength hemp protein powder preparation may be added, either in even amounts or in varying concentrations. A calcium or magnesium salt may also be added in an amount of about 0.01-0.5 wt. %, typically about 0.1-0.3 wt. % and most typically about 0.2 wt. %, as may be any desired flavoring agents (e.g., half and half flavoring, cottage cheese flavoring, milk flavoring, etc.) in a combined amount of about 0.4-0.8 wt. %, in some embodiments about 0.6 wt. %; dairy enhancers in an amount of about 0.1-0.3 wt. %, in some embodiments about 0.2 wt. %; and any desired flavor modulator in an amount of about 0.01-0.05 wt. %, in some embodiments about 0.03 wt. %. Salt and sugar may be added to taste (e.g., in amounts of about 0.5 wt. % and about 1.0 wt. %, respectively). All of these components are then mixed into the dispersion until completely dissolved. In some embodiments, this optional component addition step 120 may include heating the liquid dispersion, for example to about 90° F.-120° F. (32.2° C.-48.9° C.), in some embodiments to 110° F. (43.3° C.), and allowing the liquid dispersion to stand at temperature for about 5-20 minutes, in some embodiments for about 10 minutes; this heating may be carried out to ensure that any powdered components added to the mixture are sufficiently hydrated, thereby minimizing agglomerates or pockets of dry, inactive components.

In the optional lipid addition step 130, an oil and/or solid fat or a blend of two or more oils and/or solid fats may be added to the liquid dispersion, in an amount of about 4 wt. %-10 wt. %; in one particular embodiment, coconut oil is added in an amount of about 10 wt. %. The lipid-dispersion combination is then mixed in any manner suitable to ensure homogeneity, i.e., that the oil and/or solid fat is fully incorporated into the liquid dispersion. As a first non-limiting example of a suitable mixing technique, the lipid-dispersion combination may be mixed in the blender or with the impeller until it is visually homogenous. As a second non-limiting example of a suitable mixing technique, the lipid-dispersion combination may be subjected to high shear mixing (e.g., at about 10,000+ rpm), non-stop, for a period of at least 2-10 minutes, or until a stable, homogeneous lipid-dispersion combination is achieved. As a third non-limiting example of a suitable mixing technique, the lipid-dispersion combination may be homogenized under pressure (about 160 bar) using a high-pressure homogenizer.

In the acid addition step 140, one or more acids are added to the liquid dispersion to reduce the pH of the liquid dispersion to a pH at which a desired extent or type of coalescence of fungal proteins occurs. By way of first non-limiting example, where the liquid dispersion comprises an oil and/or solid fat and it is desired to form a soft fungal curd useful for making, e.g., a soft cheese analog food product, the pH of the liquid dispersion may be reduced to about 5.5-6.0. By way of second non-limiting example, where the liquid dispersion is a mixed-format mycelial biomass composition and it is desired to cause the two or more mycelial biomass formats to coalesce to transform the liquid dispersion into a non-flowable gel, the pH of the liquid dispersion may be reduced to about 3.5. The amount of acid added in the acid addition step 140 thus depends both on the “target” pH and the particular acids being used, which may be selected such that the target pH can be achieved without exceeding regulatory or safety limits for the acid(s) in food materials/products; by way of non-limiting example, where it is desired to reduce the pH of the liquid dispersion from about 7.0-7.5 to about 5.5-6.0, a weaker acid (e.g., lactic acid, citric acid, or a combination thereof) may be used in an amount of about 2-3 g/L, whereas if it is desired to reduce the pH to a lower value of about 3.5, a smaller quantity of a stronger acid (e.g., hydrochloric acid) may be used. The dispersion-acid combination is then mixed for a time sufficient to ensure distribution of the acid; optionally, the liquid dispersion may be allowed to stand without mixing for a period of, e.g., about 5-15 minutes. Optionally, the liquid dispersion may be heated (e.g., to about 160° F.-175° F. (71.1° C.-79.4° C.)) and/or mixed during the acid addition step 140; mixing and/or heating may help to ensure that the liquid dispersion does not separate before coalescence of the fungal proteins is complete.

In the optional heating step 150, the liquid dispersion is heated to about 185° F.-200° F. (85° C.-93.3° C.), with or without mixing; in some embodiments, the mixing and/or heating may help to ensure complete coalescence of the fungal proteins, for example by increasing the physical contact between the acid(s) and the fungal particles. The temperature is typically maintained for at least about 30 seconds, and in some embodiments for a period of about 1-10 minutes.

Optionally, although not illustrated in FIG. 1, the coalesced fungal protein composition can then be processed further. By way of first non-limiting example, where the coalescence results in formation of a substantially solid fungal curd that can be separated from the liquid phase, the further processing may include any one or more conventional liquid-solid separation steps (e.g., decanting, pressing, filtration, gravity separation, screw separation, centrifugation, etc.). By way of second non-limiting example, where the coalescence results in formation of a gel (i.e., a colloid in which the liquid phase is dispersed throughout a solid dispersion medium formed by the coalescence of the fungal proteins), the gel may be further processed by any suitable techniques for processing edible gels, as will be known to those skilled in the art. Most typically, the coalesced fungal protein composition is edible (that is, safe for human consumption) even in the absence of any further processing, but the further processing may also allow the coalesced fungal protein composition to be made into a suitable food product (e.g., a cheese or cheese curd analog food product, a tofu analog food product, etc.).

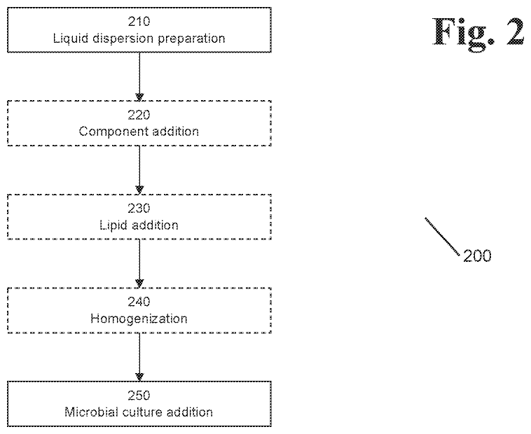

Referring now to FIG. 2, another non-limiting embodiment of a method 200 for making a composition comprising coalesced fungal proteins (e.g., a fungal curd, a fungal gel, etc.) via pH adjustment is illustrated. This embodiment is largely similar to the embodiment of the method 100 illustrated in FIG. 1, with the most notable difference being that the pH adjustment is carried out by adding a microbial culture suitable for fermentation of food products rather than simply adding the acid directly. Particularly, the embodiment of the method 200 illustrated in FIG. 2 includes a liquid dispersion preparation step 210, an optional component addition step 220, an optional lipid addition step 230, an optional homogenization step 240, and a microbial culture addition step 250.

In the liquid dispersion preparation step 210, a liquid dispersion of edible filamentous fungi is prepared by combining water and one or more mycelial biomass formats in ratios as described herein, such as about 30:1, 27:1, or 20:1, or alternatively in any ratio that results in a dispersion having a solids content of about 0.1 wt. % to about 15 wt. % (e.g., in some embodiments in which the liquid phase is water, having a water content of about 85 wt. % to about 99.9 wt. %). The water and mycelial biomass formats are placed into an apparatus containing rotating blades, for example a blender or an impeller, and sheared until smooth. In this embodiment, shearing occurs by high speed blending or mixing (e.g., at about 10,000+ rpm), non-stop, for a period of at least 2-10 minutes, or until a stable, homogeneous dispersion is achieved; shear mixing is desirable to achieve a satisfactory homogeneity of the fungal material in the water, and to fully disintegrate any possible agglomerates. This step can occur without the addition of any heat, though if desired heat (e.g., 90° F.-120° F., 32.2° C.-48.9° C.) can be applied to facilitate generation of a homogeneous mixture.

In the optional component addition step 220, such components as additional (e.g., non-fungal) proteins, flavoring agents, salts, sugars, etc., may be added to the liquid dispersion. In some embodiments, a mixture of non-fungal proteins is added to the dispersion in a combined amount of about 0.25-10 wt. %, in some embodiments in a combined amount of about 3.0-4.0 wt. %, and in some embodiments about 3.5 wt. %. For example, a soy protein powder (e.g., a soy flour) and an 80% strength hemp protein powder preparation may be added, either in even amounts or in varying concentrations. A calcium or magnesium salt may also be added in an amount of about 0.01-0.5 wt. %, typically about 0.1-0.3 wt. % and most typically about 0.2 wt. %, as may be any desired flavoring agents (e.g., half and half flavoring, cottage cheese flavoring, milk flavoring, etc.) in a combined amount of about 0.4-0.8 wt. %, in some embodiments about 0.6 wt. %; dairy enhancers in an amount of about 0.1-0.3 wt. %, in some embodiments about 0.2 wt. %; and any desired flavor modulator in an amount of about 0.01-0.05 wt. %, in some embodiments about 0.03 wt. %. Salt and sugar may be added to taste (e.g., in amounts of about 0.5 wt. % and about 1.0 wt. %, respectively). All of these components are then mixed into the dispersion until completely dissolved. In some embodiments, this optional component addition step 120 may include heating the liquid dispersion, for example to about 90° F.-120° F. (32.2° C.-48.9° C.), in some embodiments to 110° F. (43.3° C.), and allowing the liquid dispersion to stand at temperature for about 5-20 minutes, in some embodiments for about 10 minutes; this heating may be carried out to ensure that any powdered components added to the mixture are sufficiently hydrated, thereby minimizing agglomerates or pockets of dry, inactive components.

In the optional lipid addition step 230, an oil and/or solid fat or a blend of two or more oils and/or solid fats may be added to the liquid dispersion, in an amount of about 4 wt. %-10 wt. %; in one particular embodiment, coconut oil is added in an amount of about 10 wt. %. The lipid-dispersion combination is then mixed using the blender or the impeller, until it appears visually smooth. Optionally, the lipid-dispersion combination may be heated to about 180° F.-190° F. (82.2° C.-87.8° C.), in some embodiments to about 185° F. (85° C.), and allowed to stand at this temperature for 10-20 minutes, in some embodiments for about 15 minutes.

In the optional homogenization step 240, to ensure that the oil(s) and/or solid fat(s) is/are thoroughly incorporated into the liquid dispersion, the (optionally heated) lipid-dispersion combination may be homogenized under pressure (about 200 bar) using a high-pressure homogenizer. In some embodiments, the high-pressure homogenizer forces a stream of the lipid-dispersion combination through a system that subjects the lipid-dispersion combination to one or more forces that ensure complete mixing of the oil and/or solid fat into the liquid dispersion and thus homogenize the oil and/or solid fat into the liquid dispersion.

In the microbial culture addition step 250, a microbial culture is added to the (optionally homogenized) liquid dispersion, typically in an amount of about 0.01-0.05 wt. %, together with any media or growth nutrients the microbial culture may require that are not otherwise present in the liquid dispersion. The inoculated liquid dispersion is then maintained at a temperature conducive to survival and growth of the microbial culture (e.g., about 90° F.-120° F. (32.2° C.-48.9° C.), in some embodiments about 110° F. (43.3° C.)) for a time sufficient for fermentation of the nutrients in the liquid dispersion by the microbial culture, typically about 4-12 hours, depending on the microorganisms present in the culture, and in particular embodiments about 6 hours or overnight. Where the liquid dispersion is at elevated temperature (e.g., where the optional heating of optional lipid addition step 230 was carried out), the microbial culture is typically added while or after the liquid dispersion cools to the maintenance temperature. The fermentation by the microbial culture produces acids or bases that decrease or increase the pH of the liquid dispersion and thus cause coalescence of fungal proteins in the liquid dispersion.

Optionally, although not illustrated in FIG. 2, the coalesced fungal protein composition can then be processed further. By way of first non-limiting example, where the coalescence results in formation of a substantially solid fungal curd that can be separated from the liquid phase, the further processing may include any one or more conventional liquid-solid separation steps (e.g., decanting, pressing, filtration, gravity separation, screw separation, centrifugation, etc.). By way of second non-limiting example, where the coalescence results in formation of a gel (i.e., a colloid in which the liquid phase is dispersed throughout a solid dispersion medium formed by the coalescence of the fungal proteins), the gel may be further processed by any suitable techniques for processing edible gels, as will be known to those skilled in the art. Most typically, the coalesced fungal protein composition is edible (that is, safe for human consumption) even in the absence of any further processing, but the further processing may also allow the coalesced fungal protein composition to be made into a suitable food product (e.g., a cheese or cheese curd analog food product, a tofu analog food product, etc.).

It is to be expressly understood that, while many of the teachings of this disclosure relate to compositions (e.g., in some embodiments, mixed-format mycelial biomass compositions) that may, due to coalescence of fungal proteins, form a fungal curd or a gel or other stable colloid under acidic conditions, particularly at a pH of no more than about 4 and even more particularly at a pH of about 3.5, mycelial biomass compositions may be produced that form a fungal curd or stable gel under any of several selected pH conditions. By way of first non-limiting example, mycelial biomass compositions according to the present disclosure may form a fungal curd or stable gel at a pH of, and/or methods of making a fungal curd or stable gel according to the present disclosure may comprise a step of adjusting the pH to, no more than about 14, no more than about 13.5, no more than about 13, no more than about 12.5, no more than about 12, no more than about 11.5, no more than about 11, no more than about 10.5, no more than about 10, no more than about 9.5, no more than about 9, no more than about 8.5, no more than about 8, no more than about 7.5, no more than about 7, no more than about 6.5, no more than about 6, no more than about 5.5, no more than about 5, no more than about 4.5, no more than about 4, no more than about 3.5, no more than about 3, no more than about 2.5, no more than about 2, no more than about 1.5, no more than about 1, no more than about 0.5, or no more than about 0. By way of second non-limiting example, mycelial biomass compositions according to the present disclosure may form a fungal curd or stable gel at a pH of, and/or methods of making a fungal curd or stable gel according to the present disclosure may comprise a step of adjusting the pH to, at least about 0, at least about 0.5, at least about 1, at least about 1.5, at least about 2, at least about 2.5, at least about 3, at least about 3.5, at least about 4, at least about 4.5, at least about 5, at least about 5.5, at least about 6, at least about 6.5, at least about 7, at least about 7.5, at least about 8, at least about 8.5, at least about 9, at least about 9.5, at least about 10, at least about 10.5, at least about 11, at least about 11.5, at least about 12, at least about 12.5, at least about 13, at least about 13.5, or at least about 14. By way of third non-limiting example, mycelial biomass compositions according to the present disclosure may form a fungal curd or stable gel at a pH of, and/or methods of making a fungal curd or stable gel according to the present disclosure may comprise a step of adjusting the pH to any pH value in any range having a lower bound of any tenth of a pH value from 0.0 to 14.0 and an upper bound of any other tenth of a pH value from 0.0 to 14.0.

### Coalescence of Fungal Proteins via Addition of Functional Ingredients

In some embodiments of the present disclosure, coalescence of filamentous fungal proteins is induced by adding one or more functional ingredients (i.e., proteins and/or carbohydrates) to a liquid dispersion of filamentous fungal particles. In some embodiments, this coalescence results in the formation of a fungal curd, i.e., a solid mass of filamentous fungal proteins (and, in some cases, other components) that can be separated from the remaining liquid phase, similar to the manner in which proteins are coagulated from animal milks (to form curd) or soy milk (to form tofu), while in other embodiments the coalescence results in the formation of a gel material, i.e., a phase that holds its shape and is resistant to flow, in which the liquid phase is dispersed throughout a network formed by the filamentous fungal proteins (and, in some cases, other compounds).

The one or more functional ingredients may aid or trigger coalescence of the fungal proteins by any of several mechanisms. Particularly, as further described elsewhere throughout this disclosure, the present inventors have found that, depending on the pI of the fungal proteins and the pH of the liquid dispersion, addition of selected non-fungal proteins and/or oligo- and/or polysaccharides having a pI different from that of the fungal proteins may subject the fungal proteins to a desired type or extent of electrostatic interactions, either with themselves, with the non-fungal proteins and/or oligo- and/or polysaccharides, or with other components in the liquid dispersion. By way of first non-limiting example, non-fungal proteins (e.g., potato protein, chickpea protein, etc.) and/or oligo- and/or polysaccharides (e.g., maltodextrin) may be selected based on their pI to result in a pH_{Φ} of the liquid dispersion that is below the desired pH of the liquid dispersion, which may thereby result in the formation of soluble complexes between the fungal proteins and the non-fungal proteins and/or oligo- and/or polysaccharides at the desired pH (“Stage I” coalescence). By way of second non-limiting example, non-fungal proteins (e.g., potato protein, chickpea protein, etc.) and/or oligo- and/or polysaccharides (e.g., maltodextrin) may be selected based on their pI such that the desired pH of the liquid dispersion is in a range between the pH_{Φ} of the liquid dispersion and the pI of the fungal protein(s), which may thereby result in the formation of larger interpolymeric complexes between the fungal proteins and the non-fungal proteins and/or oligo- and/or polysaccharides at the desired pH (“Stage II” coalescence). By way of third non-limiting example, non-fungal proteins (e.g., potato protein, chickpea protein, etc.) and/or oligo- and/or polysaccharides (e.g., maltodextrin) may be selected based on their pI such that the desired pH of the liquid dispersion is less than (or more than) both the pH_{Φ} of the liquid dispersion and the pI of the fungal proteins, which may thereby result in the formation of a highly networked gel of fungal proteins and non-fungal proteins and/or oligo- and/or polysaccharides at the desired pH (“Stage III” coalescence).

In some embodiments, non-fungal proteins and/or oligo- and/or polysaccharides may be selected that effectively “balance” the surface electrical charges on the fungal proteins at the desired pH; by way of non-limiting example, if the desired pH (e.g., 4.2) is above the pI of the fungal proteins (e.g., for a submerged dough in liquid dispersion, 2.2) and below the pI of the non-fungal proteins and/or oligo- and/or polysaccharides (e.g., for commercially available potato protein, 5.1), the negative surface charge of the fungal proteins may be counteracted by an approximately equal but opposite positive charge of the non-fungal proteins and/or oligo- and/or polysaccharides at the desired pH. Particularly, where the non-fungal proteins and/or oligo- and/or polysaccharides are selected such that the pI of the non-fungal proteins and/or oligo- and/or polysaccharides is well above, or well below, the pI of the fungal proteins (e.g., where a difference between the pI of the fungal proteins and the non-fungal proteins and/or oligo- and/or polysaccharides is at least about 2.2, at least about 2.3, at least about 2.4, at least about 2.5, at least about 2.6, at least about 2.7, at least about 2.8, or at least about 2.9), there may exist a range of intermediate pH values between the pI of the fungal proteins and the pI of the non-fungal proteins and/or oligo- and/or polysaccharides where electrostatic attractive interactions between the fungal proteins and the non-fungal proteins and/or oligo- and/or polysaccharides allow the latter to essentially “reinforce” the former to form a gel structure.

Addition of non-fungal proteins and/or oligo- and/or polysaccharides can also provide further structural properties to the resulting coalesced protein composition and/or boost the nutritional value of the food materials and products made from the coalesced protein composition. By way of non-limiting example, hemp protein is considered a “complete” protein because it is known to contain all of the essential amino acids humans are required to intake via food, and hemp seeds contain more than 30 g of protein per 100 g seeds. Additionally, soy protein, like hemp, is considered a “complete” protein because it is known to contain all of the essential amino acids humans are required to intake via food, and soybeans contain about 18 g of protein per 100 g. Other non-fungal proteins contain similar benefits and can be mixed and matched in the disclosed methods to achieve desired nutritional profiles. Suitable proteins for use in the disclosed methods and compositions include bean protein, broccoli protein, chickpea protein, hemp protein, lentil protein, nut protein, pea protein, potato protein, quinoa protein, rice protein, seaweed protein, seed protein, soy protein, spinach protein, and combinations thereof. Suitable oligo- and/or polysaccharides for use in the disclosed methods and compositions include cellobiose, isomaltose, isomaltulose, lactose, lactulose, maltose, sucrose, trehalose, turanose, maltotriose, melezitose, raffinose, stachyose, acarbose, fructooligosaccharides, galactooligosaccharides, isomaltooligosaccharides, maltodextrin, beta-glucans, chitosan, dextrins, dextran, fructose, fructans, galactose, galactans, glucose, glucans, hemicellulose, levan, lignin, mannan, pectin, starch or fractions thereof (e.g., amylopectin, amylose), xanthan gum, and combinations thereof.

In some embodiments, one or more of the non-fungal proteins added to the liquid dispersion may be enzymes, and the coalescence of fungal proteins may be induced, at least in part, by enzymatic action. Suitable enzymes for use in the disclosed methods and composition include catalases, chymosin, lactases, lipases, transglutaminases, and combinations thereof.

The amount of non-fungal protein and/or oligo- and/or polysaccharides used in the disclosed methods can vary based on desired coalescence behavior of the liquid dispersion as described above, and/or the desired texture and/or flavor of the resulting coalesced protein composition. In various embodiments, an amount of 1.0 wt. %-4.0 wt. % of non-fungal protein and/or oligo- and/or polysaccharides can be used. This amount can reflect use of a single source of non-fungal protein and/or oligo- and/or polysaccharide, or a combination of sources of non-fungal protein and/or oligo- and/or polysaccharide, again depending on the desired coalescence behavior, texture, flavor, etc. In some embodiments, the amount of non-fungal protein and/or oligo- and/or polysaccharide used in the disclosed methods is selected from 1.0 wt. %, 1.5 wt. %, 2.0 wt. %, 2.5 wt. %, 3.0 wt. %, 3.5 wt. %, and 4.0 wt. % or any range between 1.0 wt. %-4.0 wt. %.

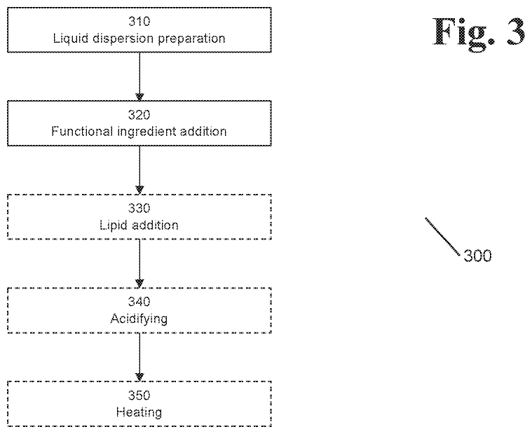

Referring now to FIG. 3, one non-limiting embodiment of a method 300 for making a composition comprising coalesced fungal proteins (e.g., a fungal curd, a fungal gel, etc.) via addition of functional ingredients is illustrated. The embodiment of the method 300 illustrated in FIG. 3 includes a liquid dispersion preparation step 310, a functional ingredient addition step 320, an optional lipid addition step 330, an optional acidifying step 340, and an optional heating step 350.

In the liquid dispersion preparation step 310, a liquid dispersion of edible filamentous fungi is prepared by combining water and one or more mycelial biomass formats in ratios as described herein, such as about 30:1, 27:1, or 20:1, or alternatively in any ratio that results in a dispersion having a solids content of about 0.1 wt. % to about 15 wt. % (e.g., in some embodiments in which the liquid phase is water, having a water content of about 85 wt. % to about 99.9 wt. %). The water and mycelial biomass formats are placed into an apparatus containing rotating blades, for example a blender or an impeller, and sheared until smooth. In this embodiment, shearing occurs by high speed blending or mixing (e.g., at about 10,000+ rpm), non-stop, for a period of at least 2-10 minutes, or until a stable, homogeneous dispersion is achieved; shear mixing is desirable to achieve a satisfactory homogeneity of the fungal material in the water, and to fully disintegrate any possible agglomerates. This step can occur without the addition of any heat, though if desired heat (e.g., 90° F.-120° F., 32.2° C.-48.9° C.) can be applied to facilitate generation of a homogeneous mixture.

In the functional ingredient addition step 320, one or more functional ingredients, i.e., non-fungal proteins and/or oligo- and/or polysaccharides, are added to the liquid dispersion. In some embodiments, a mixture of non-fungal proteins is added to the dispersion in a combined amount of about 0.25-10 wt. %, in some embodiments in a combined amount of about 3.0-4.0 wt. %, and in some embodiments about 3.5 wt. %. By way of first non-limiting example, a soy protein powder (e.g., a soy flour) and an 80% strength hemp protein powder preparation may be added, either in even amounts or in varying concentrations. By way of second non-limiting example, a protein with a selected isoelectric point (e.g., a commercially available potato protein having an isoelectric point of about pH 5.1 and/or a commercially available chickpea protein having an isoelectric point of about pH 4.5) may be added, typically in a total amount of about 1.0 wt. %. By way of third non-limiting example, an oligo- and/or polysaccharide (e.g., maltodextrin) selected to have an electrostatic effect on (and thus induce coalescence in) the fungal proteins of the liquid dispersion may be added.

Functional ingredient addition step 320 may optionally further include addition of such components as flavoring agents, salts, sugars, etc., to the liquid dispersion. A calcium or magnesium salt may also be added in an amount of about 0.01-0.5 w. %, typically about 0.1-0.3 wt. % and most typically about 0.2 wt. %, as may be any desired flavoring agents (e.g., half and half flavoring, cottage cheese flavoring, milk flavoring, etc.) in a combined amount of about 0.4-0.8 wt. %, in some embodiments about 0.6 wt. %; dairy enhancers in an amount of about 0.1-0.3 wt. %, in some embodiments about 0.2 wt. %; and any desired flavor modulator in an amount of about 0.01-0.05 wt. %, in some embodiments about 0.03 wt. %. Salt and sugar may be added to taste (e.g., in amounts of about 0.5 wt. % and about 1.0 wt. %, respectively).

All of these components are then mixed into the dispersion until completely dissolved. In some embodiments, this functional ingredient addition step 320 may optionally include heating the liquid dispersion, for example to about 90° F.-120° F. (32.2° C.-48.9° C.), in some embodiments to 110° F. (43.3° C.), and allowing the liquid dispersion to stand at temperature for about 5-20 minutes, in some embodiments for about 10 minutes; this heating may be carried out to ensure that any powdered components added to the mixture are sufficiently hydrated, thereby minimizing agglomerates or pockets of dry, inactive components.

In the optional lipid addition step 330, an oil and/or solid fat or a blend of two or more oils and/or solid fats may be added to the liquid dispersion, in an amount of about 4 wt. %-10 wt. %; in one particular embodiment, coconut oil is added in an amount of about 10 wt. %. The lipid-dispersion combination is then mixed in any manner suitable to ensure homogeneity, i.e., that the oil and/or solid fat is fully incorporated into the liquid dispersion. As a first non-limiting example of a suitable mixing technique, the lipid-dispersion combination may be mixed in the blender or with the impeller until it is visually homogenous. As a second non-limiting example of a suitable mixing technique, the lipid-dispersion combination may be subjected to high shear mixing (e.g., at about 10,000+ rpm), non-stop, for a period of at least 2-10 minutes, or until a stable, homogeneous lipid-dispersion combination is achieved. As a third non-limiting example of a suitable mixing technique, the lipid-dispersion combination may be homogenized under pressure (about 160 bar) using a high-pressure homogenizer.

In the optional acidifying step 340, one or more acids and/or acidifying microbial cultures may be added to the liquid dispersion to reduce the pH of the liquid dispersion to a pH at which a desired extent or type of coalescence of fungal proteins occurs. By way of first non-limiting example, where the liquid dispersion comprises an oil and/or solid fat and it is desired to form a soft fungal curd useful for making, e.g., a soft cheese analog food product, the pH of the liquid dispersion may be reduced to about 5.5-6.0. By way of second non-limiting example, where the liquid dispersion is a mixed-format mycelial biomass composition and it is desired to cause the two or more mycelial biomass formats to coalesce to transform the liquid dispersion into a non-flowable gel, the pH of the liquid dispersion may be reduced to about 3.5. The amount of acid/acidifying microbial culture added in the optional acidifying step 340 may thus depend both on the “target” pH and the particular acids/acidifying microbial cultures being used, which may be selected such that the target pH can be achieved without exceeding regulatory or safety limits for the acid(s) in food materials/products; by way of non-limiting example, where it is desired to reduce the pH of the liquid dispersion from about 7.0-7.5 to about 5.5-6.0, a weaker acid (e.g., lactic acid, citric acid, or a combination thereof) may be used in an amount of about 2-3 g/L, whereas if it is desired to reduce the pH to a lower value of about 3.5, a smaller quantity of a stronger acid (e.g., hydrochloric acid) may be used. The dispersion-acid combination may then be mixed for a time sufficient to ensure distribution of the acid; optionally, the liquid dispersion may be allowed to stand without mixing for a period of, e.g., about 5-15 minutes. Optionally, the liquid dispersion may be heated (e.g., to about 160° F.-175° F. (71.1° C.-79.4° C.)) and/or mixed during the acidifying step 340; mixing and/or heating may help to ensure that the liquid dispersion does not separate before coalescence of the fungal proteins is complete.

It is to be emphasized that the acidifying step 340 is an optional step. Specifically, in some embodiments of the method 300 illustrated in FIG. 3, adjustment of the pH of the liquid dispersion after functional ingredient addition step 320 may not be necessary, or, in other words, the “natural” pH of the liquid dispersion after functional ingredient addition step 320 may be a suitable target pH, to achieve the desired type and extent of coalescence of the fungal proteins.

In the optional heating step 350, the liquid dispersion is heated to about 185° F.-200° F. (85° C.-93.3° C.), with or without mixing; in some embodiments, the mixing and/or heating may help to ensure complete coalescence of the fungal proteins, for example by increasing the physical contact between the functional ingredient(s) and the fungal particles. The temperature is typically maintained for at least about 30 seconds, and in some embodiments for a period of about 1-10 minutes.

Optionally, although not illustrated in FIG. 3, the coalesced fungal protein composition can then be processed further. By way of first non-limiting example, where the coalescence results in formation of a substantially solid fungal curd that can be separated from the liquid phase, the further processing may include any one or more conventional liquid-solid separation steps (e.g., decanting, pressing, filtration, gravity separation, screw separation, centrifugation, etc.). By way of second non-limiting example, where the coalescence results in formation of a gel (i.e., a colloid in which the liquid phase is dispersed throughout a solid dispersion medium formed by the coalescence of the fungal proteins), the gel may be further processed by any suitable techniques for processing edible gels, as will be known to those skilled in the art. Most typically, the coalesced fungal protein composition is edible (that is, safe for human consumption) even in the absence of any further processing, but the further processing may also allow the coalesced fungal protein composition to be made into a suitable food product (e.g., a cheese or cheese curd analog food product, a tofu analog food product, etc.).

### Coalescence of Fungal Proteins Via Addition of Salts

In some embodiments of the present disclosure, coalescence of filamentous fungal proteins is induced by adding one or more salts to a liquid dispersion of filamentous fungal particles. In some embodiments, this coalescence results in the formation of a fungal curd, i.e., a solid mass of filamentous fungal proteins (and, in some cases, other components) that can be separated from the remaining liquid phase, similar to the manner in which proteins are coagulated from animal milks (to form curd) or soy milk (to form tofu), while in other embodiments the coalescence results in the formation of a gel material, i.e., a phase that holds its shape and is resistant to flow, in which the liquid phase is dispersed throughout a network formed by the filamentous fungal proteins (and, in some cases, other compounds).

The one or more salts may aid or trigger coalescence of the fungal proteins by any of several mechanisms. Particularly, as further described elsewhere throughout this disclosure, the present inventors have found that, depending on the pI of the fungal proteins and the pH of the liquid dispersion, addition of selected salts may result in formation of ionic salt “bridges” between fungal protein molecules. By way of first non-limiting example, when the pH of the liquid dispersion is relatively far from the pI of the fungal material, salts (e.g., calcium salts, magnesium salts) may be added to the liquid dispersion at a relatively low ionic strength to cause the formation of a relatively low concentration of salt bridges, such that the fungal proteins may coalesce into “fine” networks. By way of second non-limiting example, when the pH of the liquid dispersion is relatively close to the pI of the fungal material, salts (e.g., calcium salts, magnesium salts) may be added to the liquid at a relatively high ionic strength to cause the formation of a relatively high concentration of salt bridges, such that the fungal proteins may coalesce into “particulate” or “coarse” networks. It is thus to be expressly understood that in some embodiments, it is desirable to add calcium and/or magnesium salts to the liquid dispersion when the pH of the liquid dispersion is approximately equal to (e.g., within about 1 pH unit, about 0.95 pH units, about 0.9 pH units, about 0.85 pH units, about 0.8 pH units, about 0.75 pH units, about 0.7 pH units, about 0.65 pH units, about 0.6 pH units, about 0.55 pH units, about 0.5 pH units, about 0.45 pH units, about 0.4 pH units, about 0.35 pH units, about 0.3 pH units, about 0.25 pH units, about 0.2 pH units, about 0.15 pH units, about 0.1 pH units, or about 0.05 pH units of) the pI of the fungal proteins, while in other embodiments it is desirable to add calcium and/or magnesium salts to the liquid dispersion when the pH of the liquid dispersion is not approximately equal to the pI of the fungal proteins.

The present inventors have generally found that food-grade salts comprising a divalent cation, i.e., edible calcium and/or magnesium salts, may be effective to induce coalescence of fungal proteins in liquid dispersions; particularly, as further described elsewhere throughout this disclosure, salts comprising monovalent cations (e.g., sodium chloride) have been found generally ineffective, or much less effective than salts comprising divalent cations, in inducing coalescence. Moreover, the present inventors have found that different divalent cations provide different rheology and/or texture to the resulting coalesced protein composition, specifically in that use of calcium salts generally results in formation of a “softer” curd composition, having a texture similar to that of, e.g., ricotta cheese (or a curd suitable for use in the making thereof), whereas use of magnesium salts generally results in formation of a “harder” curd composition, having a texture similar to that of, e.g., tofu (or a curd suitable for use in the making thereof).

Addition of calcium and/or magnesium salts can also boost the nutritional value of the food materials and products made from the coalesced protein composition. By way of non-limiting example, edible and/or food-grade calcium and/or magnesium salts may be added such that, when the coalesced protein composition (or a food material or food product made therefrom) is consumed by a human in a selected amount (e.g., one recommended serving), the coalesced protein composition provides at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or at least about 100% of the recommended dietary allowance (RDA) of calcium and/or magnesium. Suitable calcium salts for use in the disclosed methods and compositions include calcium carbonate, calcium sorbate, calcium benzoate, calcium sulfite, calcium hydrogen sulfite, calcium formate, calcium acetate, calcium propionate, calcium ascorbate, calcium lactate, monocalcium citrate, dicalcium citrate, tricalcium citrate, monocalcium phosphate, dicalcium phosphate, tricalcium phosphate, calcium malate, calcium hydrogen malate, calcium tartrate, calcium fumarate, calcium glycerylphosphate, calcium disodium ethylene diamine tetraacetate, calcium lactobionate, calcium alginate, dicalcium diphosphate, calcium dihydrogen diphosphate, sodium calcium polyphosphate, calcium polyphosphate, calcium salts of fatty acids, calcium stearoyl-2-lactylate, calcium stearoyl fumarate, calcium chloride, calcium sulfate, calcium oxide, calcium ferrocyanide, dicalcium diphosphate, calcium sodium polyphosphate, calcium polyphosphate, calcium silicate, calcium aluminosilicate, calcium stearate, calcium gluconate, synthetic calcium aluminates, calcium diglutamate, calcium guanylate, calcium inosinate, calcium 5′-ribonucleotides, calcium iodate, calcium bromate, calcium peroxide, calcium cyclamate, calcium saccharate, and combinations thereof. Suitable magnesium salts for use in the disclosed methods and compositions include magnesium lactate, monomagnesium phosphate, dimagnesium phosphate, magnesium citrate, magnesium salts of fatty acids, magnesium carbonate, magnesium bicarbonate, magnesium chloride, magnesium sulfate, magnesium oxide, magnesium silicate, magnesium trisilicate, magnesium stearate, magnesium gluconate, magnesium diglutamate, and combinations thereof.

The amount of the one or more salts used in the disclosed methods can vary based on desired coalescence behavior of the liquid dispersion as described above, and/or the desired texture and/or flavor of the resulting coalesced protein composition. In various embodiments, an amount of about 0.01 wt. % to about 0.5 wt. % of calcium and/or magnesium salts can be used. This amount can reflect use of a single calcium salt, a single magnesium salt, a combination of two or more calcium salts, a combination of two or more magnesium salts, or a combination of at least one calcium salt and at least one magnesium salt, again depending on the desired coalescence behavior, texture, flavor, etc. In some embodiments, the amount of the one or more salts used in the disclosed methods is selected from 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.2 wt. %, 0.3 wt. %, 0.4 wt. %, and 0.5 wt. %.

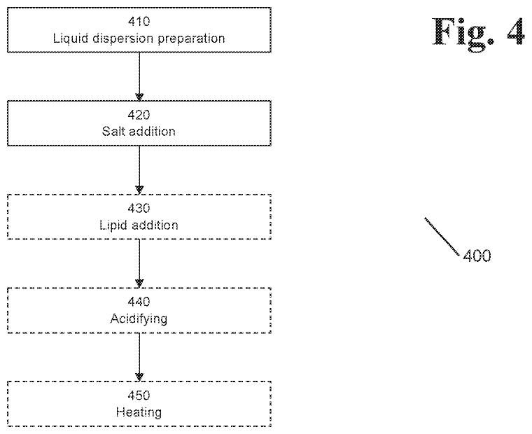

Referring now to FIG. 4, one non-limiting embodiment of a method 400 for making a composition comprising coalesced fungal proteins (e.g., a fungal curd, a fungal gel, etc.) via addition of salts is illustrated. The embodiment of the method 400 illustrated in FIG. 4 includes a liquid dispersion preparation step 410, a salt addition step 420, an optional lipid addition step 430, an optional acidifying step 440, and an optional heating step 450.

In the liquid dispersion preparation step 410, a liquid dispersion of edible filamentous fungi is prepared by combining water and one or more mycelial biomass formats in ratios as described herein, such as about 30:1, 27:1, or 20:1, or alternatively in any ratio that results in a dispersion having a solids content of about 0.1 wt. % to about 15 wt. % (e.g., in some embodiments in which the liquid phase is water, having a water content of about 85 wt. % to about 99.9 wt. %). The water and mycelial biomass formats are placed into an apparatus containing rotating blades, for example a blender or an impeller, and sheared until smooth. In this embodiment, shearing occurs by high speed blending or mixing (e.g., at about 10,000+ rpm), non-stop, for a period of at least 2-10 minutes, or until a stable, homogeneous dispersion is achieved; shear mixing is desirable to achieve a satisfactory homogeneity of the fungal material in the water, and to fully disintegrate any possible agglomerates. This step can occur without the addition of any heat, though if desired heat (e.g., 90° F.-120° F., 32.2° C.-48.9° C.) can be applied to facilitate generation of a homogeneous mixture.

In the salt addition step 420, one or more calcium or magnesium salts are added to the liquid dispersion. The one or more calcium or magnesium salts are generally added in an amount of about 0.01-0.5 wt. %, typically about 0.1-0.3 wt. % and most typically about 0.2 wt. %. By way of first non-limiting example, in embodiments in which formation of a “softer” curd composition, having a texture similar to that of, e.g., ricotta cheese (or a curd suitable for use in the making thereof) is desired, one or more calcium salts (e.g., tricalcium citrate, tricalcium phosphate, calcium lactate, or a combination thereof) may be added. By way of second non-limiting example, in embodiments in which formation of a “harder” curd composition, having a texture similar to that of, e.g., tofu (or a curd suitable for use in the making thereof) is desired, one or more magnesium salts (e.g., magnesium chloride) may be added. By way of first non-limiting example, a soy protein powder (e.g., a soy flour) and an 80% strength hemp protein powder preparation may be added, either in even amounts or in varying concentrations. By way of second non-limiting example, a protein with a selected isoelectric point (e.g., a commercially available potato protein having an isoelectric point of about pH 5.1 and/or a commercially available chickpea protein having an isoelectric point of about pH 4.5) may be added, typically in a total amount of about 1.0 wt. %. By way of third non-limiting example, an oligo- and/or polysaccharide (e.g., maltodextrin) selected to have an electrostatic effect on (and thus induce coalescence in) the fungal proteins of the liquid dispersion may be added.

Salt addition step 420 may optionally further include addition of such components as flavoring agents, non-fungal proteins and/or oligo- and/or polysaccharides, sugars, etc., to the liquid dispersion. In some embodiments, a mixture of non-fungal proteins may be added to the dispersion in a combined amount of about 0.25-10 wt. %, in some embodiments in a combined amount of about 3.0-4.0 wt. %, and in some embodiments about 3.5 wt. %, as may be any desired flavoring agents (e.g., half and half flavoring, cottage cheese flavoring, milk flavoring, etc.) in a combined amount of about 0.4-0.8 wt. %, in some embodiments about 0.6 wt. %; dairy enhancers in an amount of about 0.1-0.3 wt. %, in some embodiments about 0.2 wt. %; and any desired flavor modulator in an amount of about 0.01-0.05 wt. %, in some embodiments about 0.03 wt. %. Salts other than those used to induce coalescence (e.g., sodium salts such as sodium chloride) and sugar may be added to taste (e.g., in amounts of about 0.5 wt. % and about 1.0 wt. %, respectively).

All of these components are then mixed into the dispersion until completely dissolved. In some embodiments, this salt addition step 420 may optionally include heating the liquid dispersion, for example to about 90° F.-120° F. (32.2° C.-48.9° C.) or to about 160° F.-175° F. (71.1° C.-79.4° C.), in some embodiments to 110° F. (43.3° C.) or 175° F. (79.4° C.), and allowing the liquid dispersion to stand at temperature for about 5-30 minutes, in some embodiments for about 10 minutes or about 30 minutes; this heating may be carried out to ensure that any powdered components added to the mixture are sufficiently hydrated, thereby minimizing agglomerates or pockets of dry, inactive components.

In the optional lipid addition step 430, an oil and/or solid fat or a blend of two or more oils and/or solid fats may be added to the liquid dispersion, in an amount of about 4 wt. %-10 wt. %; in one particular embodiment, coconut oil is added in an amount of about 10 wt. %. The lipid-dispersion combination is then mixed in any manner suitable to ensure homogeneity, i.e., that the oil and/or solid fat is fully incorporated into the liquid dispersion. As a first non-limiting example of a suitable mixing technique, the lipid-dispersion combination may be mixed in the blender or with the impeller until it is visually homogenous. As a second non-limiting example of a suitable mixing technique, the lipid-dispersion combination may be subjected to high shear mixing (e.g., at about 10,000+ rpm), non-stop, for a period of at least 2-10 minutes, or until a stable, homogeneous lipid-dispersion combination is achieved. As a third non-limiting example of a suitable mixing technique, the lipid-dispersion combination may be homogenized under pressure (about 160 bar) using a high-pressure homogenizer.

In the optional acidifying step 440, one or more acids and/or acidifying microbial cultures may be added to the liquid dispersion to reduce the pH of the liquid dispersion to a pH at which a desired extent or type of coalescence of fungal proteins occurs. By way of first non-limiting example, where the liquid dispersion comprises an oil and/or solid fat and it is desired to form a soft fungal curd useful for making, e.g., a soft cheese analog food product, the pH of the liquid dispersion may be reduced to about 5.5-6.0. By way of second non-limiting example, where the liquid dispersion is a mixed-format mycelial biomass composition and it is desired to cause the two or more mycelial biomass formats to coalesce to transform the liquid dispersion into a non-flowable gel, the pH of the liquid dispersion may be reduced to about 3.5. The amount of acid/acidifying microbial culture added in the optional acidifying step 440 may thus depend both on the “target” pH and the particular acids/acidifying microbial cultures being used, which may be selected such that the target pH can be achieved without exceeding regulatory or safety limits for the acid(s) in food materials/products; by way of non-limiting example, where it is desired to reduce the pH of the liquid dispersion from about 7.0-7.5 to about 5.5-6.0, a weaker acid (e.g., lactic acid, citric acid, or a combination thereof) may be used in an amount of about 2-3 g/L, whereas if it is desired to reduce the pH to a lower value of about 3.5, a smaller quantity of a stronger acid (e.g., hydrochloric acid) may be used. The dispersion-acid combination may then be mixed for a time sufficient to ensure distribution of the acid; optionally, the liquid dispersion may be allowed to stand without mixing for a period of, e.g., about 5-15 minutes. Optionally, the liquid dispersion may be heated (e.g., to about 160° F.-175° F. (71.1° C.-79.4° C.)) and/or mixed during the acidifying step 440; mixing and/or heating may help to ensure that the liquid dispersion does not separate before coalescence of the fungal proteins is complete.

It is to be emphasized that the acidifying step 440 is an optional step. Specifically, in some embodiments of the method 400 illustrated in FIG. 4, adjustment of the pH of the liquid dispersion after salt addition step 420 may not be necessary, or, in other words, the “natural” pH of the liquid dispersion after salt addition step 420 may be a suitable target pH, to achieve the desired type and extent of coalescence of the fungal proteins.

In the optional heating step 450, the liquid dispersion is heated to about 185° F.-200° F. (85° C.-93.3° C.), with or without mixing; in some embodiments, the mixing and/or heating may help to ensure complete coalescence of the fungal proteins, for example by increasing the physical contact between the salt(s) and the fungal particles. The temperature is typically maintained for at least about 30 seconds, and in some embodiments for a period of about 1-10 minutes.

Optionally, although not illustrated in FIG. 4, the coalesced fungal protein composition can then be processed further. By way of first non-limiting example, where the coalescence results in formation of a substantially solid fungal curd that can be separated from the liquid phase, the further processing may include any one or more conventional liquid-solid separation steps (e.g., decanting, pressing, filtration, gravity separation, screw separation, centrifugation, etc.). By way of second non-limiting example, where the coalescence results in formation of a gel (i.e., a colloid in which the liquid phase is dispersed throughout a solid dispersion medium formed by the coalescence of the fungal proteins), the gel may be further processed by any suitable techniques for processing edible gels, as will be known to those skilled in the art. Most typically, the coalesced fungal protein composition is edible (that is, safe for human consumption) even in the absence of any further processing, but the further processing may also allow the coalesced fungal protein composition to be made into a suitable food product (e.g., a cheese or cheese curd analog food product, a tofu analog food product, etc.).

### Coalescence of Fungal Proteins Via Combination of Techniques Described Above

It is to be expressly understood that in some embodiments, coalescence of fungal proteins may be induced by a combination of any two, or all three, of the methods described in the preceding sections of this disclosure. By way of first non-limiting example, coalescence of fungal proteins may be induced by a combination of pH adjustment and addition of one or more functional ingredients. By way of second non-limiting example, coalescence of fungal proteins may be induced by a combination of pH adjustment and addition of one or more salts. By way of third non-limiting example, coalescence of fungal proteins may be induced by a combination of addition of one or more functional ingredients and addition of one or more salts. By way of fourth non-limiting example, coalescence of fungal proteins may be induced by a combination of pH adjustment, addition of one or more functional ingredients, and addition of one or more salts.

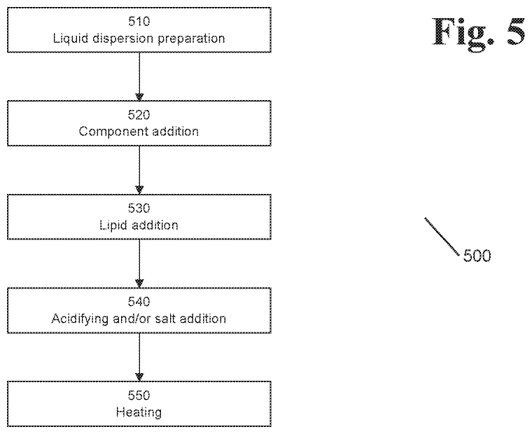

Referring now to FIG. 5, one non-limiting embodiment of a method 500 for making a fungal curd is illustrated. The embodiment of the method 500 illustrated in FIG. 5 includes a liquid dispersion preparation step 510, a component addition step 520, a lipid addition step 530, an acidifying and/or salt addition step 540, and a heating step 550, and may be particularly effective for producing relatively soft fungal curds suitable for processing into, e.g., a cheese curd analog food product or a soft cheese (such as ricotta) analog food product.

In the liquid dispersion preparation step 510, a liquid dispersion of edible filamentous fungi is prepared. Liquid dispersion preparation step 510 may be generally similar to analogous steps 110, 210, 310, 410 illustrated in FIGS. 1-4 and described above.

In the component addition step 520, such components as functional ingredients (e.g., non-fungal proteins and/or oligo- and/or polysaccharides), flavoring agents, salts, sugars, emulsifiers etc., are added to the liquid dispersion. Component addition step 520 may be generally similar to analogous steps 120, 220, 320 illustrated in FIGS. 1-3 and described above.

In the lipid addition step 530, an oil and/or solid fat or a blend of two or more oils and/or solid fats is added to the liquid dispersion. Lipid addition step 530 may be generally similar to analogous steps 130, 230, 330, 430 illustrated in FIGS. 1-4 and described above.

In the acidifying and/or salt addition step 540, the liquid dispersion is acidified (i.e., its pH is reduced), or one or more calcium or magnesium salts are added to the liquid dispersion, or both. In some embodiments, acidifying and/or salt addition step 540 comprises adding an acid and/or an acid-producing microbial culture to the liquid dispersion and therefore may be generally similar to (or include a sub-step that is generally similar to) analogous steps 140, 250, 340, 440 illustrated in FIGS. 1-4 and described above. Additionally or alternatively, in some embodiments, acidifying and/or salt addition step 540 comprises adding one or more calcium or magnesium salts to the liquid dispersion and therefore may be generally similar to (or include a sub-step that is generally similar to) analogous step 420 illustrated in FIG. 4 and described above. It is to be expressly understood that, in those embodiments in which acidifying and/or salt addition step 540 includes both acidification and salt addition, these two sub-steps may be carried out simultaneously or sequentially in any order.

In the heating step 550, the liquid dispersion is heated, with or without stirring, to ensure complete coalescence of the fungal proteins. Heating step 550 may be generally similar to analogous steps 150, 350, 450 illustrated in FIGS. 1, 3, and 4 and described above.

Optionally, although not illustrated in FIG. 5, the fungal curd(s) produced by the method 500 can then be processed further. By way of non-limiting example, the further processing may include any one or more conventional liquid-solid separation steps (e.g., decanting, pressing, filtration, gravity separation, screw separation, centrifugation, etc.). Most typically, the fungal curd composition is edible (that is, safe for human consumption) even in the absence of any further processing, but the further processing may also allow the coalesced fungal protein composition to be made into a suitable food product (e.g., a cheese or cheese curd analog food product).

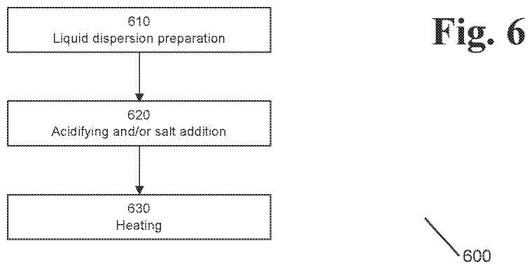

Referring now to FIG. 6, one non-limiting embodiment of a method 600 for making a fungal curd is illustrated. The embodiment of the method 600 illustrated in FIG. 6 includes a liquid dispersion preparation step 610, an acidifying and/or salt addition step 620, and a heating step 630.

In the liquid dispersion preparation step 610, a liquid dispersion of edible filamentous fungi is prepared. Liquid dispersion preparation step 610 may be generally similar to analogous steps 110, 210, 310, 410, 510 illustrated in FIGS. 1-5 and described above.

In the acidifying and/or salt addition step 620, the liquid dispersion is acidified (i.e., its pH is reduced), or one or more calcium or magnesium salts are added to the liquid dispersion, or both. In some embodiments, acidifying and/or salt addition step 620 comprises adding an acid and/or an acid-producing microbial culture to the liquid dispersion and therefore may be generally similar to (or include a sub-step that is generally similar to) analogous steps 140, 250, 340, 440 illustrated in FIGS. 1-4 and described above. Additionally or alternatively, in some embodiments, acidifying and/or salt addition step 620 comprises adding one or more calcium or magnesium salts to the liquid dispersion and therefore may be generally similar to (or include a sub-step that is generally similar to) analogous step 420 illustrated in FIG. 4 and described above. Thus, the acidifying and/or salt addition step 620 in toto may be generally similar to analogous step 540 illustrated in FIG. 5 and described above. It is to be expressly understood that, in those embodiments in which acidifying and/or salt addition step 620 includes both acidification and salt addition, these two sub-steps may be carried out simultaneously or sequentially in any order.

In the heating step 630, the liquid dispersion is heated, with or without stirring, to ensure complete coalescence of the fungal proteins. Heating step 630 may be generally similar to analogous steps 150, 350, 450, 550 illustrated in FIGS. 1 and 3-5 and described above.

Optionally, although not illustrated in FIG. 6, the fungal curd(s) produced by the method 600 can then be processed further. By way of non-limiting example, the further processing may include any one or more conventional liquid-solid separation steps (e.g., decanting, pressing, filtration, gravity separation, screw separation, centrifugation, etc.). Most typically, the fungal curd composition is edible (that is, safe for human consumption) even in the absence of any further processing, but the further processing may also allow the coalesced fungal protein composition to be made into a suitable food product (e.g., a tofu analog food product).

### Fungal Curd Compositions Comprising Coalesced Fungal Proteins

The present disclosure provides fungal curd compositions comprising coalesced fungal proteins, optionally produced by the methods disclosed herein. In many embodiments, these compositions may be cheese curd analog food products and may resemble, for example, ricotta cheese curds, mozzarella cheese curds, or other cheese curds. In other embodiments, these compositions may be tofu (or tofu curd) analog food products.

In many but not all embodiments, the curd compositions of the present disclosure include an oil. The oils that may be present in the curd compositions are described elsewhere throughout this disclosure, but in particular embodiments, the oil may be selected from acai oil, almond oil, avocado oil, blackcurrant seed oil, borage seed oil, canola oil, cashew oil, coconut oil, corn oil, cottonseed oil, evening primrose oil, grapeseed oil, hazelnut oil, hemp oil, macadamia oil, olive oil, palm oil, peanut oil, pecan oil, pine seed oil, pistachio oil, pumpkin seed oil, safflower oil, sesame oil, soybean oil, sunflower oil, tea oil, walnut oil, and combinations thereof.

In many but not all embodiments, the curd compositions of the present disclosure include a solid fat. The solid fats that may be present in the curd compositions are described elsewhere throughout this disclosure, but in particular embodiments, the solid fat may be selected from blubber, butter, chicken fat, clarified butter, cocoa butter, dripping, duck fat, fatback, lard, mango butter, margarine, schmaltz, shea butter, speck, suet, tail fat, tallow, vegetable shortening, and combinations thereof.

In some embodiments, the fungal curd compositions comprise a non-fungal protein, for example hemp protein, soy protein, pea protein, chickpea protein, rice protein, or combinations thereof. As noted above, such non-fungal proteins may induce coalescence, or aid in coalescence, of the fungal proteins.

In some embodiments, the filamentous fungal biomass used to make the curds may comprise particles produced by size-reducing a cohesive filamentous fungal mycelial biomass. This biomass can be produced by any of several methods, including liquid surface fermentation, solid-state fermentation, or submerged fermentation. Additionally or alternatively, the curds may be, or may be made from, a mixed-format mycelial biomass composition as disclosed herein; by way of non-limiting example, the fungal curd composition may be made by a method of coalescing fungal proteins as disclosed herein, where the liquid dispersion used in the method is a liquid dispersion comprising particles of at least two different mycelial biomass formats.

In one embodiment, the filamentous fungal particles consist essentially of fungal mycelia. In other embodiments, the filamentous fungal particles comprise at least about 50 wt. % fungal mycelia, at least about 75 wt. % fungal mycelia, or at least about 95 wt. % fungal mycelia.

Typically, the fungal curd compositions are edible on their own. Depending on the combination of flavoring agents added to the dispersion before, during, or after coalescence of the fungal proteins, they can take on a variety of cheese-like flavors, tofu-like flavors, etc. They are also suitable for the production of other cheese analog food products, as described below.

In some embodiments, the fungal curd compositions are basic food materials analogous to, e.g., dairy curd or tofu, and accordingly may be free of any components or ingredients other than fungal material, residual liquid phase (e.g., water), and any acids/bases, functional ingredients, and/or salts used to induce coalescence. In these embodiments, fungal biomass and/or proteins, alone or in combination with the acids/bases, functional ingredients, and/or salts used to induce coalescence, may make up at least about 25 wt. %, at least about 30 wt. %, at least about 35 wt. %, at least about 40 wt. %, at least about 45 wt. %, at least about 50 wt. %, at least about 55 wt. %, at least about 60 wt. %, at least about 65 wt. %, at least about 70 wt. %, at least about 75 wt. %, at least about 80 wt. %, at least about 85 wt. %, at least about 90 wt. %, at least about 95 wt. %, at least about 96 wt. %, at least about 97 wt. %, at least about 98 wt. %, at least about 99 wt. %, at least about 99.1 wt. %, at least about 99.2 wt. %, at least about 99.3 wt. %, at least about 99.4 wt. %, at least about 99.5 wt. %, at least about 99.6 wt. %, at least about 99.7 wt. %, at least about 99.8 wt. %, at least about 99.9 wt. %, or substantially all of the curd composition on a dry weight basis. Particularly, fungal curd compositions according to these embodiments may have a very low content, or be entirely free, of non-fungal gelling agents, emulsifiers, thickening agents, and/or hydrocolloids, e.g., algae- or plant-derived polysaccharides such as alginates and carrageenans; the total content of non-fungal gelling agents, emulsifiers, thickening agents, and/or hydrocolloids in fungal curd compositions according to these embodiments may be less than about 2 wt. %, less than about 1.9 wt. %, less than about 1.8 wt. %, less than about 1.7 wt. %, less than about 1.6 wt. %, less than about 1.5 wt. %, less than about 1.4 wt. %, less than about 1.3 wt. %, less than about 1.2 wt. %, less than about 1.1 wt. %, less than about 1 wt. %, less than about 0.9 wt. %, less than about 0.8 wt. %, less than about 0.7 wt. %, less than about 0.6 wt. %, less than about 0.5 wt. %, less than about 0.4 wt. %, less than about 0.3 wt. %, less than about 0.2 wt. %, less than about 0.19 wt. %, less than about 0.18 wt. %, less than about 0.17 wt. %, less than about 0.16 wt. %, less than about 0.15 wt. %, less than about 0.14 wt. %, less than about 0.13 wt. %, less than about 0.12 wt. %, less than about 0.11 wt. %, less than about 0.1 wt. %, less than about 0.09 wt. %, less than about 0.08 wt. %, less than about 0.07 wt. %, less than about 0.06 wt. %, less than about 0.05 wt. %, less than about 0.04 wt. %, less than about 0.03 wt. %, less than about 0.02 wt. %, less than about 0.01 wt. %, or 0 wt. %.

Fungal curd compositions according to the present disclosure may have, or be further processed as described elsewhere herein to have, any desired moisture content. In some embodiments, the moisture content of the fungal curd composition may be comparable to the moisture content of a conventional food product to which the fungal curd composition is intended to be analogous, e.g., tofu. By way of first non-limiting example, where it is desired to make a “soft” (relatively high-moisture) tofu analog food product, the fungal curd composition may have a moisture content of at least about 65 wt. %, at least about 66 wt. %, at least about 67 wt. %, at least about 68 wt. %, at least about 69 wt. %, at least about 70 wt. %, at least about 71 wt. %, at least about 72 wt. %, at least about 73 wt. %, at least about 74 wt. %, at least about 75 wt. %, at least about 76 wt. %, at least about 77 wt. %, at least about 78 wt. %, at least about 79 wt. %, at least about 80 wt. %, at least about 81 wt. %, at least about 82 wt. %, at least about 83 wt. %, at least about 84 wt. %, at least about 85 wt. %, at least about 86 wt. %, at least about 87 wt. %, at least about 88 wt. %, at least about 89 wt. %, or at least about 90 wt. %. By way of second non-limiting example, where it is desired to make a “firm” (relatively low-moisture) tofu analog food product, the fungal curd composition may have a moisture content of no more than about 90 wt. %, no more than about 89 wt. %, no more than about 88 wt. %, no more than about 87 wt. %, no more than about 86 wt. %, no more than about 85 wt. %, no more than about 84 wt. %, no more than about 83 wt. %, no more than about 82 wt. %, no more than about 81 wt. %, no more than about 80 wt. %, no more than about 79 wt. %, no more than about 78 wt. %, no more than about 77 wt. %, no more than about 76 wt. %, no more than about 75 wt. %, no more than about 74 wt. %, no more than about 73 wt. %, no more than about 72 wt. %, no more than about 71 wt. %, no more than about 70 wt. %, no more than about 69 wt. %, no more than about 68 wt. %, no more than about 67 wt. %, no more than about 66 wt. %, or no more than about 65 wt. %.

Fungal curd compositions according to the present disclosure may have any desired protein content. In some embodiments, the protein content of the fungal curd composition may be comparable to, or desirably higher than, the protein content of a conventional food product to which the fungal curd composition is intended to be analogous, e.g., tofu. By way of non-limiting example, the protein content of the fungal curd composition may be (on a dry weight basis) at least about 40 wt. %, and more particularly about 40 wt. % to about 60 wt. % (or any value in any subrange thereof, e.g., any value in any range having a lower bound of any whole-number dry-weight percentage from 40 wt. % to 60 wt. % and an upper bound of any other whole-number dry-weight percentage from 40 wt. % to 60 wt. %).

Fungal curd compositions according to the present disclosure may have, or be further processed as described elsewhere herein to have, any desired hardness value as measured by a suitable texture profile analysis method (e.g., the method described in Example 14 below). Hardness is defined as the maximum force during the first compression cycle. In some embodiments, the hardness of the fungal curd composition may be comparable to, or desirably higher or lower than, the hardness of a conventional food product to which the fungal curd composition is intended to be analogous, e.g., tofu. By way of non-limiting example, the hardness of the fungal curd composition (as measured by the method described in Example 14 below) may be about 1 N to about 50 N, or alternatively any value in any range having a lower bound of any whole number of newtons from 1 N to 50 N and an upper bound of any other whole number of newtons from 1 N to 50 N.

Fungal curd compositions according to the present disclosure may have, or be further processed as described elsewhere herein to have, any desired adhesiveness value as measured by a suitable texture profile analysis method (e.g., the method described in Example 14 below). In some embodiments, the adhesiveness of the fungal curd composition may be comparable to, or desirably higher or lower than, the adhesiveness of a conventional food product to which the fungal curd composition is intended to be analogous, e.g., tofu. By way of non-limiting example, the adhesiveness of the fungal curd composition (as measured by the method described in Example 14 below) may be about 0.001 N·mm to about 60 N·mm, or alternatively any value in any range having a lower bound of any whole number of thousandths of newton-millimeters from 0.001 N·mm to 60 N·mm and an upper bound of any other whole number of thousandths of newton-millimeters from 0.001 N·mm to 60 N·mm.

Fungal curd compositions according to the present disclosure may have, or be further processed as described elsewhere herein to have, any desired cohesiveness value as measured by a suitable texture profile analysis method (e.g., the method described in Example 14 below). Cohesiveness refers to how well a material can tolerate a second deformation in comparison with the first, which in the context of the materials of the present disclosure can be interpreted as the “tightness” of the coalescence of fungal proteins in the coalesced fungal protein composition to resist the deformation; generally, a product with strong cohesion will be more tolerant of manufacturing, packaging, and delivery stresses and thus is more likely to be presented to consumers/users in its expected state. In some embodiments, the cohesiveness of the fungal curd composition may be comparable to, or desirably higher or lower than, the cohesiveness of a conventional food product to which the fungal curd composition is intended to be analogous, e.g., tofu. By way of non-limiting example, the cohesiveness of the fungal curd composition (as measured by the method described in Example 14 below) may be about 0.001 to about 4, or alternatively any value in any range having a lower bound of any whole number of thousandths from 0.001 to 4 and an upper bound of any other whole number of thousandths from 0.001 to 4.

The fungal curd products can be made to be very palatable and may, depending on the additives, flavorings, etc. with which they are combined to form a food product, provide a wide variety of taste and nutritional experiences. In some embodiments, curds produced according to the disclosed methods using the disclosed liquid dispersion of filamentous fungal particles are characterized by one or more of the nutritional profiles shown in Tables 1-5:

TABLE 1
Nutritional information, Fusarium strain flavolapis

| | | | | | |
|---|---|---|---|---|---|
| Species | Fusarium | Fusarium | Fusarium | Fusarium | Fusarium |
| name | | | | | |
| Common | F. | F. | F. | F. | F. |
| name | flavolapis | flavolapis | flavolapis | flavolapis | flavolapis |
| Protein | 53.09% | 38.71% | 46.67% | 35.31% | 40.74% |
| Ash | 8.92% | 7.67% | 8.20% | 10.00% | 10.66% |
| Carbohydrates | 33.52% | 50.74% | 41.60% | 51.98% | 44.95% |
| cis, cis-Poly | 2.59% | 1.60% | 2.13% | 1.23% | 2.14% |
| unsaturated | | | | | |
| FA | | | | | |
| Cis- | 0.58% | 0.43% | 0.40% | 0.12% | 0.44% |
| Mono- | | | | | |
| unsaturated | | | | | |
| FA | | | | | |
| Total | 0.94% | 0.74% | 0.80% | 0.68% | 0.89% |
| Saturated | | | | | |
| Fatty Acids | | | | | |
| Total Fat as | 4.24% | 2.89% | 3.53% | 2.35% | 3.63% |
| Triglycerides | | | | | |
| Total Trans | Below | Below | Below | Below | Below |
| FA isomers- | | | | | |
| GC | Detection | Detection | Detection | Detection | Detection |

TABLE 2
Total protein analysis, Fusarium strain flavolapis

| Units | Analyte | F. flavolapis |
|---|---|---|
| Percent dry | Total Protein | 43-52% |
| weight | Total Fat | 12.0% |
| | Total Fiber | 23.3% |
| | Total sugars | <0.35% |
| | Total Ash | 12.4% |
| | Total Carb | 35.4% |
| | (calculated) | |
| | Total | 1.47% |
| | Nucleotides | |

TABLE 3
Branched amino acid analysis, Fusarium strain flavolapis

| Units | Analyte | F. flavolapis |
|---|---|---|
| Percent of total | Tryptophan* | 1.07% |
| protein dry weight | | |
| | Cystine | 0.82% |
| | Methionine* | 1.54% |
| | Alanine | 10.43% |
| | Arginine | 5.67% |
| | Aspartic | 10.30% |
| | Glutamic | 11.56% |
| | Glycine | 5.58% |
| | Histidine* | 2.11% |
| | Isoleucine* | 5.42% |
| | Leucine* | 8.25% |
| | Phenylalanine* | 2.52% |
| | Proline | 4.91% |
| | Serine | 4.98% |
| | Threonine* | 5.99% |
| | Total lysine* | 7.12% |
| | Tyrosine | 2.33% |
| | Valine* | 9.39% |
| | Essential AA total | 43.42% |
| | Branched chain | 23.06% |

*essential amino acid

TABLE 4
Vitamins, Fusarium strain flavolapis

| Units | Analyte | F. flavolapis |
|---|---|---|
| IU/100 g wet | Vitamin A | 7.53 |
| mg/100 g wet | Folic acid | 0.15 |
| mg/100 g wet | B3 niacin | 2.06 |
| ug/100 g wet | B12 | 1.82 |
| mg/100 g wet | B2 | 0.89 |
| mg/100 g wet | B5 | 0.33 |
| mg/100 g wet | B1 | 0.01 |
| IU/100 g wet | D2 | 222 |
| mg/100 g wet | Omega-3 Linolenic | 148 |
| mg/100 g wet | Calcium | 229 |
| mg/100 g wet | Iron | 3.88 |

TABLE 5
Fatty acid analysis, Fusarium strain flavolapis

| Units | Fatty acid | F. flavolapis |
|---|---|---|
| percent of total | Capric acid (C10:0) | |
| triglycerides | | |
| | Myristic acid (C14:0) | 1.91% |
| | Pentadecanoic acid (C15:0) | |
| | Palmitic acid (C16:0) | 26.75% |
| | Palmitoleic acid (C16:1) | |
| | Margaric acid (C17:0) | |
| | Stearic acid (C18:0) | 7.64% |
| | Oleic acid (C18:1 z-9) | 21.66% |
| | Linoleic acid (C18:2 (z-9,12) | 32.48% |
| | Gamma linolenic acid | |
| | Alpha linolenic acid | 3.82% |
| | Arachidic acid (C20:0) | |
| | 11-Eicosenoic acid C20:1 (z- | |
| | 11) | |
| | Behenic acid (C22:0) | |
| | Lignoceric acid (c24:0) | |
| | Other >C20 | |
| | Other <C20 | 2.55% |
| | Saturated | 41.40% |
| | Monounsaturated | 22.29% |
| | Polyunsaturated | 36.31% |

### Fungal Gel Compositions Comprising Coalesced Fungal Proteins

In many embodiments, particularly those in which a mixed-format mycelial biomass composition as disclosed herein is utilized, the coalesced fungal protein composition is in the form of a non-flowable gel. Such a gel is, in many embodiments, a food material that can be either consumed as a food product on its own or transformed into a food product by being mixed or otherwise combined with one or more other food components, e.g., flavorings, herbs, spices, flavor enhancers, fats, fat replacers, preservatives, sweeteners, color additives, nutrients, emulsifiers, stabilizers, thickeners, pH control agents, acidulants, leavening agents, anti-caking agents, humectants, yeast nutrients, dough strengtheners, dough conditioners, firming agents, enzymes, gases, vegetables, fruits, non-animal derived proteins such as plant proteins (for example, pea protein, soy protein, and textured vegetable protein), meat products, etc. In some embodiments, the gel may be a food product, or may be suitable to be combined with one or more other food components to form a food product, that is analogous to a conventional or known food product comprising a dairy or otherwise animal-derived ingredient (milk, egg, etc.); the mycelial biomass may be provided in addition to or in lieu of the animal-derived ingredient. In some embodiments, the gel may be a non-dairy composition, or more specifically a vegan composition (i.e., a composition that includes no animal-derived components). Examples of food products that can be made using coalesced fungal protein-containing gels of the present disclosure include, without limitation, blancmange, bread, butter, cake, custard, egg white foam, ice cream, jam, jelly, margarine, mayonnaise, meringue, milk, whipped cream, yogurt, cream cheese, emulsified meat products (for example hot dogs), vegetarian and vegan analogs of emulsified meat products, and many sauces and spreads (e.g., béchamel sauce, espagnole sauce, hollandaise sauce, hummus, Russian dressing, tartar sauce, Thousand Island dressing, velouté sauce, etc.), and/or analogs thereof. In some embodiments, the gel and/or a food product made therefrom may be gluten-free.

In some embodiments, the fungal gel compositions are basic food materials that may be free of any components or ingredients other than fungal material, residual liquid phase (e.g., water), and any acids/bases, functional ingredients, and/or salts used to induce coalescence. In these embodiments, fungal biomass and/or proteins may make up at least about 25 wt. %, at least about 30 wt. %, at least about 35 wt. %, at least about 40 wt. %, at least about 45 wt. %, at least about 50 wt. %, at least about 55 wt. %, at least about 60 wt. %, at least about 65 wt. %, at least about 70 wt. %, at least about 75 wt. %, at least about 80 wt. %, at least about 85 wt. %, at least about 90 wt. %, at least about 95 wt. %, at least about 96 wt. %, at least about 97 wt. %, at least about 98 wt. %, at least about 99 wt. %, at least about 99.1 wt. %, at least about 99.2 wt. %, at least about 99.3 wt. %, at least about 99.4 wt. %, at least about 99.5 wt. %, at least about 99.6 wt. %, at least about 99.7 wt. %, at least about 99.8 wt. %, at least about 99.9 wt. %, or substantially all of the gel composition on a dry weight basis. Particularly, fungal gel compositions according to these embodiments may have a very low content, or be entirely free, of non-fungal gelling agents, emulsifiers, thickening agents, and/or hydrocolloids e.g., algae- or plant-derived polysaccharides such as alginates and carrageenans; the total content of non-fungal gelling agents, emulsifiers, thickening agents, and/or hydrocolloids in fungal gel compositions according to these embodiments may be less than about 2 wt. %, less than about 1.9 wt. %, less than about 1.8 wt. %, less than about 1.7 wt. %, less than about 1.6 wt. %, less than about 1.5 wt. %, less than about 1.4 wt. %, less than about 1.3 wt. %, less than about 1.2 wt. %, less than about 1.1 wt. %, less than about 1 wt. %, less than about 0.9 wt. %, less than about 0.8 wt. %, less than about 0.7 wt. %, less than about 0.6 wt. %, less than about 0.5 wt. %, less than about 0.4 wt. %, less than about 0.3 wt. %, less than about 0.2 wt. %, less than about 0.19 wt. %, less than about 0.18 wt. %, less than about 0.17 wt. %, less than about 0.16 wt. %, less than about 0.15 wt. %, less than about 0.14 wt. %, less than about 0.13 wt. %, less than about 0.12 wt. %, less than about 0.11 wt. %, less than about 0.1 wt. %, less than about 0.09 wt. %, less than about 0.08 wt. %, less than about 0.07 wt. %, less than about 0.06 wt. %, less than about 0.05 wt. %, less than about 0.04 wt. %, less than about 0.03 wt. %, less than about 0.02 wt. %, less than about 0.01 wt. %, or about 0 wt. %.

### Post-Processing of Compositions of Coalesced Fungal Proteins

Once a coalesced fungal protein composition has been produced, it is possible to process it further to produce such food products as cheese analog food products, tofu analog food products, and the like. Particularly, fungal curd compositions produced by the methods disclosed herein are suitable for preparing non-dairy, and in many cases vegan, cheese analog and tofu analog food products.

In some embodiments, fungal curd compositions according to the present disclosure may be further processed to create a cultured cheese analog food product, i.e., a product in which a microbial food culture (that is, live bacteria, yeasts, or molds) is introduced to the fungal curd composition. By way of non-limiting example, fungal food materials according to the present invention may be cultured with Lactobacillus spp, or other lactic acid bacteria (to make, e.g., a cheese analog food product or other dairy analog food product). In some embodiments, fungal curd compositions may be cultured with two or more microbial food cultures, either simultaneously or sequentially, to produce an analog of a cheese food product that is made by fermentation of two or more microbial cultures; by way of non-limiting example, cultured food products according to the present disclosure may include semi-soft ripened cheese analog food products (made by subjecting a fungal curd to a first culture by Lactobacillus spp, or other lactic acid bacteria and a second culture by a cheese ripening yeast), blue cheese analog food products (made by subjecting a fungal curd to a first culture by Lactobacillus spp, or other lactic acid bacteria and a second culture by a mold such as Penicillium roqueforti), or soft ripened cheese (e.g., Brie or Camembert) analog food products (made by subjecting a fungal curd to a first culture by Lactobacillus spp, or other lactic acid bacteria and a second culture by Penicillium camemberti), among others.

In some embodiments, the cheese analog food product comprises a thickening or gelling agent. Such agents are known in the art and include agar, gelatin, starches (e.g., arrowroot, tapioca, corn, potato), higher fat liquids (e.g., coconut milk), fat (e.g., coconut flakes, deodorized or otherwise), chickpea water, flax seeds, xanthan gum, guar gum, psyllium husk, ground chia seed, nut and/or seed butters, pumpkin puree, cooked mashed yams, cooked mashed sweet potato, applesauce, mashed overripe bananas or plantains, pureed dates or prunes, soaked and simmered figs, shredded fruit/vegetables, shredded coconut, gluten free flours (e.g., teff flour, buckwheat flour, amaranth flour, chickpea flour, sorghum flour, almond flour), cooked pureed beans, cocoa powder, vegetable gums, polysaccharides, vegetable mucilage, seaweed derivatives, pectin, gluten, soy, and egg analogs. A thickening agent may be a fat, which may be a liquid, such as coconut milk, or a solid, such as deodorized coconut flakes.

In some embodiments, a cheese analog food product that may be produced from fungal curd compositions as disclosed herein comprises lactic acid bacteria (LAB). These bacteria produce lactic acid as the major metabolic end product of carbohydrate fermentation. Examples of LAB include the genera Lactobacillus, Leuconostoc, Pediococcus, Lactococcus, and Streptococcus. In some embodiments, the cheese analog food product comprises the bacteria Lactobacillus bulgaricus and/or Streptococcus thermophilus.

In some embodiments, the cheese analog food product further comprises a rennet. The rennet may be derived from an animal source, a vegetarian source, or a microbial source. In vegetarian or vegan food products, the rennet is derived from a vegetarian source and/or a microbial source.

In some embodiments, the cheese analog food product further comprises an enzymatic water produced as follows: 100 g of whole rye or durum wheat seeds (or other suitable whole cereal seeds) are combined with 1 liter of water and germinated for 2-4 hours. When seeds start to sprout and the first roots appear, the seeds are moved to a clean jar with 1 liter of water. The jar is covered with a permeable cloth (e.g., linen or cotton) and incubated at room temp for 24 hours, at the end of which the water in the jar changes color and odor. This water is referred to as enzymatic water and can be used in the production of cheese analog food products.

In some embodiments, the cheese analog food product further comprises a probiotic. Probiotics are mixtures of live micro-organisms such as bacteria and yeast that provide health benefits including improved digestion.

In some embodiments, the cheese analog food product comprises milk solids derived from animal milk. In some embodiments, the cheese analog food product is free of milk solids derived from animal milk.

In non-limiting examples, cheese analog food products produced from curds provided according to the present disclosure can, in some embodiments, be a hard cheese (e.g., Parmesan) analog food product, a semi-hard cheese (e.g., Gouda) analog food product, a semi-soft cheese (e.g., Havarti) analog food product, a soft or soft ripened cheese (e.g., Brie) analog food product, a cream cheese analog food product, a sour milk cheese analog food product, a blue cheese analog food product, a mascarpone cheese analog food product, a pasta filata (mozzarella) cheese analog food product, a brined cheese (feta) analog food product, a whey cheese (ricotta or brunost) analog food product, or a fresh cheese (cottage cheese) analog food product. In other embodiments, the fungal curds provided by the present disclosure can be used to produce a cream analog food product such as a crème fraiche analog food product, a smetana analog food product, a sour cream analog food product, a half-and-half analog food product, a table cream analog food product, a whipping cream analog food product, a double cream analog food product, a clotted cream analog food product, a soured cream analog food product, a pasteurized cream analog food product, or a condensed cream analog food product.

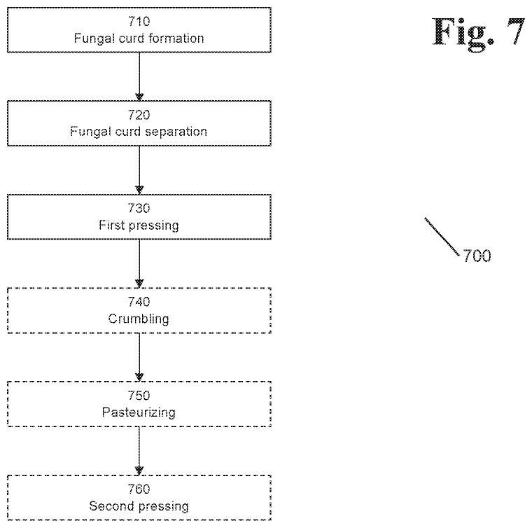

Referring now to FIG. 7, one non-limiting embodiment of a method 700 for making a tofu analog food product is illustrated. The embodiment of the method 700 illustrated in FIG. 7 includes a fungal curd formation step 710, a curd separation step 720, a first pressing step 730, an optional crumbling step 740, an optional pasteurizing step 750, and an optional second pressing step 760.

In the fungal curd formation step 710, a fungal curd is formed by any of the methods for forming a fungal curd disclosed herein. By way of first non-limiting example, a fungal curd may be formed by inducing coalescence of fungal proteins via pH adjustment, e.g., by adjusting the pH of a liquid dispersion of filamentous fungal particles to a pH of about 3.5 at a temperature of about 175° F. (79.4° C.) while slowly mixing and/or stirring. By way of second non-limiting example, a fungal curd may be formed by coalescence of fungal proteins via addition of salt(s), e.g., by adding calcium chloride and/or magnesium chloride to a liquid dispersion of filamentous fungal particles at a temperature of about 175° F. (79.4° C.), in the absence of any pH adjustment, while slowly mixing and/or stirring.

In the curd separation step 720, the fungal curd is separated from a liquid phase of the liquid dispersion by any suitable liquid-solid separation technique. Non-limiting examples of suitable liquid-solid separation techniques include decanting, pressing, filtration, gravity separation, screw separation, and centrifugation.

In the first pressing step 730, the fungal curd is mechanically pressed to squeeze out at least a portion of entrapped water (thus reducing the moisture content and increasing the solids content of the fungal curd) and compress the fungal curd into a shape suitable for packaging and/or further processing. Most typically, the fungal curd is squeezed into a rectangular block in first pressing step 730 by any suitable type of mechanical press or other similar machine or device commonly used in the manufacture of tofu (e.g., a traditional screw-type tofu mold).

In the optional crumbling step 740, the pressed tofu analog food product may be broken into smaller particles for subsequent processing. In some embodiments, optional crumbling step 740 may be carried out to improve the effectiveness of subsequent processing steps, such as optional pasteurizing step 750. Additionally or alternatively, optional crumbling step 740 may be carried out to allow additional ingredients (e.g., chopped vegetables, ground meat, etc.) to be incorporated into the tofu analog food product to create a ready-to-cook meal.

In the optional pasteurizing step 750, the tofu analog food product may be pasteurized to eliminate potentially pathogenic microbes in the tofu analog food product. The pasteurization step may be carried out by any suitable means and under any suitable conditions known to those skilled in the art; by way of non-limiting example, the optional pasteurizing step 750 may be achieved by rapidly heating the tofu analog food product to a temperature of about 90-100° C. and maintaining the tofu analog food product at this temperature for about 5-30 minutes.

In the optional second pressing step 760, the tofu analog food product may again be mechanically pressed to squeeze out further entrapped water (thus further reducing the moisture content and increasing the solids content of the fungal curd) and again compress the fungal curd into a shape suitable for packaging and/or further processing. The optional second pressing step 760 may be carried out to produce a tofu analog food product having a particularly low moisture content; by way of non-limiting example, where a single pressing step 730 may be effective to produce a soft/“silken” tofu or firm tofu analog food product (e.g., a tofu analog food product having a surface firmness akin to raw meat and an internal texture similar to a firm custard), a second pressing step 760 may be necessary to produce an extra-firm tofu analog food product (e.g., a tofu analog food product having a firmness akin to cooked meat and a rubbery or crumbly texture similar to that of paneer).

The first pressing step 730 and optional second pressing step 760 may be carried out to press residual water out of the tofu analog product to any desired extent. In particular embodiments, the pressing step(s) may reduce the water content of the fungal curd and/or tofu analog to amounts comparable to the water content of conventional tofu food products, e.g., about 65 wt. % to about 90 wt. % (or any value in any subrange thereof). By way of first non-limiting example, where it is desired to make a “soft” (relatively high-moisture) tofu analog food product, first pressing step 730 and optionally second pressing step 760 may reduce the water content of the fungal curd and/or tofu analog to at least about 65 wt. %, at least about 66 wt. %, at least about 67 wt. %, at least about 68 wt. %, at least about 69 wt. %, at least about 70 wt. %, at least about 71 wt. %, at least about 72 wt. %, at least about 73 wt. %, at least about 74 wt. %, at least about 75 wt. %, at least about 76 wt. %, at least about 77 wt. %, at least about 78 wt. %, at least about 79 wt. %, at least about 80 wt. %, at least about 81 wt. %, at least about 82 wt. %, at least about 83 wt. %, at least about 84 wt. %, at least about 85 wt. %, at least about 86 wt. %, at least about 87 wt. %, at least about 88 wt. %, at least about 89 wt. %, or at least about 90 wt. %. By way of second non-limiting example, where it is desired to make a “firm” (relatively low-moisture) tofu analog food product, first pressing step 730 and optionally second pressing step 760 may reduce the water content of the fungal curd and/or tofu analog to no more than about 90 wt. %, no more than about 89 wt. %, no more than about 88 wt. %, no more than about 87 wt. %, no more than about 86 wt. %, no more than about 85 wt. %, no more than about 84 wt. %, no more than about 83 wt. %, no more than about 82 wt. %, no more than about 81 wt. %, no more than about 80 wt. %, no more than about 79 wt. %, no more than about 78 wt. %, no more than about 77 wt. %, no more than about 76 wt. %, no more than about 75 wt. %, no more than about 74 wt. %, no more than about 73 wt. %, no more than about 72 wt. %, no more than about 71 wt. %, no more than about 70 wt. %, no more than about 69 wt. %, no more than about 68 wt. %, no more than about 67 wt. %, no more than about 66 wt. %, or no more than about 65 wt. %.

The method 700 illustrated in FIG. 7 may provide the resulting fungal tofu analog product with any desired hardness value as measured by a suitable texture profile analysis method (e.g., the method described in Example 14 below). In particular embodiments, the method 700 may provide the resulting fungal tofu analog product with a hardness that is comparable to, or desirably higher or lower than, the hardness of a conventional tofu product. By way of non-limiting example, the hardness of the tofu analog product (as measured by the method described in Example 14 below) may be about 1 N to about 50 N, or alternatively any value in any range having a lower bound of any whole number of newtons from 1 N to 50 N and an upper bound of any other whole number of newtons from 1 N to 50 N.

The method 700 illustrated in FIG. 7 may provide the resulting fungal tofu analog product with any desired adhesiveness value as measured by a suitable texture profile analysis method (e.g., the method described in Example 14 below). In particular embodiments, the method 700 may provide the resulting fungal tofu analog product with an adhesiveness that is comparable to, or desirably higher or lower than, the adhesiveness of a conventional tofu product. By way of non-limiting example, the adhesiveness of the tofu analog product (as measured by the method described in Example 14 below) may be about 0.001 N·mm to about 60 N·mm, or alternatively any value in any range having a lower bound of any whole number of thousandths of newton-millimeters from 0.001 N·mm to 60 N·mm and an upper bound of any other whole number of thousandths of newton-millimeters from 0.001 N·mm to 60 N·mm.

The method 700 illustrated in FIG. 7 may provide the resulting fungal tofu analog product with any desired cohesiveness value as measured by a suitable texture profile analysis method (e.g., the method described in Example 14 below). In particular embodiments, the method 700 may provide the resulting fungal tofu analog product with a cohesiveness that is comparable to, or desirably higher or lower than, the cohesiveness of a conventional tofu product. By way of non-limiting example, the cohesiveness of the tofu analog product (as measured by the method described in Example 14 below) may be about 0.001 to about 4, or alternatively any value in any range having a lower bound of any whole number of thousandths from 0.001 to 4 and an upper bound of any other whole number of thousandths from 0.001 to 4.

The concepts disclosed herein are further described by way of the following non-limiting Examples, which are provided only for the purpose of illustrating specific embodiments of the present disclosure and in no way limit the scope or breadth of the disclosure.

### Example 1

### Fungal Curd Formation Via Addition of Bacterial Cultures or Acids

Two batches of cheese curd analogs were prepared from edible filamentous fungi, specifically from the filamentous acidophilic Fusarium strain flavolapis (a/k/a/“F. flavolapis” or “F.f.”). This experiment was designed to test the difference in curd production between the addition of bacterial cultures (batch 1, as shown in Table 6 below) versus the addition of an acid (batch 2, as shown in Table 7 below) to fungal preparations. Biomat growth and preparation of F. flavolapis occurred as described in PCT/US2020/020152 (WO 2020/176758 A1).

TABLE 6
Composition of Batch 1

| | | Batch size |
|---|---|---|
| Batch 1 | | (g) |
| Ingredient | % | 1000 |
| F.f. (biomat) | 3.00% | 30 |
| Water | 81.00% | 810 |
| Soy flour | 1.50% | 15 |
| Dextrose | 1.00% | 10 |
| Hemp protein 80% | 2.00% | 20 |
| Salt | 0.50% | 5 |
| Tricalcium citrate | 0.20% | 2 |
| Coconut oil | 10.00% | 100 |
| Dairy enhancer | 0.20% | 2 |
| Half and half flv* | 0.25% | 2.5 |
| Cottage cheese flv* | 0.15% | 1.5 |
| Milk flv* | 0.20% | 2 |
| Taste modulator** | 0.03% | 0.3 |
| | 100.03% | 1,000.3 |

*flv = flavoring agent
**Modumax ® (Royal DSM, NL)

The water and F. flavolapis were placed in a blender (Vitamix®, Vita-Mix Corporation, USA) and sheared (e.g., for 2 minutes at 10,000 rpm) until smooth, creating an aqueous dispersion. All of the powdered ingredients (soy flour, dextrose, hemp protein, salt, tricalcium citrate, dairy enhancer, flavoring agents, taste modulator) were added to the aqueous dispersion and mixed until completely dissolved. The resulting mixture was heated to 110° F. for 10 minutes, to allow the powders to hydrate.

Coconut oil was then added and the entire combination mixed until smooth. Thereafter, the mixture was heated to 185° F. for 15 minutes and homogenized, while hot, at 200 bar of pressure. The homogenate was then cooled to 110° F., at which time a 0.02% bacterial culture preparation (VEGA™ Vibe, Chr. Hansen Holding A/S, DK) was added, with a 0.5% triglyceride mix. This batch was maintained for 6 hours at 110° F., at which point curd formation was observed.

TABLE 7
Composition of Batch 2

| | | Batch size |
|---|---|---|
| Batch 2 | | (g) |
| Ingredient | % | 1000 |
| F.f. (biomat) | 3.00% | 30 |
| Water | 80.92% | 809.2 |
| Soy flour | 1.50% | 15 |
| Dextrose | 1.00% | 10 |
| Hemp protein 80% | 2.00% | 20 |
| Salt | 0.50% | 5 |
| Tricalcium citrate | 0.20% | 2 |
| Coconut oil | 10.00% | 100 |
| Dairy enhancer | 0.20% | 2 |
| Half and half flv* | 0.30% | 3 |
| Cottage cheese flv* | 0.10% | 1 |
| Milk flv* | 0.20% | 2 |
| Cultured flv* | 0.05% | 0.5 |
| Taste modulator** | 0.03% | 0.3 |
| | 100.00% | 1,000 |

*flv = flavoring agent
**Modumax ® (Royal DSM, NL)

The water and F. flavolapis were placed in a blender (Vitamix®, Vita-Mix Corporation, USA) and sheared (e.g., for 2 minutes at 10,000 rpm) until smooth, creating an aqueous dispersion. All of the powdered ingredients (soy flour, dextrose, hemp protein, salt, tricalcium citrate, dairy enhancer, flavoring agents, taste modulator) were added to the aqueous dispersion and mixed until completely dissolved. The resulting mixture was heated to 110° F. for 10 minutes, to allow the powders to hydrate.

Coconut oil was then added and the entire combination mixed at high shear (e.g., for 2 minutes at 10,000 rpm) until smooth. Thereafter, the mixture was heated to 160° F. while slowly mixing (speed 0.5), 2 g of 50% citric acid was added, and the resulting mixture was slowly heated to 190° F. over a 15 minute period. At this point, mixing was stopped and the batch was allowed to sit at 190° F. for a further 10 minutes, at which point curd formation was observed.

While curd formation was observed in both batches, these data suggest that acid formation of curds will occur more quickly than curds formed with bacterial cultures.

### Example 2

### Fungal Curd Formation Via Addition of Citric Acid

A third batch of cheese curd analogs was prepared from edible filamentous fungi, specifically from the filamentous acidophilic Fusarium strain F. flavolapis, as shown in Table 8 below. This experiment was conducted to confirm reproducibility of curd formation using the addition of an acid to a fungal preparation. Biomat growth and preparation of F. flavolapis occurred as described in PCT/US2020/020152 (WO 2020/176758 A1).

TABLE 8
Composition of Batch 3

| | | Batch size |
|---|---|---|
| Batch 3 | | (g) |
| Ingredient | % | 1000 |
| F.f. (biomat) | 2.70% | 27 |
| Water | 85.67% | 856.7 |
| Dextrose | 2.00% | 20 |
| Hemp protein 80% | 2.00% | 20 |
| Salt | 0.80% | 8 |
| Tricalcium citrate | 0.20% | 2 |
| Coconut oil | 6.00% | 60 |
| Half and half flv* | 0.10% | 1 |
| Cottage cheese flv* | 0.05% | 0.5 |
| Milk flv* | 0.20% | 2 |
| Taste modulator** | 0.03% | 0.3 |
| | 99.75% | 997.50 |

*flv = flavoring agent
**Modumax ® (Royal DSM, NL)

The water and F. flavolapis were placed in a blender (Vitamix®, Vita-Mix Corporation, USA) and sheared (e.g., for 2 minutes at 10,000 rpm) until smooth, creating an aqueous dispersion. All of the powdered ingredients (dextrose, hemp protein, salt, tricalcium citrate, flavoring agents, taste modulator) were added to the aqueous dispersion and mixed until completely dissolved. The resulting mixture was heated to 110° F. for 10 minutes, to allow the powders to hydrate.

Coconut oil was then added and the entire combination mixed at high shear (2 minutes at 10,000 rpm) until smooth. Thereafter, the mixture was heated to 160° F. while slowly mixing (speed 0.5), 2 g of 50% citric acid was added, and the resulting mixture was slowly heated to 190° F. over a 15 minute period. As with Batch 2 in Example 1, mixing was then stopped and the batch was allowed to sit at 190° F. for a further 10 minutes, at which point curd formation was observed, confirming reproducibility of curd production via the use of an acid.

### Example 3

Fungal Curd Formation with Higher Fungal Protein Content

A fourth batch of cheese curd analogs was prepared from edible filamentous fungi, specifically from the filamentous acidophilic Fusarium strain F. flavolapis. This experiment was conducted to test a higher concentration of fungi, increasing from 2.70%-3.00% to 4.00% of the total composition (as shown in Table 9 below), together with homogenization and their collective impact on curd formation. Biomat growth and preparation of F. flavolapis occurred as described in PCT/US2020/020152 (WO 2020/176758 A1).

TABLE 9
Composition of Batch 4

| | | Batch size |
|---|---|---|
| Batch 4 | | (g) |
| Ingredient | % | 1000 |
| F.f. (biomat) | 4.00% | 40 |
| Water | 84.54% | 845.4 |
| Dextrose | 2.00% | 20 |
| Hemp protein 80% | 2.00% | 20 |
| Salt | 0.80% | 8 |
| Tricalcium citrate | 0.20% | 2 |
| Coconut oil | 6.00% | 60 |
| Cream flv* | 0.10% | 1 |
| Half and half flv* | 0.10% | 1 |
| Milk flv* | 0.15% | 1.5 |
| Plantmasker | 0.06% | 0.6 |
| | 99.95% | 999.50 |

*flv = flavoring agent

The water and F. flavolapis were placed in a blender (Vitamix®, Vita-Mix Corporation, USA) and sheared (e.g., for 2 minutes at 10,000 rpm) until smooth, creating an aqueous dispersion. All of the powdered ingredients (dextrose, hemp protein, salt, tricalcium citrate, flavoring agents, taste modulator) were added to the aqueous dispersion and mixed until completely dissolved. The resulting mixture was heated to 110° F. for 10 minutes, to allow the powders to hydrate.

Coconut oil was then added, the entire combination mixed until smooth, and then homogenized at a pressure of 160 bar. Thereafter, the mixture was heated to 165° F. while slowly mixing (speed 0.5), 2 g of 50% citric acid was added, and the resulting mixture was further heated to 190° F. over a 15 minute period. As with Batch 2 in Example 1, mixing was then stopped and the batch was allowed to sit at 190° F. for a further 5 minutes. Curd formation was not observed in this batch, which may be due to too high of a concentration of F. flavolapis, or the homogenization process.

### Example 4

### Impact of Hemp Protein and Texturizing Agent on Fungal Curd Formation

Two further batches, 5 and 6, of cheese curd analogs were prepared from edible filamentous fungi, specifically from the filamentous acidophilic Fusarium strain F. flavolapis. This experiment was conducted to first determine the impact of hemp protein in curd production (batch 5, as shown in Table 10 below), and also to determine whether the addition of a texturizing agent might improve the resulting characteristics of the curds, such as cut and yield (batch 6, as shown in Table 11 below). Biomat growth and preparation of F. flavolapis occurred as described in PCT/US2020/020152 (WO 2020/176758 A1).

Batch 5—this batch was prepared twice, one with 2.7% F. flavolapis and 2% hemp protein, and another with 2.7% F. flavolapis and 3% hemp protein.

TABLE 10
Composition of Batch 5

| | | Batch size |
|---|---|---|
| Batch 5 (x2) | | (g) |
| Ingredient | % | 1000 |
| F.f. (biomat) | 2.70% | 27 |
| Water | 85.54% | 855.4 |
| Dextrose | 2.00% | 20 |
| Hemp protein 80% | 2 and 3% | 20 and 30 |
| Salt | 0.80% | 8 |
| Tricalcium citrate | 0.50% | 5 |
| Coconut oil | 6.00% | 60 |
| Cream flv* | 0.10% | 1 |
| Half and half flv* | 0.15% | 1.5 |
| Milk flv* | 0.15% | 1.5 |
| Plantmasker | 0.06% | 0.6 |
| | 98.00% | |

*flv = flavoring agent

For each batch made, the water and F. flavolapis were placed in a blender (Vitamix®, Vita-Mix Corporation, USA) and sheared (e.g., for 2 minutes at 10,000 rpm) until smooth, creating an aqueous dispersion. All of the powdered ingredients (dextrose, hemp protein, salt, tricalcium citrate, flavoring agents, taste modulator) were added to the aqueous dispersion and mixed until completely dissolved. The resulting mixtures were heated to 110° F. for 10 minutes, to allow the powders to hydrate.

Coconut oil was then added and the entire combination mixed until smooth, resulting in a pH of 7.0 in the 2% hemp protein batch and 7.2 in the 3% hemp protein batch. Thereafter, the mixture was heated to 170° F. while slowly mixing (speed 0.5) and 2 g of 50% citric acid was added. At this point, the approximate pH of the 2% hemp protein batch was 5.8 and that of the 3% hemp protein batch was 6.0. The resulting mixtures were slowly heated to 190° F. over a 15 minute period. Mixing was then stopped and each batch was allowed to sit at 190° F. for a further 5 minutes, at which point curd formation was observed. The curd yield in both of the 2% hemp protein and 3% hemp protein batches was approximately 50%.

Batch 6—this batch was also prepared twice, both containing 3% F. flavolapis and 2% hemp protein, with the inclusion of sunflower lecithin as an emulsifier.

TABLE 11
Composition of Batch 6

| | | Batch size |
|---|---|---|
| Batch 6 (x2) | | (g) |
| Ingredient | % | 1000 |
| F.f. (biomat) | 3.00% | 30 |
| Water | 87.24% | 872.4 |
| Sunflower lecithin | 0.30% | 3 |
| Dextrose | 2.00% | 20 |
| Hemp protein 80% | 2% | 20 |
| Salt | 0.80% | 8 |
| Tricalcium phosphate | 0.20% | 2 |
| Coconut oil | 4.00% | 40 |
| Cream flv* | 0.10% | 1 |
| Half and half flv* | 0.15% | 1.5 |
| Milk flv* | 0.15% | 1.5 |
| Plantmasker | 0.06% | 0.6 |
| | 100.00% | |

*flv = flavoring agent

For each batch made, the water and F. flavolapis were placed in a blender (Vitamix®, Vita-Mix Corporation, USA) and sheared (e.g., for 2 minutes at 10,000 rpm) until smooth, creating an aqueous dispersion. All of the powdered ingredients (sunflower lecithin, dextrose, hemp protein, salt, tricalcium phosphate, flavoring agents, taste modulator) were added to the aqueous dispersion and sheared (e.g., for 2 minutes at 10,000 rpm) until completely dissolved. The resulting mixtures were heated to 110° F. for 10 minutes, to allow the powders to hydrate.

Coconut oil was then added and the entire combination sheared (e.g., for 2 minutes at 10,000 rpm) until emulsified, resulting in a pH range of 7.5-7.6 in the batches. Thereafter, the mixture was heated to 170° F. while slowly mixing (speed 0.5) and 3 g of 50% citric acid was added. At this point, the approximate pH range across both batches was 5.9-6.0. Mixing was stopped and both batches were allowed to sit at 170° F. without mixing. Slow mixing (speed 0.5) was then resumed and the batches were slowly heated to 190° F. over a 15 minute period. Mixing was stopped again and each batch was allowed to sit at 190° F. for a further 5 minutes, at which point curd formation was observed. The curd yield in both batches was approximately 45%. The lower yield notwithstanding, this batch 6 had clearer curds that demonstrated a cleaner cut than batch 5.

### Example 5

### Impact of Later Addition of Calcium on Fungal Curd Formation

A further batch 7 of cheese curd analogs was prepared from edible filamentous fungi, specifically from the filamentous acidophilic Fusarium strain F. flavolapis. This experiment was conducted to determine the impact of the addition of calcium much later in the curd formation process. Additionally, a different acid was used with this batch-lactic acid here, whereas citric acid was used in all previous batches, as shown in Table 12 below. Biomat growth and preparation of F. flavolapis occurred as described in PCT/US2020/020152 (WO 2020/176758 A1).

TABLE 12
Composition of Batch 7

| | | Batch size |
|---|---|---|
| Batch 7 | | (g) |
| Ingredient | % | 1000 |
| F.f. (biomat) | 3.00% | 30 |
| Water | 85.94% | 859.4 |
| Sunflower lecithin | 0.50% | 5 |
| Dextrose | 3.00% | 30 |
| Hemp protein 80% | 1.5% | 15 |
| Salt | 0.80% | 8 |
| Calcium lactate | 0.20% | 2 |
| Coconut oil | 4.50% | 45 |
| Butter flv* | 0.05% | 0.5 |
| Cream flv* | 0.15% | 1.5 |
| Half and half flv* | 0.15% | 1.5 |
| Taste modulator** | 0.03% | 0.3 |
| Milk flv* | 0.15% | 1.5 |
| Plantmasker | 0.03% | 0.3 |
| | 100.00% | |

*flv = flavoring agent
**Modumax ® (Royal DSM, NL)

The water and F. flavolapis were placed in a blender (Vitamix®, Vita-Mix Corporation, USA) and sheared (e.g., for 2 minutes at 10,000 rpm) until smooth, creating an aqueous dispersion, as in previous examples. However, in this batch all of the powdered ingredients (sunflower lecithin, dextrose, hemp protein, salt, flavoring agents, taste modulators) except for calcium lactate were added to the aqueous dispersion and sheared (e.g., for 2 minutes at 10,000 rpm) until completely dissolved. The resulting mixture was heated to 110° F. for 10 minutes, to allow the powders to hydrate.

Coconut oil was then added and the entire combination was sheared for 10 minutes (e.g., at 10,000 rpm) until emulsified, resulting in a pH of 7.5-7.6. Thereafter, the mixture was heated to 170° F. while slowly mixing (speed 0.5) and both the calcium lactate with 2 g of 90% lactic acid were added. At this point, the approximate pH dropped to 5.9-6.0. Mixing was then stopped and the batch was allowed to sit at 170° F. for 10 minutes. The temperature was then increased to 190° F. and the batch was held at this temperature for 5 minutes, at which point curd formation was observed. The curd yield was approximately 45%. This batch 7 had clearer curds that demonstrated a cleaner cut than batch 6.

### Example 6

### Formation of Fungal Cheese Curd Analogs

A further batch 8 of cheese curd analogs was prepared from edible filamentous fungi, specifically from the filamentous acidophilic Fusarium strain F. flavolapis. Biomat growth and preparation of F. flavolapis occurred as described in PCT/US2020/020152 (WO 2020/176758 A1), as shown in Table 13 below.

TABLE 13
Composition of Batch 8

| | | Batch size |
|---|---|---|
| Batch 8 | | (g) |
| Ingredient | % | 1000 |
| F.f. (biomat) | 3.00% | 30 |
| Water | 86.71% | 867.1 |
| Sunflower lecithin | 0.30% | 3 |
| Dextrose | 3.00% | 30 |
| Hemp protein 80% | 1.5% | 15 |
| Salt | 0.80% | 8 |
| Tricalcium Phosphate | 0.15% | 1.5 |
| Coconut oil | 4.00% | 40 |
| Giv LQ Masking flv AR-283* | 0.12% | 1.2 |
| Edlong SD Milk flv 412* | 0.18% | 1.8 |
| Edlong SD Half and half flv | 0.12% | 1.2 |
| 640* | | |
| Edlong SD Milk flv 283* | 0.15% | 1.5 |
| | 100.00% | |

*flv = flavoring agent

The water and F. flavolapis were placed in a blender (Vitamix®, Vita-Mix Corporation, USA) and sheared (e.g., for 2 minutes at 10,000 rpm) until smooth, creating an aqueous dispersion as shown in FIG. 8. The aqueous dispersion was then transferred to a Thermomix multicooker. In this batch, all of the powdered ingredients (sunflower lecithin, dextrose, hemp protein, salt, flavoring agents) except for tricalcium phosphate were added to the aqueous dispersion and sheared (e.g., for 2 minutes at 10,000 rpm) until completely dissolved. The resulting mixture was heated to 110° F. for 10 minutes, to allow the powders to hydrate.

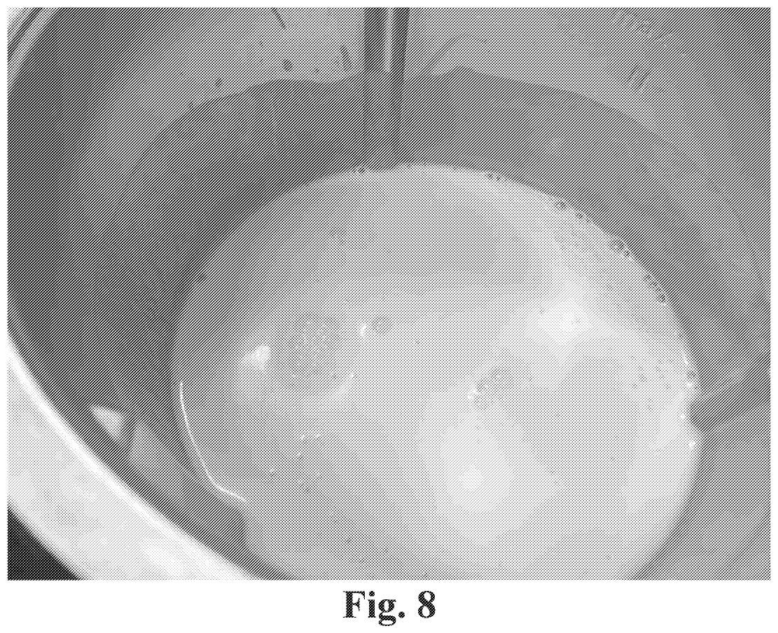

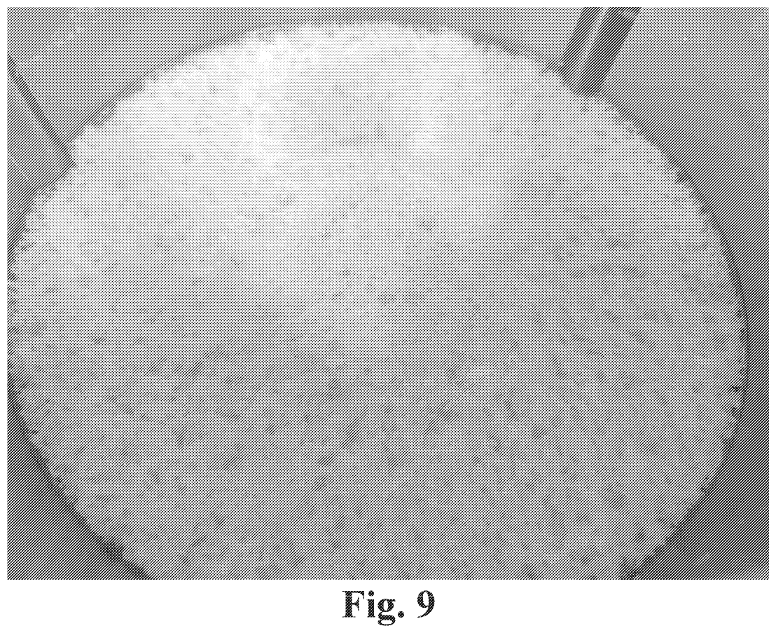

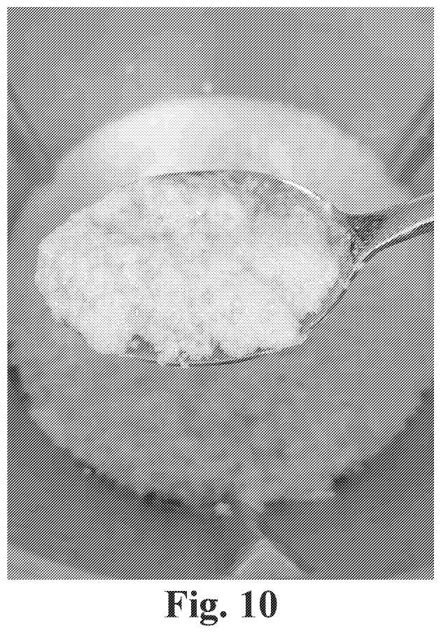

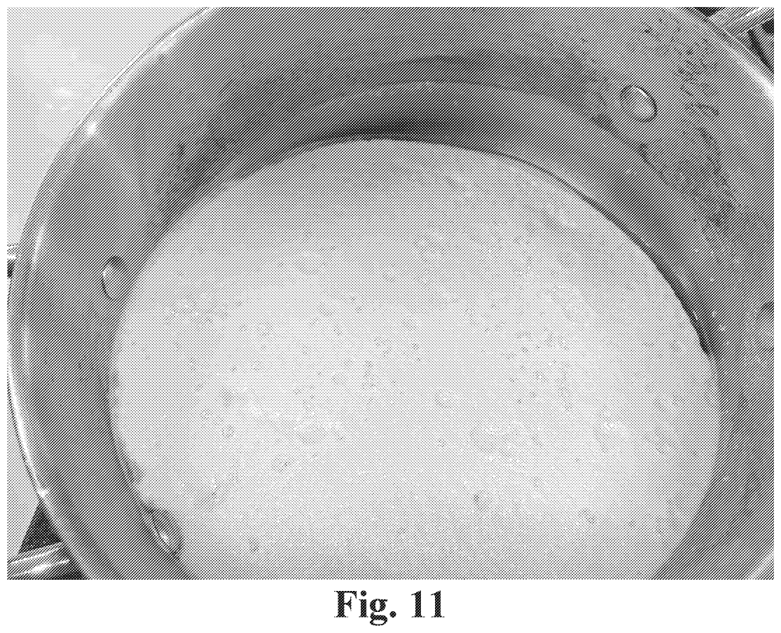

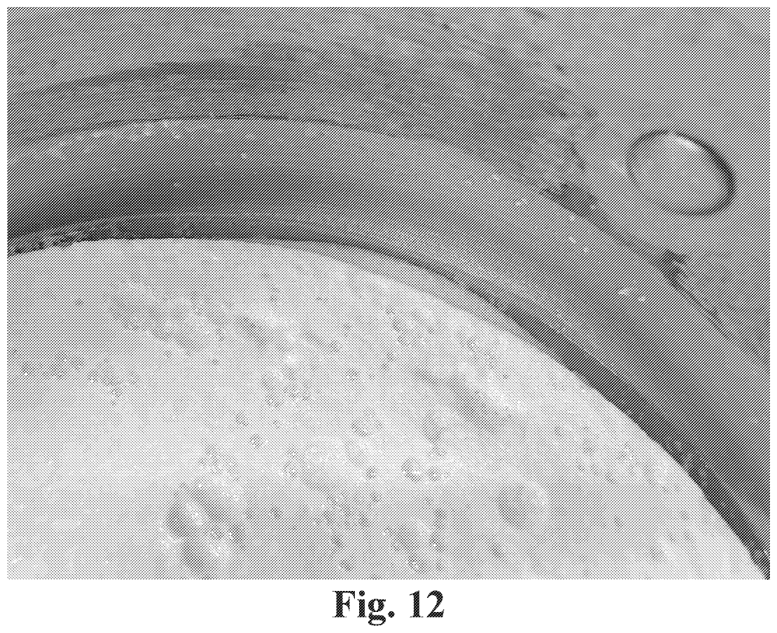

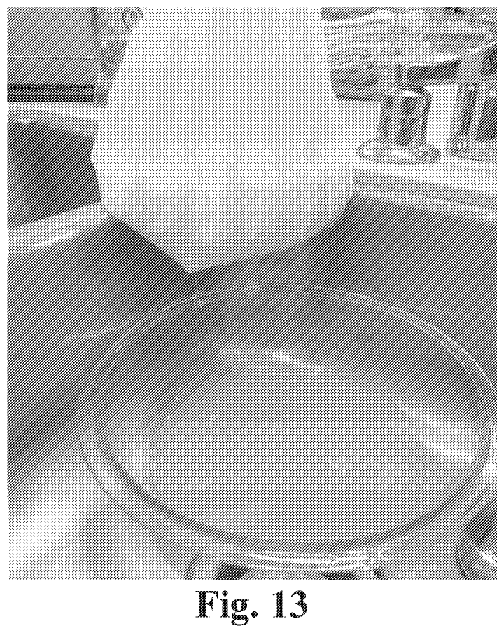

Coconut oil was then added and the entire combination was sheared for 10 minutes (e.g., at 10,000 rpm) until emulsified, resulting in a pH of 7.0-7.6. Thereafter, the mixture was heated to 170° F. while slowly mixing (speed 0.5). Thereafter, the tricalcium phosphate was added while whisking. Immediately thereafter, 2 g of 90% lactic acid was added while whisking. Loose curd begins to form immediately, as shown in FIG. 9 and FIG. 10. At this point, the approximate pH dropped to 5.5-6.0. Mixing was then stopped and the batch was allowed to sit at 170° F. for 10 minutes. The temperature was then increased to 190° F. and the batch was held at this temperature for 5 minutes, at which point curd formation was observed as shown in FIG. 11 and FIG. 12. Thereafter, the curds were poured through a cheesecloth to separate the curd from the liquid, as shown in FIG. 13. The resulting curd was cooled (e.g., to 34° F.-40° F., 1° C.-4° C.) for a period of approximately 24 hours, after which the curd resembles a soft spreadable or ricotta-like cheese as shown in FIG. 14.

### Example 7

### Gelation of Submerged Dough/Biomat Dispersion Mycelial Biomass Blend

Submerged dough: Fungal biomass of edible filamentous fungi, specifically from the filamentous acidophilic Fusarium strain F. flavolapis was prepared by submerged fermentation in a stirred tank reactor. After growth, steam was injected into the fermenter until the temperature reached approximately 80° C. in order to deactivate the biomass. After deactivation, the fermentation broth was dewatered to produce a biomass with a dough-like consistency having an isoelectric point of 2.20 and an average particle size of 61.71 μm. The submerged dough biomass was pureed using a grinder, and the moisture content of the pureed material was measured and determined to be 83-86 wt. %. Water was added to the pureed biomass at a ratio of 3:1 w/w water:biomass. The water/biomass mixture was placed in a Vitamix blender and blended at the maximum setting for 1 minute, then homogenized using a high-speed (10,000 rpm) homogenizer for 2 minutes. This homogenized mixture was transferred to a Thermomix multicooker and heat-treated for 30 minutes at 175° F. and speed 3.0, and the resulting liquid dispersion (referred to hereinafter in this Example as a “dough milk”) was then allowed to cool to room temperature. The pH of this milk was in the range of 5.8 to 6.2.

1 M hydrochloric acid was added to the dough milk drop by drop. pH was recorded throughout the acidification process using a pH-meter. The acidified dough milk got thicker but did not form a gel when the pH was dropped to 3.5. Two samples of the acidified dough milk were stored, one at room temperature and one refrigerated, for 10 minutes. After that time, the containers holding the acidified dough milk were inverted and the milk flowed out of the containers.

Biomat pieces: A biomat of Fusarium strain F. flavolapis was made by a surface fermentation process. Pieces of the biomat having an isoelectric point of 2.25 and an average particle size of 66.21 μm were pureed using a grinder, and the moisture content of the pureed material was measured and determined to be 78-80 wt. %. Water was added to the pureed biomass at a 3:1 w/w ratio of water:biomass. The water/biomass mixture was placed in a Vitamix blender and blended at the maximum setting for 1 minute, then homogenized using a high-speed (10,000 rpm) homogenizer for 2 minutes. The homogenized composition was transferred to a Thermomix multicooker and heat-treated for 30 minutes at 175° F. and speed 3.0, and the resulting liquid dispersion (referred to hereinafter as a “biomat milk”) was then allowed to cool to room temperature. The pH of this milk was in the range of 6.4 to 6.5.

1 M hydrochloric acid was added to the biomat milk drop by drop. pH was recorded throughout the acidification process using a pH-meter. The pH was dropped to 3.5 and two samples of the acidified biomat milk were stored, one at room temperature and one refrigerated, for 10 minutes. After this time, the containers holding the acidified biomat milk were inverted and the formed gel system did not flow out of the container.

Blend #1: Biomat milk and dough milk (non-acidified) were prepared as described above and combined at a 1:3 ratio of biomat milk:dough milk. This blend was mixed on a stir plate at 7,000 rpm for 5 minutes at room temperature. The pH was then adjusted to a pH of at least 3.5 but no more than 4 by addition of 1M hydrochloric acid, producing an acidified blend. After pH adjustment, two samples of the acidified blend were allowed to rest for at least 10 minutes, one at room temperature and one in a refrigerator. After this rest period, the containers of both samples were inverted and no flow was observed, indicating that adjustment of the pH to between 3.5 and 4 resulted in gelation, i.e., formation of a gel system in the previously fluid mycelial biomass blend, as shown in Table 14 below.

TABLE 14

| Composition | pH | Gel formation? |
|---|---|---|
| Submerged dough | >4 | No |
| | 3.5-4.0 | No |
| Biomat | >4 | No |
| | 3.5-4.0 | Yes |
| Blend #1 | >4 | No |
| (biomat:submerged | 3.5-4.0 | Yes |
| dough 1:3) | | |

### Example 8

### Gelation of Submerged Dough/Submerged Flour Mycelial Biomass Composition

Submerged dough: Submerged dough was processed into dough milk as described in Example 7. The dry solid content of the dough milk was calculated to be 15%. As described in Example 7, submerged dough got thicker but did not form a gel even when the pH was dropped to 3.5.

Submerged spray dried flour: Fungal biomass of Fusarium strain F. flavolapis was prepared by stirred tank fermentation. After growth, steam was injected into the fermenter until the temperature reached approximately 80° C. in order to deactivate the biomass. After deactivation the biomass was washed with deionized water and collected as a roughly 25% solids mixture. The wet mixture was then spray dried, producing a submerged spray dried flour with a final solids content of about 98%, an isoelectric point of 2.55, and an average particle size of 20.48 μm. A solution of submerged spray dried flour was prepared at 6.5% (w/v) concentration using tap water. The water/biomass mixture was placed in a Vitamix blender and blended at the maximum setting for 1 minute, then homogenized using a high-speed (10,000 rpm) homogenizer for 2 minutes. The homogenized composition was transferred to a Thermomix multicooker and heat-treated for 30 minutes at 175° F. and speed 3.0, and the resulting liquid dispersion (referred to hereinafter as a “flour milk”) was then allowed to cool to room temperature. 1 M hydrochloric acid was added to the resulting flour milk drop by drop. pH was recorded throughout the acidification process using a pH-meter. The pH was dropped from an initial pH of 5.5-6.3 to 3.5 and two samples of the acidified flour milk were stored-one at room temperature and one refrigerated—for 10 minutes. After this time, the containers holding the acidified flour milk were inverted and the milk flowed out of the containers.

Blend #2: Dough milk (non-acidified) and submerged spray dried flour were prepared as described above. The dry solid content of the dough milk was calculated to be approximately 6.5%. The submerged spray dried flour and the dough milk were combined at a 2:3 ratio of flour:dough milk based on the calculated dry solids content. The flour/dough milk composition was mixed on a stir plate at 7,000 rpm at room temperature for at least 30 minutes to ensure that all of the flour molecules were hydrated. The pH was then adjusted to at least 3.5 but not more than 4.0 by addition of 1M hydrochloric acid, producing an acidified blend. After pH adjustment, two samples of the acidified blend were allowed to rest for at least 10 minutes, one at room temperature and one in a refrigerator. After this rest period, the containers of both samples were inverted and no flow was observed, indicating that adjustment of the pH to between 3.5 and 4 resulted in gelation, i.e., formation of a gel system in the previously fluid mycelial biomass blend, as shown in Table 15 below.

TABLE 15

| Composition | pH | Gel formation? |
|---|---|---|
| Submerged dough | >4 | No |
| | 3.5-4.0 | No |
| Submerged spray dried flour | >4 | No |
| | 3.5-4.0 | No |
| Blend #2 | >4 | No |
| (submerged dough:submerged | 3.5-4.0 | Yes |
| spray dried flour 2:3) | | |

### Example 9

Emulsion Stability of pH-Adjusted Fungal Liquid Dispersions Including Oil

For each of a dough milk as described in Example 7, a flour milk as described in Example 8, and a biomat milk as described in Example 7, 60 g of milk at room temperature and 120 g of water were added to a 350 ml beaker and stirred for 30 seconds to ensure complete mixing. 20 g of vegetable oil was added to each beaker and the resulting fungal dispersion-oil mixture was homogenized at 10,000 rpm for 2 minutes to form an oil-in-water emulsion. Samples of each emulsion were taken from the bottom of each beaker and transferred to a glass vial or 100 mL graduated cylinder using a 10 mL auto-pipettor. The pH of each sample was adjusted to either pH 4 or pH 7.

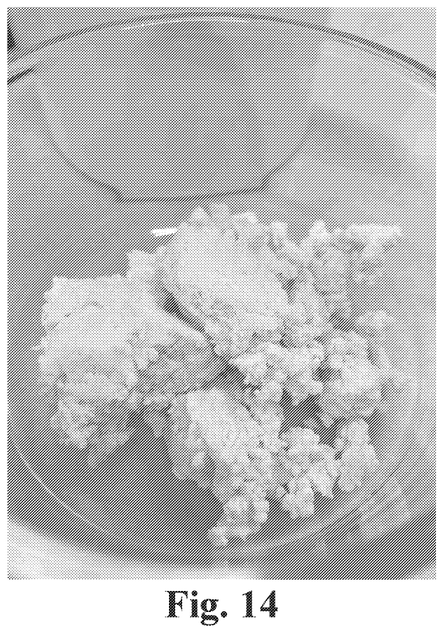

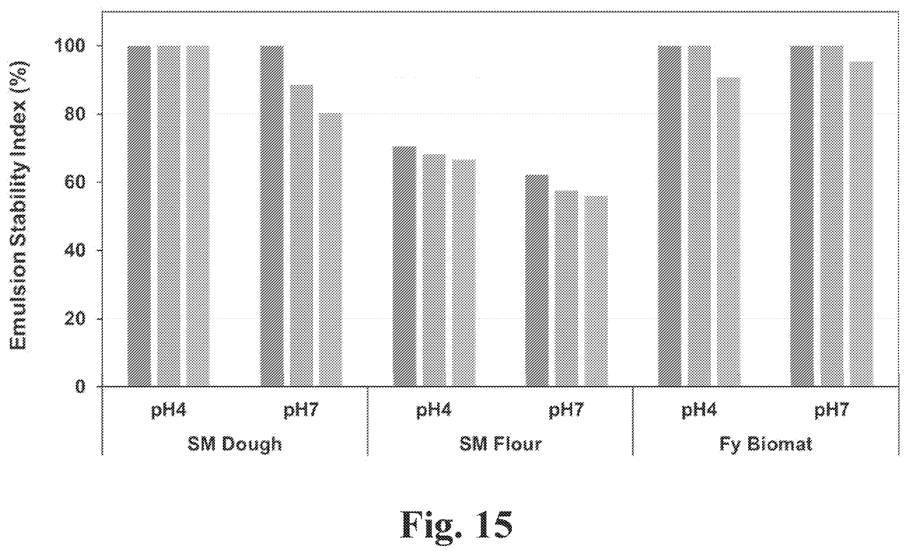

At 1, 2, and 24 hours after samples were transferred to the vial or graduated cylinder, an emulsion stability index (ESI) of each emulsion was calculated; the ESI was defined as the height of the emulsified phase in the vial or cylinder, expressed as a fraction of the total height of liquid in the vial or cylinder (i.e., the height of the emulsified phase plus the height of any water phase that separated from the emulsion and sank to the bottom of the vial/cylinder). The results are illustrated in FIG. 15 (for each milk type/pH combination, the leftmost bar in the bar graph of FIG. 15 represents t=1 hour, the middle bar represents t=2 hours, and the rightmost bar represents t=24 hours). As FIG. 15 illustrates, liquid dispersions made from all three mycelial biomass formats had oil-in-water emulsion stabilities of greater than 50% over 24 hours in both pH regimes, and, in particular, dough milk and biomat milk both formed highly stable emulsions at pH 4 and biomat pieces formed a highly stable emulsion at pH 7.

### Example 10

### Rheological Characterization of Fungal Liquid Dispersions and Gels Made Therefrom

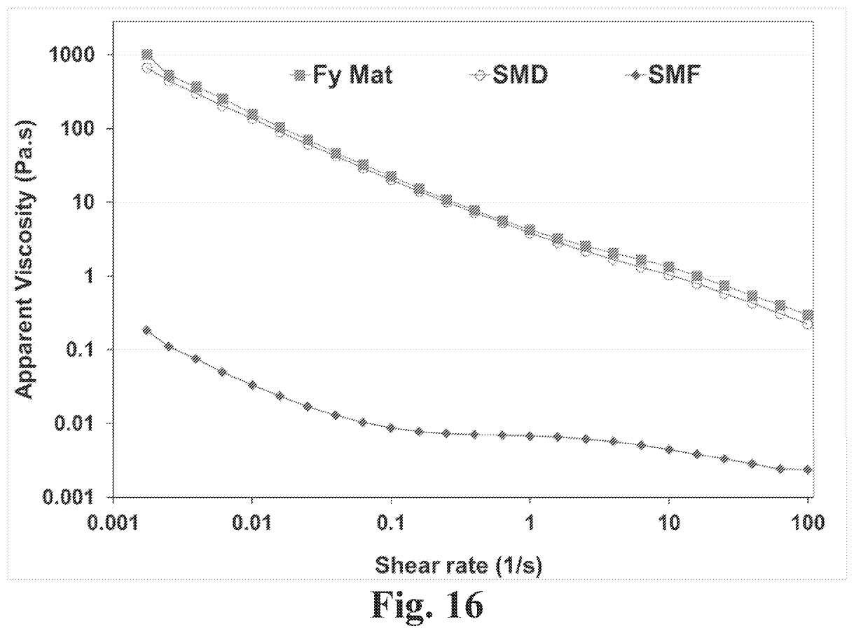

The apparent viscosity of each of a dough milk as described in Example 7, a flour milk as described in Example 8, and a biomat milk as described in Example 7 was measured over a range of shear rates at their unadjusted pH values. As FIG. 16 illustrates, all three milks exhibited shear thinning behavior, and the viscosity of the flour milk (diamond data points) was substantially lower at all shear rates than that of the biomat milk (square data points) and the dough milk (circular data points).

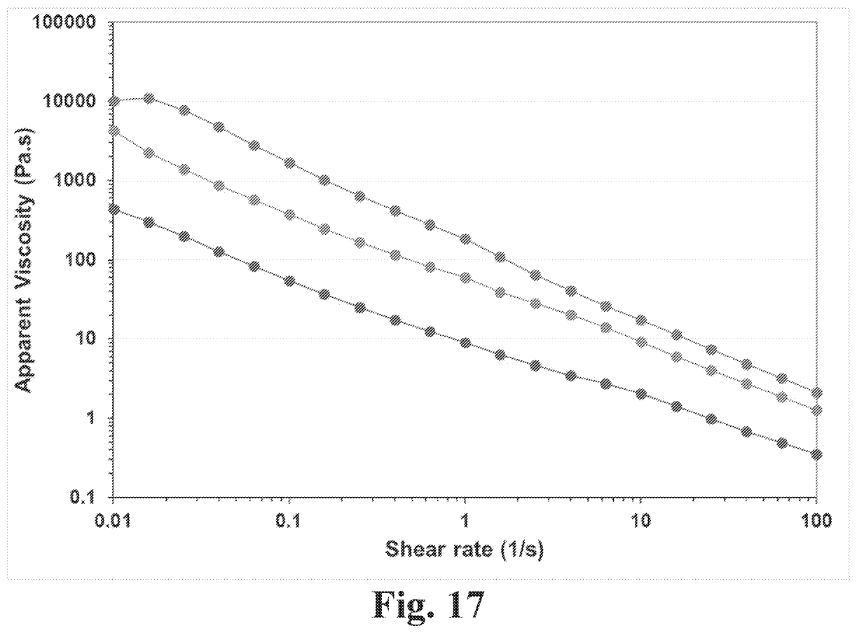

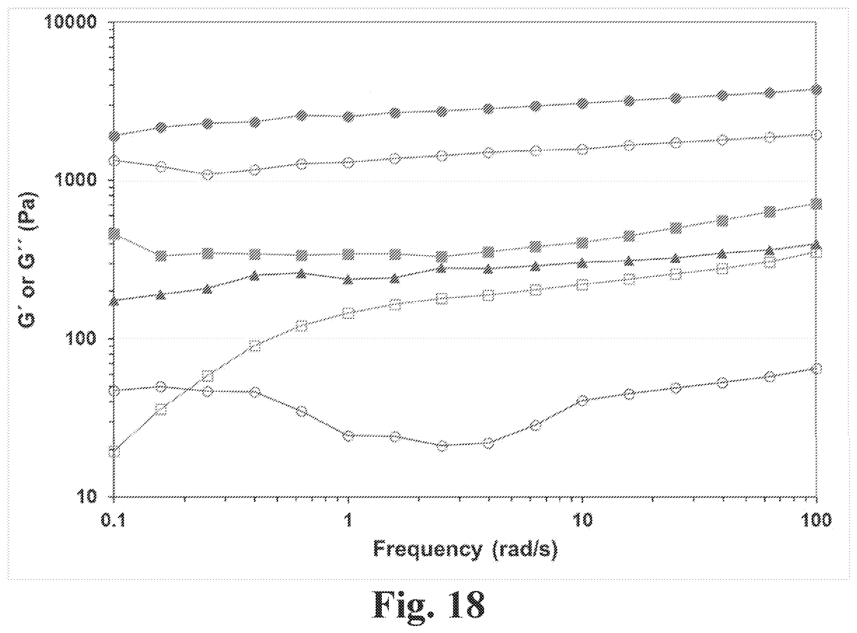

Additionally, as FIG. 17 illustrates, the biomat milk of Example 7 exhibits shear thinning behavior, i.e., decreasing viscosity with increasing shear rate, at all of the starting pH (pH 6.4-6.5, lowermost curve), pH 4.5 (middle curve), and pH 3.5 (upper curve). It was further observed that regardless of shear rate, this biomat milk thickened (i.e., exhibited increasing viscosity) as the pH was reduced to pH 3.5; the present inventors hypothesize that this phenomenon can be attributed to gelation via coalescence of fungal proteins, as supported by the frequency sweep data presented in FIG. 18. Specifically, as FIG. 18 illustrates, the biomat milk, when subjected to frequency sweep testing at 0.1% strain (in the linear viscoelastic regime), exhibits higher storage modulus (G′) values as the pH is decreased from the starting pH (solid triangular data points) through pH 4.5 (upper set of open circular data points) to pH 3.5 (solid circular data points), suggesting that the “stiffness” of the gel is enhanced by reducing the pH to about 3.5.

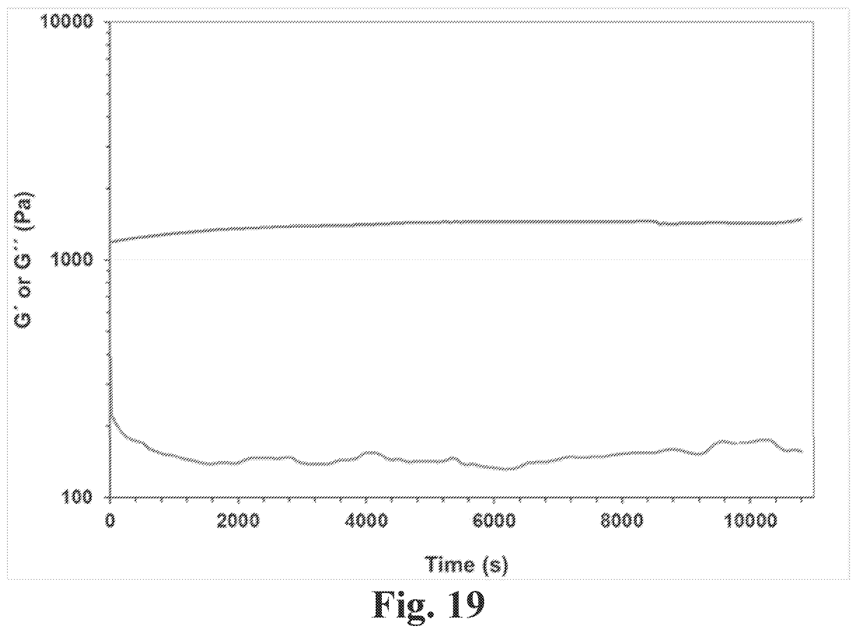

Another sample of the biomat milk was loaded onto a rheometer immediately after the pH was adjusted to 3.5 to determine the time required for the liquid dispersion to transition to a true gel system. As FIG. 19 illustrates, the transition from a liquid dispersion to a true gel system occurs almost immediately upon lowering the pH to 3.5; the storage modulus (G′, upper curve) of the sample was over 1000 Pa (comparable to the gel composition at pH 3.5 illustrated in FIG. 18) at t=0 seconds, and remained substantially consistent over three hours of testing.

### Example 11

### Gelation Via Addition of Non-Fungal Proteins and pH Adjustment

A commercially available potato protein having an isoelectric point (pI) of 5.1 was added to a dough milk as described in Example 7 in an amount of 1 wt. %, and the pH of the milk was then adjusted to 4.2 by dropwise addition of 1M hydrochloric acid. At this pH, due to their respective isoelectric points, the potato protein has a significant positive surface charge and the protein of the submerged dough has a significant negative surface charge, and thus the two types of protein are susceptible to attractive electrostatic interactions. Accordingly, the potato protein induced coalescence of the fungal proteins to form a non-flowable gel structure.

Conversely, when the same procedure was repeated using a commercially available chickpea protein having a pI of 4.5, no gelation was observed, and the chickpea protein-augmented dough milk remained in a substantially flowable liquid form. The present inventors hypothesize that this result is attributable to the small difference between the pI of the chickpea protein (4.5) and the pH of the liquid dispersion (4.2); the consequence of this small difference is that the surface charge on the chickpea protein was substantially smaller than the surface charge on the potato protein, such that the chickpea protein had much less affinity for electrostatic interactions with the fungal proteins and thus could not induce them to coalesce to form a gel structure.

### Example 12

### Production of Tofu Analog Products by Coalescence of Fungal Proteins in Liquid Dispersions

Water was added to submerged dough and to biomat pieces as described in Example 7 to achieve mixtures having the fungal biomass concentrations given in Table 16 below; the milks were prepared by placing water and biomass in a Vitamix blender and blending at the maximum setting for 1 minute, then homogenizing using a high-speed (10,000 rpm) homogenizer for 2 minutes. Each homogenized mixture was transferred to a Thermomix multicooker and heat-treated for 30 minutes at 175° F. and speed 3.0. The pH of each milk was either left unadjusted at its respective starting pH (5.1-5.8 for biomat milk, 5.5-6.2 for dough milk) or adjusted to pH 3.5 via dropwise addition of 1 M hydrochloric acid, and divalent cation salts (either calcium chloride, CaCl₂, or a mixture of about 90 wt. % magnesium chloride, MgCl₂, and about 10 wt. % calcium chloride; the latter of these compositions is referred to in this Example and those that follow as simply a magnesium chloride salt) were thereafter added to some milks, as shown in Table 16 below. After pH adjustment (if any) and salt addition (if any), each milk was heat-treated in the Thermomix multicooker for 30 seconds at 175° F. and speed 1.0 to induce coalescence of fungal proteins and production of fungal curds.

Each of the resulting curd compositions was poured into a 16 cm×16 cm×10.5 cm (6.3 inch×6.3 inch×4.13 inch) tofu mold lined with a cotton cloth. The cloth was folded once over the curds and a 5 kg weight was placed on top of the mold cover for 30 minutes to press each curd composition into a tofu analog product. Each tofu analog product was removed from the mold, crumbled into small pieces by hand, and transferred to a glass beaker, where it was pasteurized at 98° C. for 5 minutes (sufficient to achieve an internal temperature in each sample of 72° C. or above for at least 15 seconds, per United States Food and Drug Administration pasteurization guidelines). The pasteurized tofu analog product was then transferred back to the mold and pressed with the 5 kg weight for a further 15 minutes, after which each product was sealed in a vacuum sealer bag and refrigerated for 48 hours.

It was observed that, when using the biomat milk, regardless of the solids content of the milk, curds could not be formed at the unadjusted (starting) pH without adding salt, but curds could be formed without salt addition when the pH was reduced to 3.5. When using the submerged dough milk, curds could not be formed in either pH regime at a solids content of 6.25% without adding salt, but curds could be formed without salt addition at a solids content of 10% if the pH was adjusted to 3.5. It was also noted that the submerged dough milk with a solids content of 10%, without salt addition or pH adjustment (Sample ID 9 in Table 16 below), did form a cohesive mass when heated, but as explained in the following Examples, the present inventors conclude that this appeared to be a result of simply dewatering the “sticky” submerged dough milk and not of true coalescence of fungal proteins.

TABLE 16
Properties of fungal milks used to make fungal tofu analog products

| | | | pH | |
|---|---|---|---|---|
| Sample | | Biomass | adjusted | |
| ID | Biomass type | wt. % | to 3.5? | Salt added |
| 1 | Submerged dough | 6.25 | No | 0.7 wt. % MgCl₂ |
| 2 | Submerged dough | 6.25 | No | 0.1 wt. % MgCl₂ |
| 3 | Submerged dough | 6.25 | No | 0.7 wt. % CaCl₂ |
| 4 | Submerged dough | 6.25 | No | 0.1 wt. % CaCl₂ |
| 5 | Submerged dough | 10 | No | 0.7 wt. % MgCl₂ |
| 6 | Submerged dough | 10 | No | 0.1 wt. % MgCl₂ |
| 7 | Submerged dough | 10 | No | 0.7 wt. % CaCl₂ |
| 8 | Submerged dough | 10 | No | 0.1 wt. % CaCl₂ |
| 9 | Submerged dough | 10 | No | None |
| 10 | Submerged dough | 6.25 | Yes | 0.7 wt. % MgCl₂ |
| 11 | Submerged dough | 6.25 | Yes | 0.1 wt. % MgCl₂ |
| 12 | Submerged dough | 6.25 | Yes | 0.7 wt. % CaCl₂ |
| 13 | Submerged dough | 6.25 | Yes | 0.1 wt. % CaCl₂ |
| 14 | Submerged dough | 10 | Yes | 0.7 wt. % MgCl₂ |
| 15 | Submerged dough | 10 | Yes | 0.1 wt. % MgCl₂ |
| 16 | Submerged dough | 10 | Yes | 0.7 wt. % CaCl₂ |
| 17 | Submerged dough | 10 | Yes | 0.1 wt. % CaCl₂ |
| 18 | Submerged dough | 10 | Yes | None |
| 19 | Biomat pieces | 6.25 | No | 0.7 wt. % MgCl₂ |
| 20 | Biomat pieces | 6.25 | No | 0.1 wt. % MgCl₂ |
| 21 | Biomat pieces | 6.25 | No | 0.7 wt. % CaCl₂ |
| 22 | Biomat pieces | 6.25 | No | 0.1 wt. % CaCl₂ |
| 23 | Biomat pieces | 8.33 | No | 0.7 wt. % MgCl₂ |
| 24 | Biomat pieces | 8.33 | No | 0.1 wt. % MgCl₂ |
| 25 | Biomat pieces | 8.33 | No | 0.7 wt. % CaCl₂ |
| 26 | Biomat pieces | 8.33 | No | 0.1 wt. % CaCl₂ |
| 27 | Biomat pieces | 6.25 | Yes | 0.7 wt. % MgCl₂ |
| 28 | Biomat pieces | 6.25 | Yes | 0.1 wt. % MgCl₂ |
| 29 | Biomat pieces | 6.25 | Yes | 0.7 wt. % CaCl₂ |
| 30 | Biomat pieces | 6.25 | Yes | 0.1 wt. % CaCl₂ |
| 31 | Biomat pieces | 6.25 | Yes | None |
| 32 | Biomat pieces | 8.33 | Yes | 0.7 wt. % MgCl₂ |
| 33 | Biomat pieces | 8.33 | Yes | 0.1 wt. % MgCl₂ |
| 34 | Biomat pieces | 8.33 | Yes | 0.7 wt. % CaCl₂ |
| 35 | Biomat pieces | 8.33 | Yes | 0.1 wt. % CaCl₂ |
| 36 | Biomat pieces | 8.33 | Yes | None |

### Example 13

### Protein and Moisture Contents of Tofu Analog Products

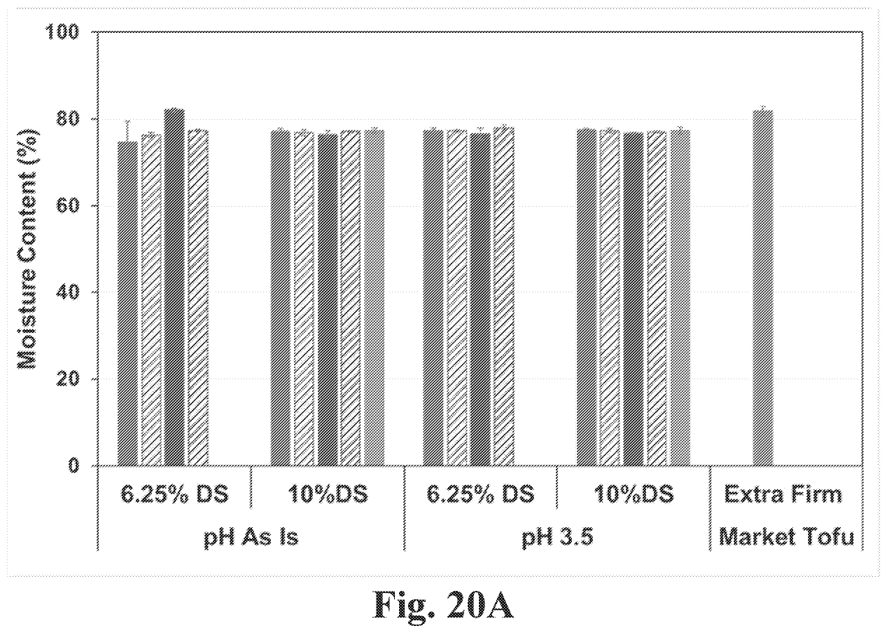

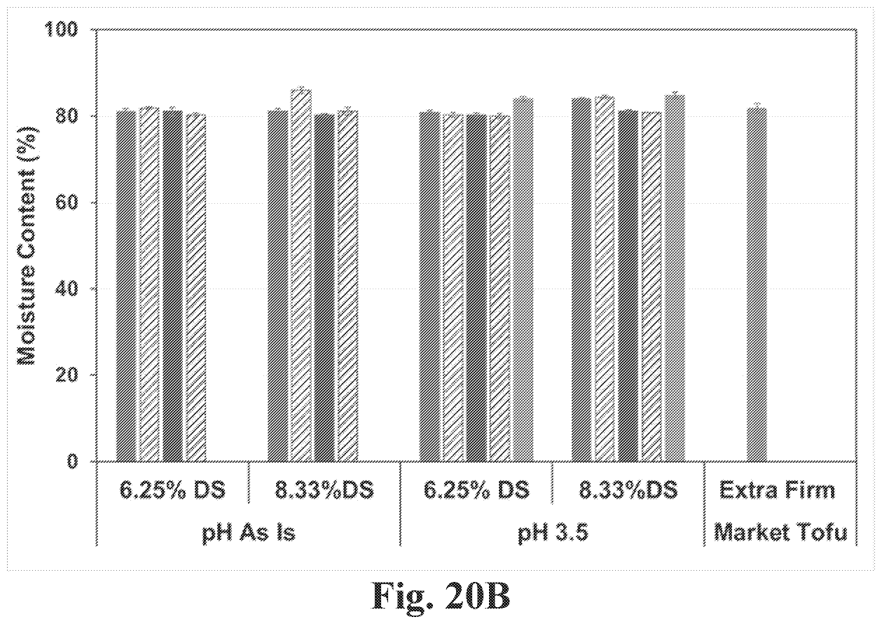

2 g of each of the tofu analog products made in Example 12 was desiccated on an aluminum pan in an oven at 110° C. for 24 hours. The difference between the mass of the original sample (2 g) and the mass of the desiccated sample was determined for each product; this difference was assumed to be the entire moisture content of the original sample and is expressed as a percentage of the original sample mass in FIGS. 20A (submerged dough, Sample IDs 1-18) and 20B (biomat pieces, Sample IDs 19-36); in each of these figures, the results for each sample are presented in numerical order by sample ID, left to right, except that the rightmost bar in each figure represents the moisture content of a commercially available extra-firm tofu food product obtained from a grocery store, which was measured for comparison.

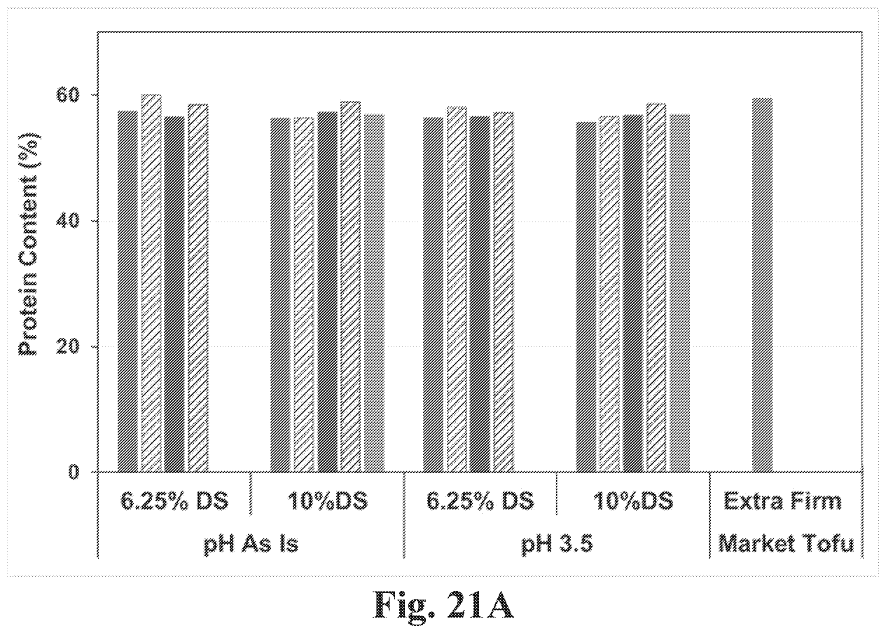

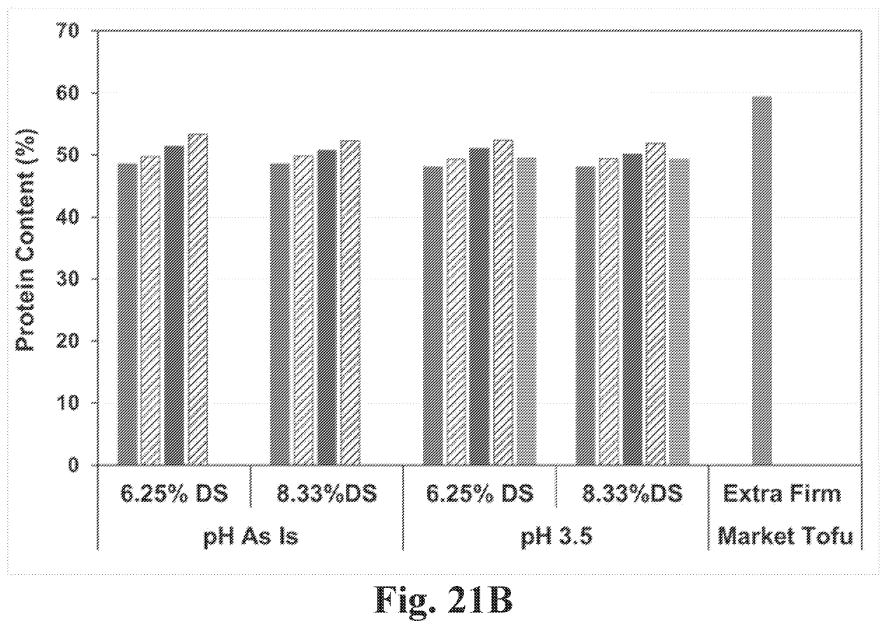

Separately, samples of each tofu analog product made in Example 7 were freeze-dried and ground using a coffee grinder, and the protein content (on a dry-weight basis) of each ground freeze-dried sample was determined via nitrogen combustion in a LECO analyzer according to American Association of Cereal Chemists (AACC) Method 46-30.01, using an assumed nitrogen to protein conversion factor of 6.25. The results are illustrated in FIGS. 21A (submerged dough, Sample IDs 1-18) and 21B (biomat pieces, Sample IDs 19-36); in each of these figures, the results for each sample are presented in numerical order by sample ID, left to right, except that the rightmost bar in each figure represents the protein content of a commercially available extra-firm tofu food product obtained from a grocery store, which was measured for comparison.

### Example 14

### Texture Profile Analysis of Tofu Analog Products

Texture profile analysis (TPA) was performed on samples of each tofu analog product made in Example 12 using a TA.XTPlus texture analyzer. Specifically, 30 mm cylinders of each product were cut using a circular stainless steel cookie cutter and compressed by 75% of the sample thickness using a cylindrical (50 mm diameter) stainless steel probe attached to a 2 kg load cell; a pretest speed of 1 mm/s, a testing speed of 2 mm/s, and a posttest speed of 2 mm/s were used with a trigger force of 5.0 g and a rest time between cycles of 5 seconds. All samples were removed from refrigeration and allowed to rest at room temperature for 10 minutes before TPA testing.

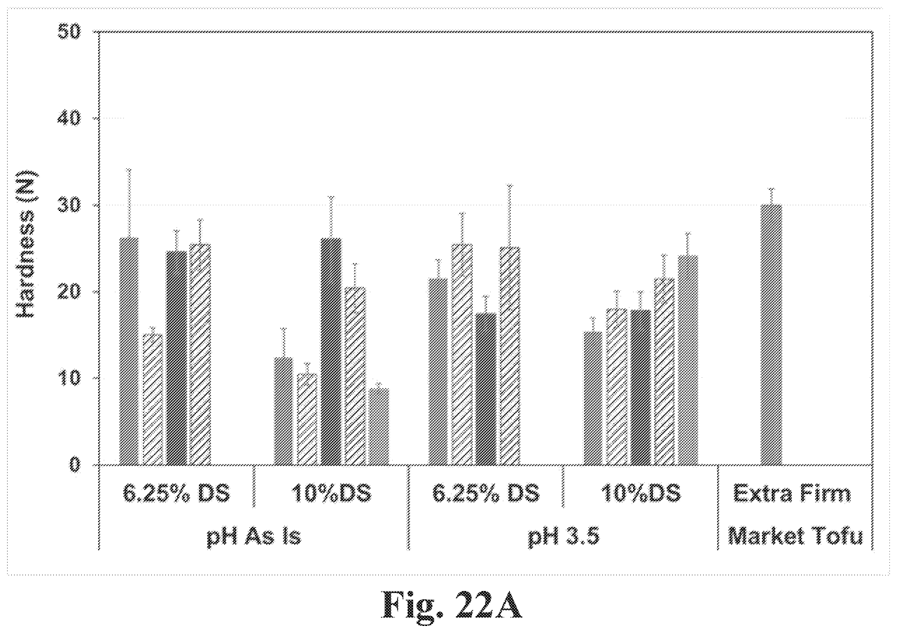

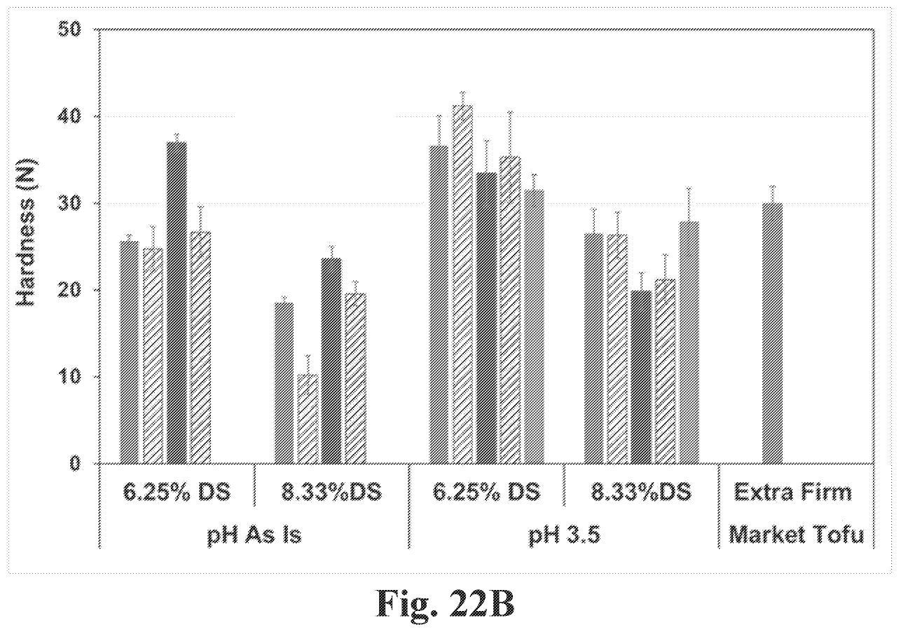

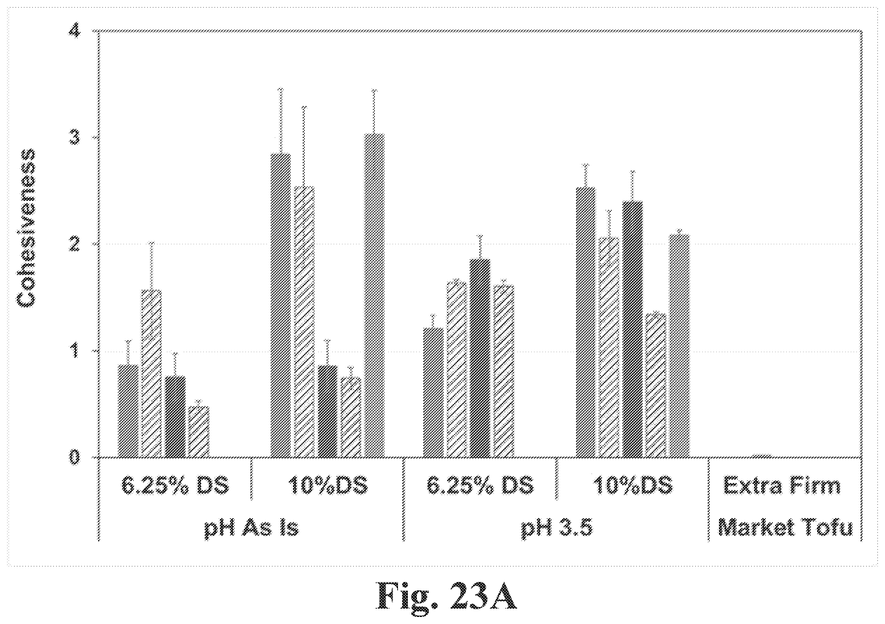

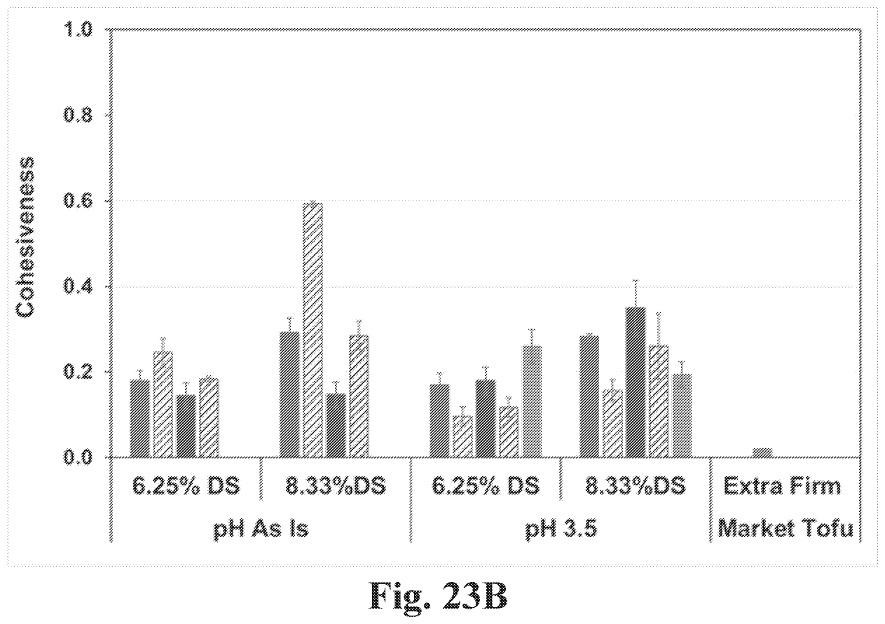

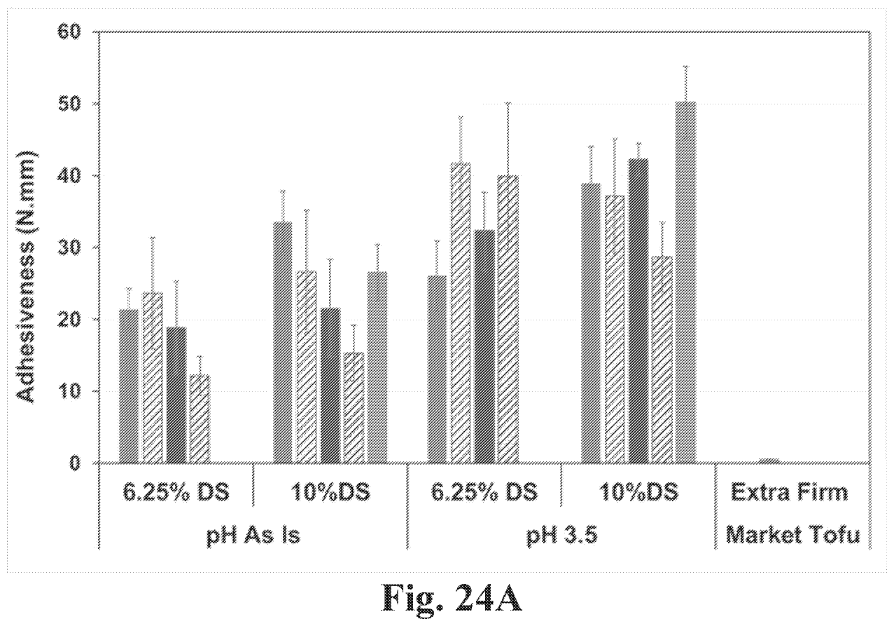

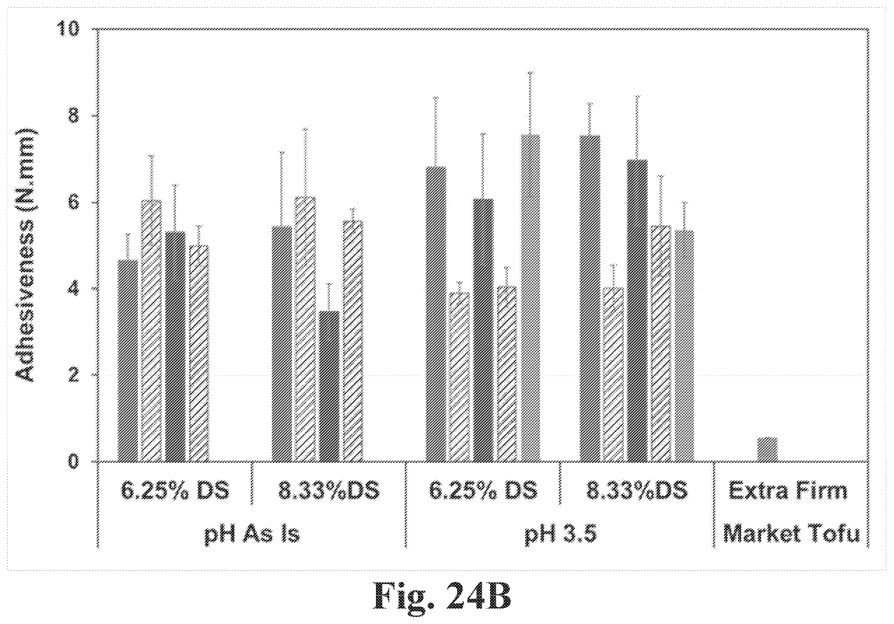

In each TPA test, hardness, cohesiveness, and adhesiveness data were collected. Hardness data are illustrated in FIGS. 22A (submerged dough, Sample IDs 1-18) and 22B (biomat pieces, Sample IDs 19-36); in each of these figures, the results for each sample are presented in numerical order by sample ID, left to right, except that the rightmost bar in each figure represents the hardness of a commercially available extra-firm tofu food product obtained from a grocery store, which was measured for comparison. Adhesiveness data are illustrated in FIGS. 23A (submerged dough, Sample IDs 1-18) and 23B (biomat pieces, Sample IDs 19-36); in each of these figures, the results for each sample are presented in numerical order by sample ID, left to right, except that the rightmost bar in each figure represents the cohesiveness of a commercially available extra-firm tofu food product obtained from a grocery store, which was measured for comparison. Cohesiveness data are illustrated in FIGS. 24A (submerged dough, Sample IDs 1-18) and 24B (biomat pieces, Sample IDs 19-36); in each of these figures, the results for each sample are presented in numerical order by sample ID, left to right, except that the rightmost bar in each figure represents the cohesiveness of a commercially available extra-firm tofu food product obtained from a grocery store, which was measured for comparison.

FIGS. 22A through 24B illustrate several trends with respect to the effect of pH and salt concentration. At the higher (unadjusted) pH values, increasing salt concentration resulted in an increase in hardness, regardless of the biomass format, solids content, or type of salt; without wishing to be bound by any particular theory, the present inventors hypothesize that a combination of the magnesium or calcium cations acting to weaken the repulsive forces between the negatively-charged fungal protein molecules and the formation of salt bridges and/or water-ion bonds served to strengthen ionic bonding in the fungal curd composition. The reverse phenomenon was observed at pH 3.5, where the hardness of the samples decreased with increasing salt concentration; without wishing to be bound by any particular theory, the present inventors hypothesize that because salts were added after pH adjustment, when coalescence may have already been underway, the salt molecules exerted a shielding effect on protein surface charges, resulting in a lower proportion of fungal proteins coalescing.

FIGS. 22A through 24B further illustrate several trends with respect to the effect of salt type and dry solid content. In samples prepared using a submerged dough, regardless of pH, use of magnesium chloride resulted in a harder fungal curd than use of calcium chloride at the lower solids content (6.25 wt. %), whereas at the higher solids content (10 wt. %) the opposite trend was observed. Samples prepared using biomat pieces exhibited a different pattern, whereby magnesium chloride produced harder fungal curds than calcium chloride at pH 3.5 but calcium chloride produced harder fungal curds than magnesium chloride at higher (unadjusted) pH. Without wishing to be bound by any particular theory, the present inventors hypothesize that these differences are attributable to differences in surface chemistry and affinity for the different salts between the two mycelial biomass formats.

Additionally, FIGS. 22A through 24B illustrate that in general, harder fungal curds were also less cohesive, indicating greater rigidity and less structural flexibility under applied deformation. Samples prepared using submerged dough generally had lower hardness but greater cohesiveness and much greater adhesiveness than samples prepared using biomat pieces; without wishing to be bound by any particular theory, the present inventors hypothesize that these differences are attributable to differences in the water binding properties of the fungal proteins between the two mycelial biomass formats.

Additionally, the present inventors' conclusion that the cohesive mass formed upon heating of the submerged dough milk with a solids content of 10%, without salt addition or pH adjustment (Sample ID 9), was simply a dewatered mass of the “sticky” submerged dough material and not a true coalesced protein composition is supported by observing that the hardness of Sample 9 (FIG. 22A, pH “as is,” 10% DS, fifth bar) was the lowest of all the samples. Without being bound by any particular theory, the present inventors hypothesize that the lack of hardness in this sample is indicative that while a cohesive mass was able to be formed, no coalescence of fungal proteins occurred.

### Example 15

### Microstructure of Tofu Analog Products

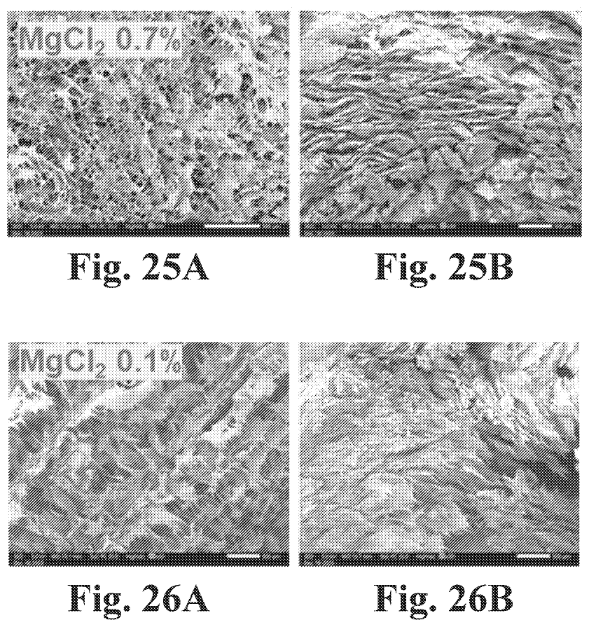

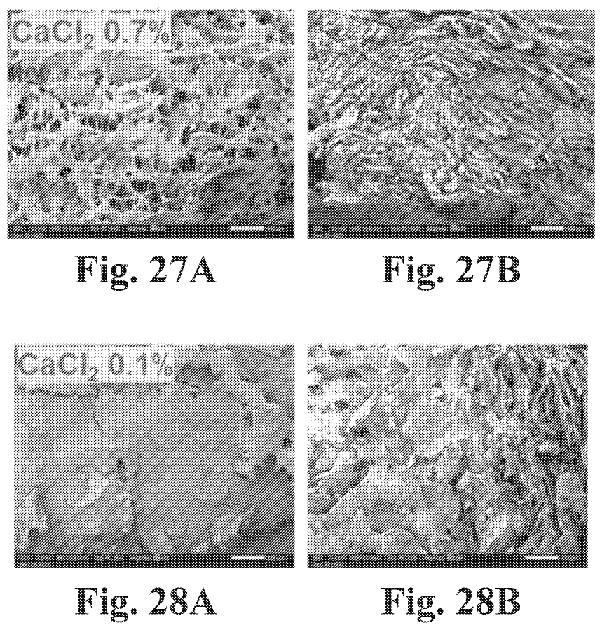

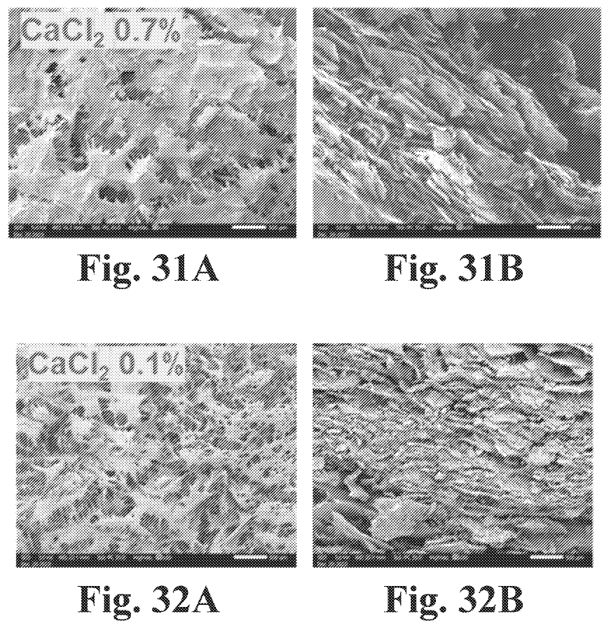

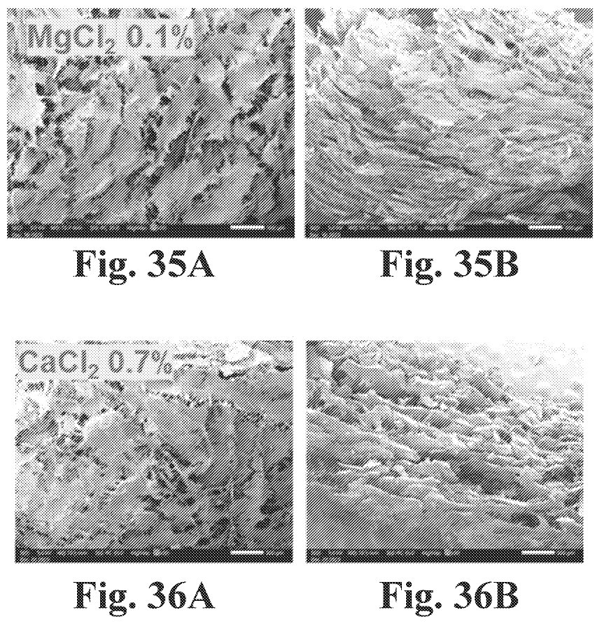

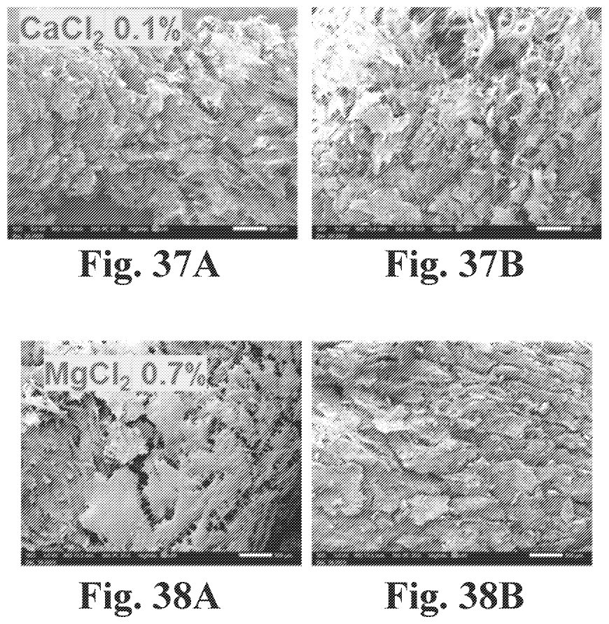

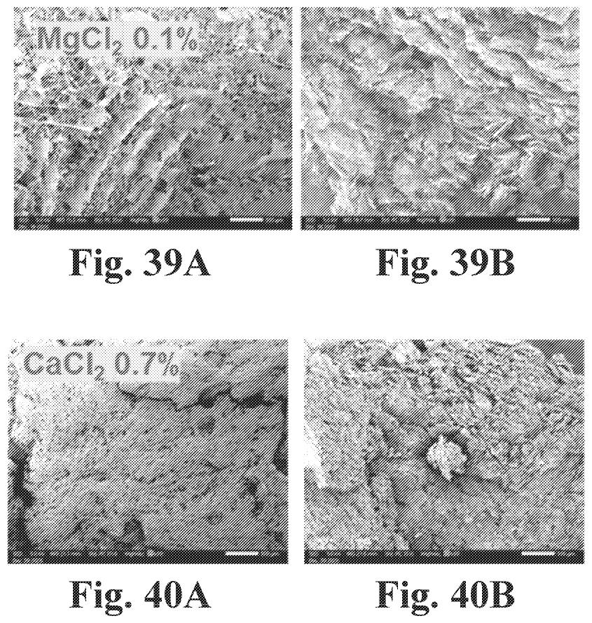

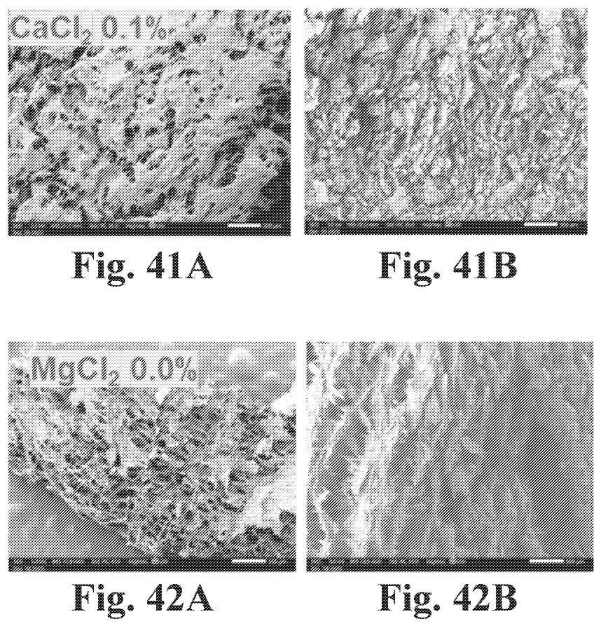

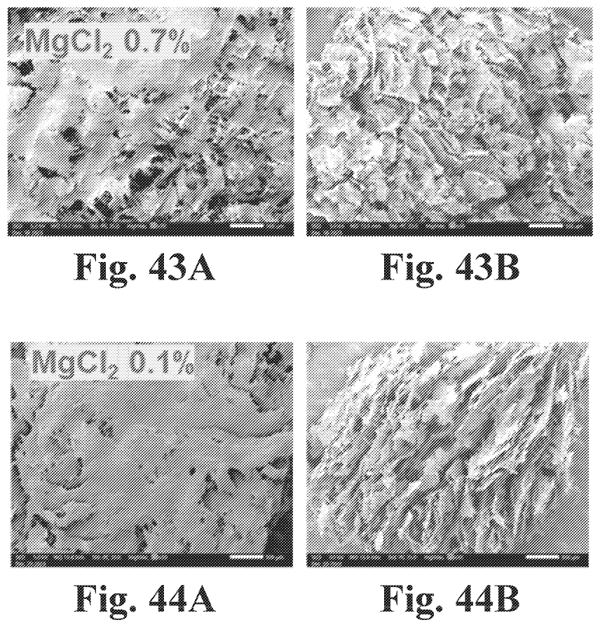

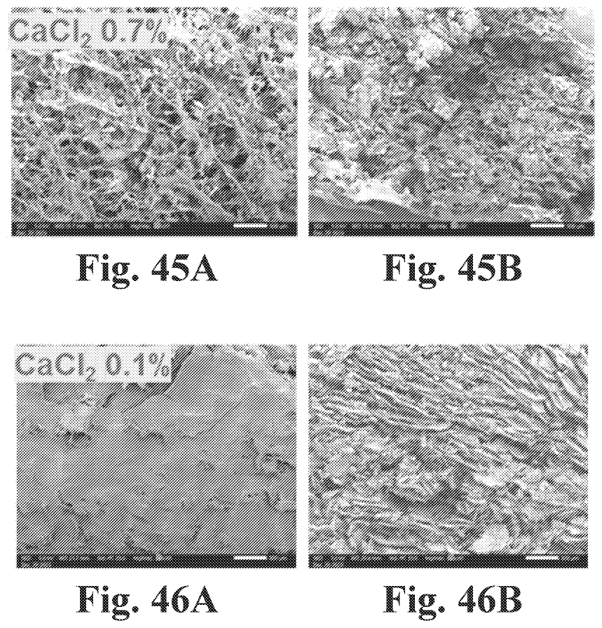

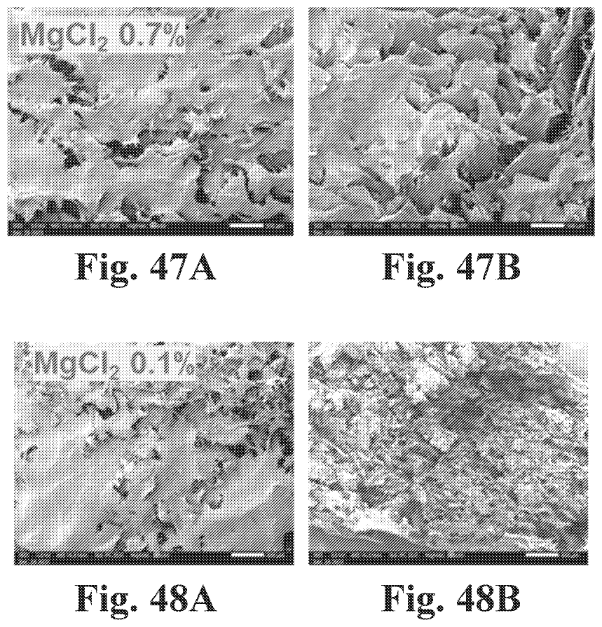

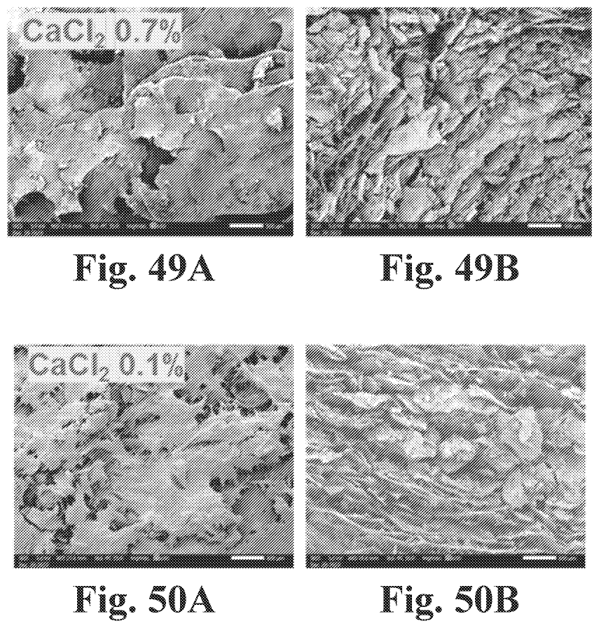

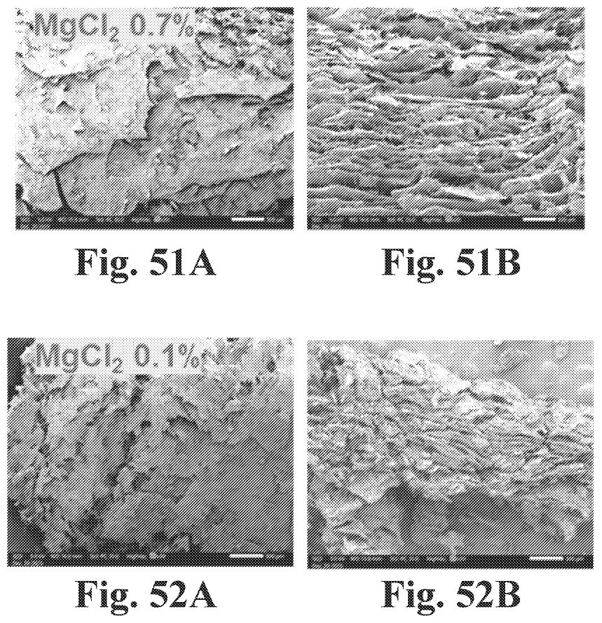

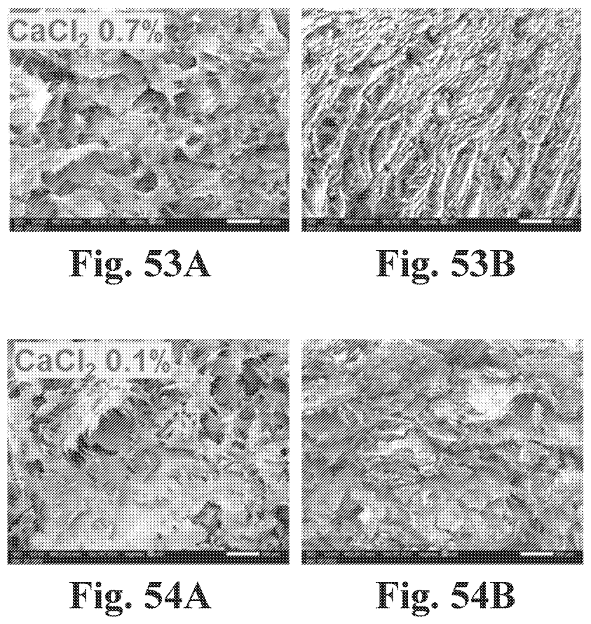

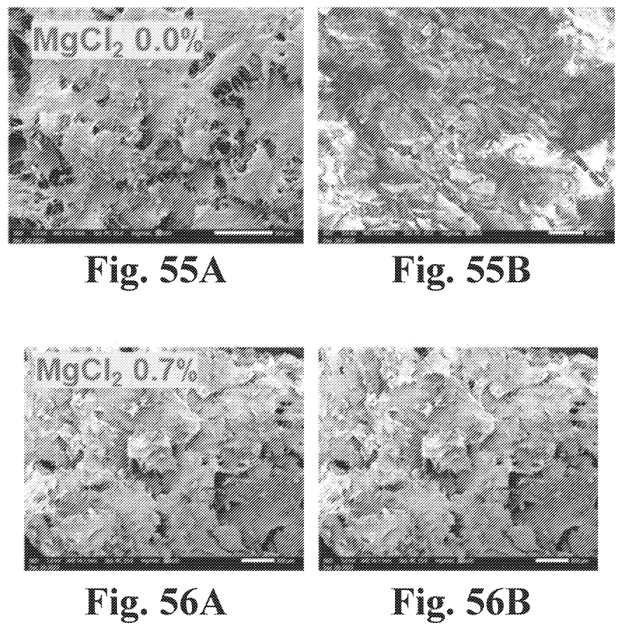

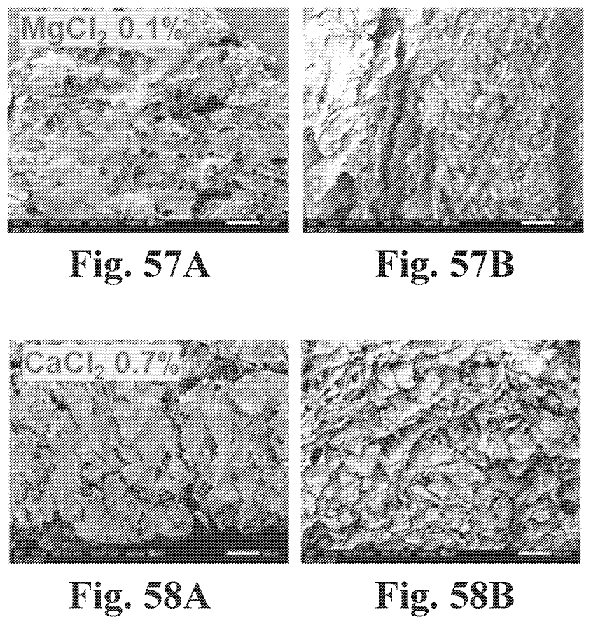

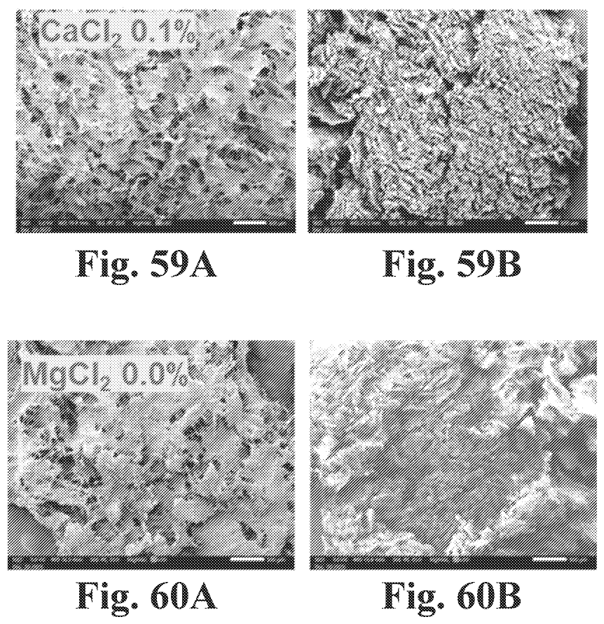

Freeze-dried samples of several of the tofu analog products made in Example 12 were platinum-coated and imaged with a scanning electron microscope (JEOL Ltd., Tokyo, Japan) using an accelerating voltage of 5 kV. Images of the surface and cross-section of each of Sample IDs 1-36 are shown in FIGS. 25A through 60B; the images are presented in numerical order by Sample ID (i.e., images of Sample ID 1 are shown in FIGS. 25A and 25B, images of Sample ID 2 are shown in FIGS. 26A and 26B, etc.), and in each pair of figures, the “A” figure is an image of the surface of the sample and the “B” figure is an image of the cross-section of the sample.

FIGS. 25A through 60B reveal several trends in the microstructure of the produced tofu analog products. For samples prepared using liquid dispersions containing 6.25 wt. % submerged dough solids, increasing the salt concentration resulted in the formation of a layered rod-like structure with higher surface porosity (regardless of pH or salt type), and magnesium chloride provided a more homogeneous and less coarse microstructure than calcium chloride. For samples prepared using liquid dispersions containing 10 wt. % submerged dough solids, increasing the salt concentration resulted in the formation of a denser and more homogeneous microstructure (regardless of pH or salt type); the microstructure also tended to be denser and more homogeneous when calcium chloride was used, while magnesium chloride produced irregular aggregate particles with rougher surfaces. For samples prepared using liquid dispersions containing 6.25 wt. % biomat piece solids, increasing the salt concentration resulted in the formation of a layered rod-like structure with a smoother surface (regardless of pH or salt type), and magnesium chloride provided a more homogeneous and less coarse microstructure than calcium chloride. For samples prepared using liquid dispersions containing 8.33 wt. % biomat piece solids, increasing the salt concentration resulted in the formation of a denser and more homogeneous microstructure with less surface porosity (regardless of pH or salt type); use of magnesium chloride tended to produce a denser and more homogeneous layered microstructure, while use of calcium chloride tended to produce irregular aggregate particles with more porous surfaces.

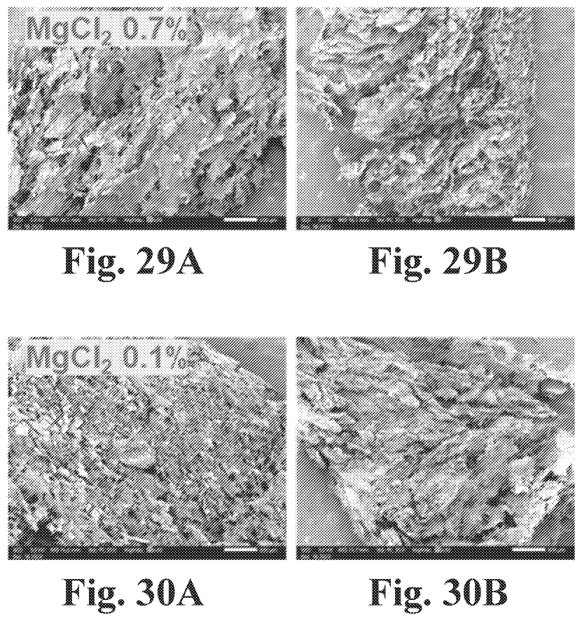

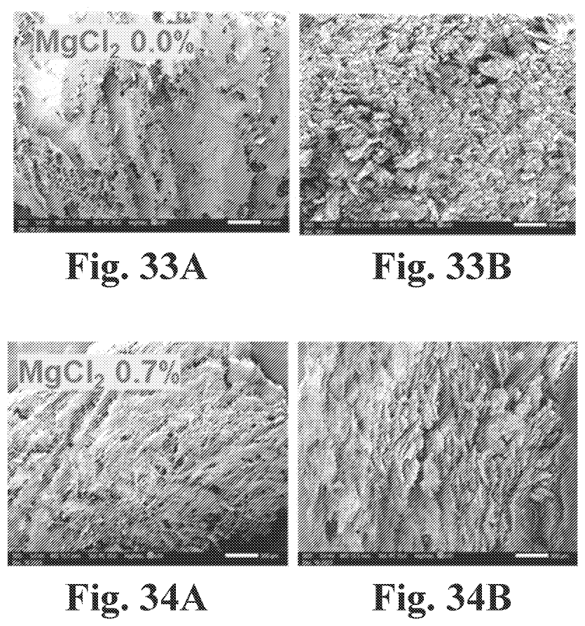

Additionally, the present inventors' conclusion that the cohesive mass formed upon heating of the submerged dough milk with a solids content of 10%, without salt addition or pH adjustment (Sample ID 9), was simply a dewatered mass of the “sticky” submerged dough material and not a true coalesced protein composition is supported by comparing the SEM cross-section of this material (FIG. 33B) with the SEM cross-sections of curds formed via pH adjustment and/or salt addition of the same milk composition (Sample IDs 5-8 and 14-18; FIGS. 29B, 30B, 31B, 32B, 38B, 39B, 40B, 41B, and 42B). Particularly, while FIG. 33B shows a grainy structure, each of the other figures shows a more layered structure. Without being bound by any particular theory, the present inventors hypothesize that the layered structure shown in FIGS. 29B, 30B, 31B, 32B, 38B, 39B, 40B, 41B, and 42B results from coalescence of the filamentous fungal biomass, which, due to its microfilamentous structure, tends to form a layered structure when coalesced, at least at the particle sizes of the materials used in Examples 12-15.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

1. A method for making a solid and/or colloidal fungal food material, comprising:
inducing coalescence of fungal proteins in a liquid dispersion of filamentous fungal particles.

2. The method of claim 1, wherein the inducing step comprises at least one of:
(i) adjusting a pH of the liquid dispersion;
(ii) adding one or more functional ingredients to the liquid dispersion; and
(iii) adding one or more salts to the liquid dispersion.

3. The method of claim 2, wherein the inducing step comprises (i).

4. The method of claim 2, wherein the inducing step comprises (ii).

5. The method of claim 2, wherein the inducing step comprises (iii).

6. The method of claim 2, wherein the inducing step comprises (i) and (ii).

7. The method of claim 2, wherein the inducing step comprises (i) and (iii).

8. The method of claim 2, wherein the inducing step comprises (ii) and (iii).

9. The method of claim 2, wherein the inducing step comprises (i), (ii), and (iii).

10. The method of any one of claims 1-9, wherein the liquid dispersion of filamentous fungal particles comprises an oil and/or a solid fat.

11. The method of claim 10, comprising, prior to the inducing step, combining a liquid phase, the filamentous fungal particles, and the oil and/or solid fat to form the liquid dispersion.

12. The method of claim 11, wherein the combining step comprises blending the liquid phase and the filamentous fungal particles with the oil and/or solid fat.

13. The method of claim 12, wherein the blending comprises high-speed shearing.

14. The method of claim 13, wherein the high-speed shearing comprises shearing the liquid phase, the filamentous fungal particles, and the oil and/or solid fat for at least about two minutes at a rotational speed of at least about 10,000 rpm.

15. The method of any one of claims 11-14, wherein the combining step comprises adding an emulsifier.

16. The method of claim 15, wherein the emulsifier is selected from the group consisting of carboxymethylcellulose, carrageenan, cellulose, guar gum, lecithin, mono- and diglycerides of fatty acids, polyglycerol esters of fatty acids, polyglycerol polyricinoleate, polysorbates, stearoyl lactylates, sorbitan esters, sucrose esters, sucroglycerides, xanthan gum, and combinations thereof.

17. The method of any one of claims 10-16, wherein the oil and/or solid fat comprises an oil selected from the group consisting of acai oil, almond oil, avocado oil, blackcurrant seed oil, borage seed oil, canola oil, cashew oil, coconut oil, corn oil, cottonseed oil, evening primrose oil, grapeseed oil, hazelnut oil, hemp oil, macadamia oil, olive oil, palm oil, peanut oil, pecan oil, pine seed oil, pistachio oil, pumpkin seed oil, safflower oil, sesame oil, soybean oil, sunflower oil, tea oil, walnut oil, and combinations thereof.

18. The method of any one of claims 10-17, wherein the oil and/or solid fat comprises a solid fat selected from the group consisting of blubber, butter, chicken fat, clarified butter, cocoa butter, dripping, duck fat, fatback, lard, mango butter, margarine, schmaltz, shea butter, speck, suet, tail fat, tallow, vegetable shortening, and combinations thereof.

19. The method of any one of claims 10-18, wherein an oil content of the liquid dispersion is about 1 wt. % to about 5 wt. %.

20. The method of any one of claims 2, 4, 6, 8, and 9, wherein the one or more functional ingredients comprise a non-fungal protein.

21. The method of claim 20, wherein the non-fungal protein is selected from the group consisting of bean protein, broccoli protein, chickpea protein, hemp protein, lentil protein, nut protein, pea protein, potato protein, quinoa protein, rice protein, seaweed protein, seed protein, soy protein, spinach protein, and combinations thereof.

22. The method of any one of claims 2, 4, 6, 8, and 9, wherein the one or more functional ingredients comprise one or more enzymes.

23. The method of claim 22, wherein the one or more enzymes are selected from the group consisting of catalases, chymosin, lactases, lipases, transglutaminases, and combinations thereof.

24. The method of any one of claims 2, 3, 6, 7, and 9, wherein, in the inducing step, the pH of the liquid dispersion is reduced.

25. The method of claim 24, wherein the pH of the liquid dispersion is reduced by adding an acid to the liquid dispersion.

26. The method of claim 25, wherein the acid is selected from the group consisting of sorbic acid, benzoic acid, formic acid, acetic acid, dehydroacetic acid, lactic acid, propionic acid, boric acid, malic acid, fumaric acid, ascorbic acid, erythorbic acid, citric acid, tartaric acid, phosphoric acid, metatartaric acid, adipic acid, succinic acid, thiodipropionic acid, phytic acid, alginic acid, hydrochloric acid, sulfuric acid, gluconic acid, glutamic acid, guanylic acid, inosinic acid, cyclamic acid, cholic acid, and combinations thereof.

27. The method of claim 24, wherein the pH of the liquid dispersion is reduced by adding an acidifying microbial culture to the liquid dispersion.

28. The method of any one of claims 24-27, wherein the inducing step further comprises heating the liquid dispersion.

29. The method of claim 28, wherein the liquid dispersion is heated to a temperature of about 150° F. to about 180° F. (about 65.5° C. to about 83° C.).

30. The method of claim 29, further comprising further heating the liquid dispersion to a temperature of about 180° F. to about 200° F. (about 83° C. to about 94° C.) after the inducing step.

31. The method of any one of claims 1-30, wherein the liquid dispersion comprises at least one salt of calcium or magnesium.

32. The method of any one of claims 2, 5, and 7-9, wherein the one or more salts comprise at least one salt of calcium or magnesium.

33. The method of claim 31 or claim 32, wherein the at least one salt of calcium or magnesium is selected from the group consisting of calcium carbonate, calcium sorbate, calcium benzoate, calcium sulfite, calcium hydrogen sulfite, calcium formate, calcium acetate, calcium propionate, calcium ascorbate, calcium lactate, monocalcium citrate, dicalcium citrate, tricalcium citrate, monocalcium phosphate, dicalcium phosphate, tricalcium phosphate, calcium malate, calcium hydrogen malate, calcium tartrate, calcium fumarate, calcium glycerylphosphate, calcium disodium ethylene diamine tetraacetate, calcium lactobionate, calcium alginate, dicalcium diphosphate, calcium dihydrogen diphosphate, sodium calcium polyphosphate, calcium polyphosphate, calcium salts of fatty acids, calcium stearoyl-2-lactylate, calcium stearoyl fumarate, calcium chloride, calcium sulfate, calcium oxide, calcium ferrocyanide, dicalcium diphosphate, calcium sodium polyphosphate, calcium polyphosphate, calcium silicate, calcium aluminosilicate, calcium stearate, calcium gluconate, synthetic calcium aluminates, calcium diglutamate, calcium guanylate, calcium inosinate, calcium 5′-ribonucleotides, calcium iodate, calcium bromate, calcium peroxide, calcium cyclamate, calcium saccharate, magnesium lactate, monomagnesium phosphate, dimagnesium phosphate, magnesium citrate, magnesium salts of fatty acids, magnesium carbonate, magnesium bicarbonate, magnesium chloride, magnesium sulfate, magnesium oxide, magnesium silicate, magnesium trisilicate, magnesium stearate, magnesium gluconate, magnesium diglutamate, and combinations thereof.

34. The method of any one of claims 1-33, wherein the liquid dispersion further comprises at least one of a flavoring agent, a taste modulator, and a plantmasker.

35. The method of any one of claims 1-34, wherein at least a portion of the filamentous fungal particles are produced by size-reducing a cohesive filamentous fungal mycelial biomass.

36. The method of claim 35, wherein the cohesive filamentous fungal mycelial biomass is produced by liquid surface fermentation or solid-state fermentation.

37. The method of any one of claims 1-36, wherein at least a portion of the filamentous fungal particles are produced by submerged fermentation.

38. The method of any one of claims 1-37, wherein the filamentous fungal particles are in the form of a flour having a particle size of about 30 μm to about 400 μm.

39. The method of any one of claims 1-38, wherein the filamentous fungal particles consist essentially of fungal mycelia.

40. The method of any one of claims 1-39, wherein the filamentous fungal particles comprise at least about 50 wt. % fungal mycelia.

41. The method of claim 40, wherein the filamentous fungal particles comprise at least about 75 wt. % fungal mycelia.

42. The method of claim 41, wherein the filamentous fungal particles comprise at least about 95 wt. % fungal mycelia.

43. The method of any one of claims 1-42, wherein a solids content of the liquid dispersion is about 4 wt. % to about 7 wt. %.

44. The method of any one of claims 1-43, wherein a mass ratio of filamentous fungal particles to liquid in the liquid dispersion is about 1:10 to about 10:1.

45. The method of any one of claims 1-44, wherein the liquid dispersion is stable at room temperature for at least about 1 day, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 15 days, at least about 16 days, at least about 17 days, at least about 18 days, at least about 19 days, at least about 20 days, at least about 21 days, at least about 22 days, at least about 23 days, at least about 24 days, at least about 25 days, at least about 26 days, at least about 27 days, at least about 28 days, at least about 29 days, at least about 30 days, at least about 1 month, at least about 2 months, or at least about 3 months.

46. The method of any one of claims 1-45, wherein the liquid dispersion is stable at a refrigerated temperature for at least about 1 day, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 15 days, at least about 16 days, at least about 17 days, at least about 18 days, at least about 19 days, at least about 20 days, at least about 21 days, at least about 22 days, at least about 23 days, at least about 24 days, at least about 25 days, at least about 26 days, at least about 27 days, at least about 28 days, at least about 29 days, at least about 30 days, at least about 1 month, at least about 2 months, or at least about 3 months.

47. The method of any one of claims 1-46, wherein the liquid dispersion is a mixed-format mycelial biomass composition comprising a first mycelial biomass format and a second mycelial biomass format, wherein the first and second mycelial biomass formats are different from each other.

48. The method of claim 47, wherein the first mycelial biomass format is a cohesive mycelial biomass format and the second mycelial biomass format is a submerged mycelial biomass format.

49. The method of claim 48, wherein the first mycelial biomass format is selected from the group consisting of biomat pieces, a biomat flour, a biomat dispersion, and a spray dried biomat flour.

50. The method of claim 48 or claim 49, wherein the second mycelial biomass format is selected from the group consisting of a submerged slurry, a submerged dough, a submerged flour, a submerged dispersion, and a submerged spray dried flour.

51. The method of claim 47, wherein each of the first and second mycelial biomass formats is a submerged mycelial biomass format.

52. The method of claim 51, wherein each of the first and second mycelial biomass formats is selected from the group consisting of a submerged liquid biomass, a submerged dough, a submerged flour, a submerged dispersion, and a submerged spray dried flour.

53. The method of any one of claims 47-52, wherein the liquid dispersion is a combined liquid dispersion, further comprising, before the inducing step:
blending a mixture of the first mycelial biomass format and a first liquid to form a first liquid dispersion;
blending a mixture of the second mycelial biomass format and a second liquid to form a second liquid dispersion; and
combining the first and second liquid dispersions to form the combined liquid dispersion.

54. The method of any one of claims 1-53, wherein a gel is formed in the inducing step.

55. The method of claim 54, wherein the inducing step comprises adjusting a pH of the liquid dispersion to a gelation pH of no more than about 4.

56. The method of claim 55, wherein the gelation pH is about 3.5.

57. The method of any one of claims 1-56, wherein a fungal curd is formed in the inducing step, further comprising:
separating at least a portion of a liquid phase of the liquid dispersion from the fungal curd.

58. The method of claim 57, wherein, in the separating step, the at least a portion of the liquid phase is at least about 90 wt. % of the liquid phase.

59. The method of claim 57 or claim 58, wherein the inducing step comprises adjusting a pH of the liquid dispersion to a pH of about 2 to about 4.

60. The method of claim 59, wherein, in the inducing step, the pH is adjusted to a pH of about 3.5.

61. The method of any one of claims 57-60, wherein the separating step comprises pressing the fungal curd through a mesh filter.

62. The method of claim 61, wherein the mesh filter comprises a cloth.

63. The method of claim 62, wherein the cloth is cheesecloth.

64. The method of claim 61 or claim 62, wherein the mesh filter comprises a fine wire sieve.

65. The method of any one of claims 61-64, further comprising forming the fungal curd into a block.

66. A food material, comprising coalesced filamentous fungal mycelial biomass.

67. The food material of claim 66, further comprising an oil and/or a solid fat.

68. The food material of claim 67, wherein the oil and/or solid fat comprises an oil selected from the group consisting of acai oil, almond oil, avocado oil, blackcurrant seed oil, borage seed oil, canola oil, cashew oil, coconut oil, corn oil, cottonseed oil, evening primrose oil, grapeseed oil, hazelnut oil, hemp oil, macadamia oil, olive oil, palm oil, peanut oil, pecan oil, pine seed oil, pistachio oil, pumpkin seed oil, safflower oil, sesame oil, soybean oil, sunflower oil, tea oil, walnut oil, and combinations thereof.

69. The food material of claim 67 or claim 68, wherein the oil and/or solid fat comprises a solid fat selected from the group consisting of blubber, butter, chicken fat, clarified butter, cocoa butter, dripping, duck fat, fatback, lard, mango butter, margarine, schmaltz, shea butter, speck, suet, tail fat, tallow, vegetable shortening, and combinations thereof.

70. The food material of any one of claims 66-69, further comprising a non-fungal protein.

71. The food material of claim 70, wherein the non-fungal protein is selected from the group consisting of bean protein, broccoli protein, chickpea protein, hemp protein, lentil protein, nut protein, pea protein, potato protein, quinoa protein, rice protein, seaweed protein, seed protein, soy protein, spinach protein, and combinations thereof.

72. The food material of any one of claims 66-71, wherein at least a portion of the filamentous fungal particles are produced by size-reducing a cohesive filamentous fungal mycelial biomass.

73. The food material of claim 72, wherein the cohesive filamentous fungal mycelial biomass is produced by liquid surface fermentation or solid-state fermentation.

74. The food material of any one of claims 66-73, wherein at least a portion of the filamentous fungal particles are produced by submerged fermentation.

75. The food material of any one of claims 66-74, wherein the filamentous fungal particles consist essentially of fungal mycelia.

76. The food material of any one of any one of claims 66-75, wherein the filamentous fungal particles comprise at least about 50 wt. % fungal mycelia.

77. The food material of claim 76, wherein the filamentous fungal particles comprise at least about 75 wt. % fungal mycelia.

78. The food material of claim 77, wherein the filamentous fungal particles comprise at least about 95 wt. % fungal mycelia.

79. The food material of any one of claims 66-78, wherein the fungal curd is in the form of a block.

80. The food material of any one of claims 66-79, wherein the food material is free of any non-fungal gelling agent.

81. The food material of any one of claims 66-80, consisting essentially of the coalesced filamentous fungal mycelial biomass.

82. The food material of any one of claims 66-81, consisting of the filamentous fungal mycelial biomass and at least one acid or base.

83. The food material of any one of claims 66-82, consisting of the filamentous fungal mycelial biomass and at least one functional ingredient.

84. The food material of any one of claims 66-83, consisting of the filamentous fungal mycelial biomass and at least one salt.

85. The food material of any one of claims 66-80, further comprising a microbial food culture.

86. The food material of any one of claims 66-85, having a hardness of about 1 N to about 50 N.

87. The food material of any one of claims 66-86, having an adhesiveness of about 0.001 N·mm to about 60 N·mm.

88. The food material of any one of claims 66-87, having a cohesiveness of about 0.001 to about 4.

89. The food material of any one of claims 66-88, wherein the food material is a fungal curd made by the method of any one of claims 57-65.

90. A mixed-format mycelial biomass composition, comprising:
a first mycelial biomass format; and
a second mycelial biomass format,
wherein the first and second mycelial biomass formats are different mycelial biomass formats.

91. The mixed-format mycelial biomass composition of claim 90, wherein the composition is a food material.

92. The mixed-format mycelial biomass composition of claim 91, wherein the food material is selected from the group consisting of a flour, a plurality of solid particles other than a flour, a liquid dispersion, an emulsion, a foam, a gel, a sol, and a solid foam.

93. The mixed-format mycelial biomass composition of claim 92, wherein the food material is a flour, wherein the flour comprises filamentous fungal particles having a particle size of about 30 μm to about 400 μm.

94. The mixed-format mycelial biomass composition of claim 92, wherein the food material is a plurality of solid particles other than a flour, wherein the plurality of solid particles comprises filamentous fungal particles having a particle length of about 0.05 mm to about 500 mm, a particle width of about 0.03 mm to about 7 mm, and a particle height of about 0.03 mm to about 1.0 mm.

95. The mixed-format mycelial biomass composition of claim 92, wherein the food material is a liquid dispersion or a sol, wherein a mass ratio of filamentous fungal particles to liquid in the liquid dispersion or sol is about 1:10 to about 10:1.

96. The mixed-format mycelial biomass composition of claim 92 or claim 95, wherein the food material is a liquid dispersion or sol, wherein the liquid dispersion or sol is stable for at least about 1 day, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 15 days, at least about 16 days, at least about 17 days, at least about 18 days, at least about 19 days, at least about 20 days, at least about 21 days, at least about 22 days, at least about 23 days, at least about 24 days, at least about 25 days, at least about 26 days, at least about 27 days, at least about 28 days, at least about 29 days, at least about 30 days, at least about 1 month, at least about 2 months, or at least about 3 months.

97. The mixed-format mycelial biomass composition of claim 92, wherein the food material is a foam having a foam stability of at least about 50%, at least about 55%, at least about 60%, at least about 65%, at least about 70%, at least about 75%, at least about 80%, at least about 85%, at least about 90%, or at least about 95% over a period of at least about 1 day, at least about 2 days, at least about 3 days, at least about 4 days, at least about 5 days, at least about 6 days, at least about 7 days, at least about 8 days, at least about 9 days, at least about 10 days, at least about 11 days, at least about 12 days, at least about 13 days, at least about 14 days, at least about 15 days, at least about 16 days, at least about 17 days, at least about 18 days, at least about 19 days, at least about 20 days, at least about 21 days, at least about 22 days, at least about 23 days, at least about 24 days, at least about 25 days, at least about 26 days, at least about 27 days, at least about 28 days, at least about 29 days, at least about 30 days, at least about 1 month, at least about 2 months, or at least about 3 months.

98. A food product comprising the food material of any one of claims 91-97.

99. The mixed-format mycelial biomass composition of any one of claims 91-97, wherein the first mycelial biomass format is a cohesive mycelial biomass format and the second mycelial biomass format is a submerged mycelial biomass format.

100. The mixed-format mycelial biomass composition of claim 99, wherein the first mycelial biomass format is selected from the group consisting of biomat pieces, a biomat flour, a biomat dispersion, and a spray dried biomat flour.

101. The mixed-format mycelial biomass composition of claim 99 or claim 100,
wherein the second mycelial biomass format is selected from the group consisting of a submerged slurry, a submerged dough, a submerged flour, a submerged dispersion, and a submerged spray dried flour.

102. The mixed-format mycelial biomass composition of any one of claims 99-101, wherein the composition is a food material.

103. The mixed-format mycelial biomass composition of claim 102, wherein the composition is a gel.

104. The mixed-format mycelial biomass composition of claim 103, wherein the composition is a food product selected from the group consisting of a blancmange analog food product, a butter analog food product, a custard analog food product, a jam analog food product, a jelly analog food product, a margarine analog food product, and a yogurt analog food product.

105. The mixed-format mycelial biomass composition of any one of claims 99-104, wherein a mass ratio of the first mycelial biomass format to the second mycelial biomass format is about 1:10 to about 10:1.

106. The mixed-format mycelial biomass composition of any one of claim 90-97 or 99-108, wherein each of the first and second mycelial biomass formats is a submerged mycelial biomass format.

107. The mixed-format mycelial biomass composition of claim 106, wherein each of the first and second mycelial biomass formats is selected from the group consisting of a submerged slurry, a submerged dough, a submerged flour, a submerged dispersion, and a submerged spray dried flour.

108. The mixed-format mycelial biomass composition of claim 106 or claim 107, wherein the composition is a food material.

109. The mixed-format mycelial biomass composition of claim 108, wherein the composition is a gel.

110. The mixed-format mycelial biomass composition of claim 109, wherein the composition is a food product selected from the group consisting of a blancmange analog food product, a butter analog food product, a custard analog food product, a jam analog food product, a jelly analog food product, a margarine analog food product, and a yogurt analog food product.

111. The mixed-format mycelial biomass composition of any one of claims 106-110, wherein a mass ratio of the first mycelial biomass format to the second mycelial biomass format is about 1:10 to about 10:1.

112. A method for producing a fungal gel, comprising at least one of:
(i) adjusting a pH of a liquid dispersion;
(ii) adding one or more functional ingredients to a liquid dispersion; and
(iii) adding one or more salts to a liquid dispersion,
wherein the liquid dispersion is a mixed-format mycelial biomass composition comprising a first mycelial biomass format and a second mycelial biomass format, wherein the first and second mycelial biomass formats are different mycelial biomass formats.

113. The method of claim 112, wherein the fungal gel is a food product.

114. The method of claim 113, wherein the food product is selected from the group consisting of a blancmange analog food product, a butter analog food product, a custard analog food product, a jam analog food product, a jelly analog food product, a margarine analog food product, and a yogurt analog food product.

115. The method of any one of claims 112-114, wherein a mass ratio of the first mycelial biomass format to the second mycelial biomass format is about 1:10 to about 10:1.

116. The method of any one of claims 112-115, wherein the first mycelial biomass format is a cohesive mycelial biomass format selected from the group consisting of biomat pieces, a biomat flour, a biomat dispersion, and a spray dried biomat flour and the second mycelial biomass format is a submerged mycelial biomass format selected from the group consisting of a submerged slurry, a submerged dough, a submerged flour, a submerged dispersion, and a submerged spray dried flour.

117. The method of claim 116, wherein the first mycelial biomass format is selected from the group consisting of biomat pieces, a biomat flour, and a spray dried biomat flour and the second mycelial biomass format is selected from the group consisting of a submerged dough, and a submerged flour.

118. The method of any one of claims 112-117, wherein each of the first and second mycelial biomass formats is a submerged mycelial biomass format selected from the group consisting of a submerged paste, a submerged flour, a submerged liquid dispersion, and a submerged spray dried flour.

119. The method of claim 118, wherein each of the first and second mycelial biomass formats is selected from the group consisting of a submerged dough, a submerged flour, and a submerged spray dried flour.

120. The method of claim 117 or claim 119, wherein the mixed-format mycelial biomass composition is produced by a method comprising:
blending a mixture of the first mycelial biomass format and a first liquid to form a first liquid dispersion;
blending a mixture of the second mycelial biomass format and a second liquid to form a second liquid dispersion; and
combining the first and second liquid dispersions to form the mixed-format mycelial biomass composition.

121. The method of any one of claims 112-120, wherein the inducing step comprises (i) and, in the inducing step, the pH of the liquid dispersion is adjusted to a gelation pH of no more than about 4.

122. The method of claim 121, wherein the gelation pH is about 3.5.

123. A method for making a fungal tofu analog food product, comprising:
inducing coalescence of fungal proteins in a liquid dispersion of filamentous fungal particles to form a fungal curd, wherein the inducing step comprises at least one of:
(i) adjusting a pH of the liquid dispersion;
(ii) adding one or more functional ingredients to the liquid dispersion; and
(iii) adding one or more salts to the liquid dispersion; and
compressing the fungal curd to form the fungal tofu analog food product.

124. The method of claim 123, further comprising, after the inducing step, separating the fungal curd from a liquid phase of the liquid dispersion.

125. The method of claim 123 or claim 124, wherein the liquid dispersion comprises an oil and/or a solid fat.

126. The method of claim 125, further comprising, prior to the inducing step, combining a liquid phase, the filamentous fungal particles, and the oil and/or solid fat to form the liquid dispersion.

127. The method of claim 126, wherein the combining step comprises blending the liquid phase and the filamentous fungal particles with the oil and/or solid fat.

128. The method of claim 127, wherein the blending comprises high-speed shearing.

129. The method of claim 128, wherein the high-speed shearing comprises shearing the liquid phase, the filamentous fungal particles, and the oil and/or solid fat for at least about two minutes at a rotational speed of at least about 10,000 rpm.

130. The method of any one of claims 126-129, wherein the combining step comprises adding an emulsifier.

131. The method of claim 130, wherein the emulsifier is selected from the group consisting of carboxymethylcellulose, carrageenan, cellulose, guar gum, lecithin, mono- and diglycerides of fatty acids, polyglycerol esters of fatty acids, polyglycerol polyricinoleate, polysorbates, stearoyl lactylates, sorbitan esters, sucrose esters, sucroglycerides, xanthan gum, and combinations thereof.

132. The method of any one of claims 125-131, wherein the oil and/or solid fat comprises an oil selected from the group consisting of acai oil, almond oil, avocado oil, blackcurrant seed oil, borage seed oil, canola oil, cashew oil, coconut oil, corn oil, cottonseed oil, evening primrose oil, grapeseed oil, hazelnut oil, hemp oil, macadamia oil, olive oil, palm oil, peanut oil, pecan oil, pine seed oil, pistachio oil, pumpkin seed oil, safflower oil, sesame oil, soybean oil, sunflower oil, tea oil, walnut oil, and combinations thereof.

133. The method of any one of claims 125-132, wherein the oil and/or solid fat comprises a solid fat selected from the group consisting of blubber, butter, chicken fat, clarified butter, cocoa butter, dripping, duck fat, fatback, lard, mango butter, margarine, schmaltz, shea butter, speck, suet, tail fat, tallow, vegetable shortening, and combinations thereof.

134. The method of any one of claims 125-133, wherein an oil content of the liquid dispersion is about 1 wt. % to about 5 wt. %.

135. The method of any one of claims 123-134, wherein the inducing step comprises (ii) and the one or more functional ingredients comprise a non-fungal protein.

136. The method of claim 135, wherein the non-fungal protein is selected from the group consisting of bean protein, broccoli protein, chickpea protein, hemp protein, lentil protein, nut protein, pea protein, potato protein, quinoa protein, rice protein, seaweed protein, seed protein, soy protein, spinach protein, and combinations thereof.

137. The method of any one of claims 123-136, wherein the inducing step comprises (ii) and the one or more functional ingredients comprise one or more enzymes.

138. The method of claim 137, wherein the one or more enzymes are selected from the group consisting of catalases, chymosin, lactases, lipases, transglutaminases, and combinations thereof.

139. The method of any one of claims 123-138, wherein the inducing step comprises (i) and, in the inducing step, the pH of the liquid dispersion is reduced.

140. The method of claim 139, wherein the pH of the liquid dispersion is reduced by adding an acid to the liquid dispersion.

141. The method of claim 140, wherein the acid is selected from the group consisting of sorbic acid, benzoic acid, formic acid, acetic acid, dehydroacetic acid, lactic acid, propionic acid, boric acid, malic acid, fumaric acid, ascorbic acid, erythorbic acid, citric acid, tartaric acid, phosphoric acid, metatartaric acid, adipic acid, succinic acid, thiodipropionic acid, phytic acid, alginic acid, hydrochloric acid, sulfuric acid, gluconic acid, glutamic acid, guanylic acid, inosinic acid, cyclamic acid, cholic acid, and combinations thereof.

142. The method of claim 139, wherein the pH of the liquid dispersion is reduced by adding an acidifying microbial culture to the liquid dispersion.

143. The method of any one of claims 139-142, wherein the inducing step further comprises heating the liquid dispersion.

144. The method of claim 143, wherein the liquid dispersion is heated to a temperature of about 150° F. to about 180° F. (about 65.5° C. to about 83° C.).

145. The method of claim 144, further comprising further heating the liquid dispersion to a temperature of about 180° F. to about 200° F. (about 83° C. to about 94° C.) after the inducing step.

146. The method of any one of claims 139-145, wherein, in the inducing step, the pH is adjusted to a pH of about 2 to about 4.

147. The method of claim 146, wherein, in the inducing step, the pH is adjusted to a pH of about 3.5.

148. The method of any one of claims 123-147, wherein the liquid dispersion comprises at least one salt of calcium or magnesium.

149. The method of any one of claims 123-148, wherein the inducing step comprises (iii) and the one or more salts comprise at least one salt of calcium or magnesium.

150. The method of claim 148 or claim 149, wherein the at least one salt of calcium or magnesium is selected from the group consisting of calcium carbonate, calcium sorbate, calcium benzoate, calcium sulfite, calcium hydrogen sulfite, calcium formate, calcium acetate, calcium propionate, calcium ascorbate, calcium lactate, monocalcium citrate, dicalcium citrate, tricalcium citrate, monocalcium phosphate, dicalcium phosphate, tricalcium phosphate, calcium malate, calcium hydrogen malate, calcium tartrate, calcium fumarate, calcium glycerylphosphate, calcium disodium ethylene diamine tetraacetate, calcium lactobionate, calcium alginate, dicalcium diphosphate, calcium dihydrogen diphosphate, sodium calcium polyphosphate, calcium polyphosphate, calcium salts of fatty acids, calcium stearoyl-2-lactylate, calcium stearoyl fumarate, calcium chloride, calcium sulfate, calcium oxide, calcium ferrocyanide, dicalcium diphosphate, calcium sodium polyphosphate, calcium polyphosphate, calcium silicate, calcium aluminosilicate, calcium stearate, calcium gluconate, synthetic calcium aluminates, calcium diglutamate, calcium guanylate, calcium inosinate, calcium 5′-ribonucleotides, calcium iodate, calcium bromate, calcium peroxide, calcium cyclamate, calcium saccharate, magnesium lactate, monomagnesium phosphate, dimagnesium phosphate, magnesium citrate, magnesium salts of fatty acids, magnesium carbonate, magnesium bicarbonate, magnesium chloride, magnesium sulfate, magnesium oxide, magnesium silicate, magnesium trisilicate, magnesium stearate, magnesium gluconate, magnesium diglutamate, and combinations thereof.

151. The method of any one of claims 123-150, wherein the separating step comprises pressing the fungal curd through a mesh filter.

152. The method of claim 151, wherein the mesh filter comprises a cloth.

153. The method of claim 152, wherein the cloth is cheesecloth.

154. The method of claim 151 or claim 152, wherein the mesh filter comprises a fine wire sieve.

155. The method of any one of claims 151-154, further comprising forming the fungal curd into a block.

156. The method of any one of claims 123-155, wherein the liquid dispersion further comprises at least one of a flavoring agent, a taste modulator, and a plantmasker.

157. The method of any one of claims 123-156, wherein at least a portion of the filamentous fungal particles are produced by size-reducing a cohesive filamentous fungal mycelial biomass.

158. The method of claim 157, wherein the cohesive filamentous fungal mycelial biomass is produced by liquid surface fermentation or solid-state fermentation.

159. The method of any one of claims 123-158, wherein at least a portion of the filamentous fungal particles are produced by submerged fermentation.

160. The method of any one of claims 123-159, wherein the filamentous fungal particles are in the form of a flour having a particle size of about 30 μm to about 400 μm.

161. The method of any one of claims 123-160, wherein the filamentous fungal particles consist essentially of fungal mycelia.

162. The method of any one of claims 123-161, wherein the filamentous fungal particles comprise at least about 50 wt. % fungal mycelia.

163. The method of claim 162, wherein the filamentous fungal particles comprise at least about 75 wt. % fungal mycelia.

164. The method of claim 163, wherein the filamentous fungal particles comprise at least about 95 wt. % fungal mycelia.

165. The method of any one of claims 123-164, wherein a solids content of the liquid dispersion is about 4 wt. % to about 7 wt. %.

166. A fungal tofu analog food product, made by the method of any one of claims 123-165.
